(19) United States
(12) Patent Application Publication
(10) Pub. No.: US 2023/0002514 A1
(43) Pub. Date: Jan. 5, 2023

(54) Supported Non-Coordinating Anion Activators, Use Thereof, and Production Thereof

(71) Applicant: ExxonMobil Chemical Patents Inc., Baytown, TX (US)

(72) Inventors: Charles J. Harlan, Houston, TX (US); Margaret T. Whalley, Houston, TX (US); Catherine A. Faler, Houston, TX (US); John R. Hagadorn, Houston, TX (US)

(21) Appl. No.: 17/771,611

(22) PCT Filed: Aug. 4, 2020
(86) PCT No.: PCT/US2020/044870

§ 371 Date: Apr. 25, 2022

Related U.S. Application Data
(60) Provisional application No. 62/926,961, filed on Oct. 28, 2019.

(30) Foreign Application Priority Data
Mar. 23, 2020 (EP) 20164766.6

(51) Int. Cl. C08F 4/02; C08F 4/659

(52) U.S. Cl. CPC C08F 4/025; C08F 4/65916

(57) ABSTRACT

Non-coordinating borate activators deposited upon a support material may be effective for promoting olefin polymerization in the presence of a suitable transition metal complex, particularly for gas phase and slurry polymerization reactions. The non-coordinating borate activators may be deposited upon the support material using substantially aliphatic hydrocarbon solvents, preferably in the absence of aromatic solvents, such as toluene.

### CROSS REFERENCE TO RELATED APPLICATIONS

This application claims the priority benefit of Provisional Application No. 62/926,961, filed Oct. 28, 2019, and European Patent Application No. 20164766.6 filed Mar. 23, 2020, herein incorporated by reference.

### FIELD

The present disclosure relates to non-coordinating anion activators deposited upon a support material without using substantial aromatic solvent and polymerization therewith.

### BACKGROUND

Polyolefins are commonly employed commercial polymers because of their robustness and wide-ranging and tunable physical properties. Polyolefins are typically prepared using a catalyst to promote polymerization of one or more olefinic monomers, frequently in the presence of a cocatalyst or activator. Catalysts suitable for promoting olefin polymerization include various transition metal complexes, such as Ziegler-Natta catalysts or metallocenes. Transition metal complexes of these types are usually activated with group 13 metallate activators, such as alumoxanes and non-coordinating anion activators. In many instances, it may be desirable to conduct olefin polymerization in the gas phase or under slurry phase conditions to facilitate polymerization throughput.

Due to solubility limitations, aromatic solvents have commonly been employed for manipulating both the transition metal complexes and activators used for promoting olefin polymerization. Recent efforts have sought to eliminate or significantly lower amounts of aromatic solvents, such as toluene, used in polymerization processes, both as a delivery vehicle or as a reaction solvent, in response to potential toxicity concerns and to eliminate residual aromatic solvent in the resulting polymer product, which may be problematic for some applications. In addition, from production standpoint, eliminating aromatic solvents from polymerization processes may allow post-polymerization devolatilization operations to be minimized, thereby decreasing process costs and complexity.

For gas phase and slurry phase polymerization reactions, the catalyst and activator may need to be deposited upon a support material, from which polymer growth may occur. Alumoxane activators may be formed in situ upon a support material without using aromatic solvents, as described in U.S. Patent Publication 2019/0127499. Due to the negligible solubility of conventional non-coordinating anion activators in aliphatic solvents, however, it can be very difficult to deposit these types of activators upon a support material without using at least some aromatic solvent. Even when no aromatic solvent is otherwise employed during polymerization, toluene and other aromatic solvents used to promote activator deposition upon a support material can still be problematic, since measurable solvent quantities can remain with the support material and become incorporated within the resulting polymer product. Moreover, reactive surface functionalities may decompose or otherwise inhibit the ability of non-coordinating anion activators to promote activation of a transition metal complex in some instances.

Other references of interest include Severn, J. R. et al. (2005) ““Bound but Not Gagged”—Immobilizing Single-Site α-Olefin Polymerization Catalysts,” Chem. Rev., v. 105(11), pp. 4073-4147; Chen, et al. (2000) “Cocatalysts for Metal-Catalyzed Olefin Polymerization: Activators, Activation Processes, and Structure-Activity Relationships,” Chem. Rev., v. 100, pp. 1391-1434; Hlatky, G. (2000) “Heterogeneous Single-Site Catalysts for Olefin Polymerization,” Chem Rev., v. 100(4), pp. 1347-1376; Hlatky, G. et al. (1996) “Supported Ionic Metallocene Polymerization Catalysts,” Macromolecules, v. 29(24), pp. 8019-8020; Charoenchaidet, S. et al. (2002) “Methylaluminoxane-Free Ethylene Polymerization with in sity Activated Zirconocene Triisobutylaluminum Catalysts and Silica-Supported Stabilized Borate Cocatalysts,” J. Polymer Sci., Part A, v. 40(19), pp. 3240-3248; Charoenchaidet, S. et al. (2002) “Borane-Functionalized Silica Supports in situ Activated Heterogeneous Zirconocene Catalysts for MAO-Free Ethylene Polymerization,” J. Molecular Catalysis A: Chemical, v. 185(1-2), pp. 167-177; Charoenchaidet, S. et al. (2002) “Improving the Performance of Heterogeneous Borane Cocatalysts by Pretreatment of the Silica Support with Alkylaluminum Compounds,” Macromolecular Rapid Communications, v. 23(7), pp. 426-431; WO 1994/003506; WO 1991/009882; WO 2005/016980; and U.S. Pat. Nos. 5,444,134 and 5,783,512.

### SUMMARY

Provided herein are supported activators comprising a support material, and a non-coordinating anion activator deposited upon the support material. The non-coordinating anion activator has a solubility of at least about 5 mM at 25° C. in at least one aliphatic solvent. Preferably, the supported activators are substantially free of aromatic solvent.

Catalyst systems may comprise the supported activators and a transition metal complex activatable by the supported activator. Preferably, the catalyst systems are substantially free of aromatic solvent.

Methods for forming the supported activators may comprise contacting at least one support material with a non-coordinating anion activator dissolved in at least one aliphatic hydrocarbon solvent, and removing the at least one aliphatic hydrocarbon solvent to deposit the non-coordinating anion activator upon the at least one support material to form the supported activator.

Polymerization methods using the supported activators may comprise contacting a catalyst system comprising a supported activator with an olefinic feed comprising one or more olefins under polymerization reaction conditions to form a polyolefin.

### BRIEF DESCRIPTION OF THE DRAWINGS

Not applicable.

### DETAILED DESCRIPTION

The present disclosure relates to olefin polymerization and, more specifically, non-coordinating anion activators deposited upon a support material substantially without using aromatic solvents, particularly ammonium and phosphonium borate activators at least partially soluble in at least one aliphatic solvent, preferably soluble at about 25° C.

As discussed above, it can be desirable to eliminate or significantly minimize the use of toluene and other aromatic solvents in polymerization processes to preclude aromatic solvent retention in the resulting polymer products. Eliminating or significantly minimizing aromatic solvent usage in polymerization processes may improve the quality of the resulting polymer products, decrease potential toxicity concerns, and/or limit expensive and time-consuming solvent devolatilization operations that may otherwise be needed when employing even small quantities of aromatic solvents during various stages of a polymerization process.

The negligible solubility of many transition metal complexes and activators effective for promoting olefin polymerization in non-aromatic solvents may be particularly problematic with respect to realizing the goal of eliminating aromatic solvents from polymerization processes. Due to their ionic character, conventional non-coordinating anion activators, in particular, have very limited solubility in aliphatic hydrocarbon solvents, thereby making elimination of aromatic solvents very difficult. In particular, the limited solubility of non-coordinating anion activators, particularly ammonium and phosphonium borate activators, in aliphatic hydrocarbon solvents may be especially problematic with respect to depositing these activators upon a support material without using toluene or other aromatic solvents.

The present disclosure provides various non-coordinating anion activators deposited upon a support material without using toluene or other aromatic solvents to promote deposition, or significantly minimizing use of these solvents during deposition. Namely, the non-coordinating anion activators employed in the present disclosure have been modified with long chain alkyl or alkoxy groups to promote sufficient solubility in aliphatic hydrocarbon solvents to allow manipulation of these activators to take place, specifically such that the activators may be deposited upon a support material to promote use thereof in gas phase and slurry phase polymerization reactions. The surface of the support material may, in some instances, be suitably passivated to allow the non-coordinating anion activator to maintain its activating capabilities. Advantageously, deposition of the non-coordinating anion activators may take place by simply contacting an aliphatic hydrocarbon solution of the activator with a suitable support material, followed by solvent removal, such as through evaporation. Thus, the supported activators disclosed herein may be readily formed and maintain activator effectiveness upon deposition without using aromatic solvents, thereby affording supported activators, catalyst systems, polymerization reactions, and polyolefin products that remain substantially free of toluene and other aromatic solvents.

### Definitions

All numerical values within the detailed description and the claims herein are modified by “about” or “approximately” with respect to the indicated value, and take into account experimental error and variations that would be expected by a person having ordinary skill in the art. Unless otherwise indicated, room temperature is about 23° C.

As used in the present disclosure and claims, the singular forms “a,” “an,” and “the” include plural forms unless the context clearly dictates otherwise.

For the purposes of the present disclosure, the new numbering scheme for groups of the Periodic Table is used. In said numbering scheme, the groups (columns) are numbered sequentially from left to right from 1 through 18, excluding the f-block elements (lanthanides and actinides). Under this scheme, the term “transition metal” refers to any atom from groups 3-12 of the Periodic Table, inclusive of the lanthanides and actinide elements. Ti, Zr, and Hf are group 4 transition metals, for example.

As used herein, Mn is number average molecular weight, Mw is weight average molecular weight, and Mz is z average molecular weight, wt % is weight percent, and mol % is mole percent. Molecular weight distribution (MWD), also referred to as polydispersity index (PDI), is defined to be Mw divided by Mn. Unless otherwise noted, all molecular weight units (e.g., Mw, Mn, and Mz) are in units of g/mol (g·mol⁻¹).

For purposes of this disclosure, when a polymer, copolymer, or oligomer, particularly a polyolefin, is referred to as comprising an olefin, the olefin present in such polymer, copolymer, or oligomer is the polymerized form of the olefin. For example, when a copolymer is said to have a “propylene” content of 0 wt % to 5 wt %, it is to be understood that the mer unit in the copolymer is derived from the monomer propylene in the polymerization reaction and said derived units are present at 0 wt % (i.e., absent) to 5 wt %, based upon the weight of the copolymer. As used herein, the terms “polymer” and oligomer” (and grammatical variations thereof) are used interchangeably to refer to a molecule having two or more of the same or different mer units. As used herein, the term “polymerize” (and grammatical variations thereof e.g., polymerization) is used to refer to a process of generating a molecule having two or more of the same or different mer units from two or more of the same or different monomers. A “homopolymer” is a polymer (or oligomer) having mer units that are the same. A “copolymer” is a polymer (or oligomer) having two or more mer units that are different from each other. A “terpolymer” is a polymer (or oligomer) having three mer units that are different from each other. “Different,” as used to refer to mer units, indicates that the mer units differ from each other by at least one atom or are different isomerically. Accordingly, the definition of copolymer, as used herein, includes terpolymers and like higher polymers. A “decene polymer” or “decene copolymer,” for example, is a polymer or copolymer comprising at least 50 mol % decene-derived units.

The term “independently,” when referenced to selection of multiple items from within a given group, means that the selected choice for a first item does not necessarily influence the choice of any second or subsequent item. That is, independent selection of multiple items within a given group means that the individual items may be the same or different from one another.

The terms “group,” “radical,” and “substituent” may be used interchangeably herein.

Reference to a group without specifying a particular isomer thereof (e.g., butyl) expressly discloses all isomers (e.g., n-butyl, iso-butyl, sec-butyl, tert-butyl and cyclobutyl), unless otherwise indicated.

The term “hydrocarbon” refers to a class of compounds having hydrogen bound to carbon, and encompasses saturated hydrocarbon compounds, unsaturated hydrocarbon compounds, and mixtures of hydrocarbon compounds (saturated and/or unsaturated), including mixtures of hydrocarbon compounds having different numbers of carbon atoms. The term “Cₙ” refers to hydrocarbon(s) or a hydrocarbyl group having n carbon atom(s) per molecule or group, wherein n is a positive integer. Such hydrocarbon compounds may be one or more of linear, branched, cyclic, acyclic, saturated, unsaturated, aliphatic, or aromatic. As used herein, a cyclic hydrocarbon may be referred to as “carbocyclic,” which includes saturated, unsaturated, and partially unsaturated carbocyclic compounds, as well as aromatic carbocyclic compounds. The term “heterocyclic” refers to a carbocyclic ring containing at least one ring heteroatom.

In particular, the term “heterocyclic” refers to a cyclic group where a ring carbon atom (or two or three ring carbon atoms) has been replaced with a heteroatom, such as N, O, or S. A heterocyclic ring is a ring having a heteroatom in the ring structure as opposed to a heteroatom substituted ring where a hydrogen on a ring atom is replaced with a heteroatom. For example, tetrahydrofuran is a heterocyclic ring, and 4-N,N-dimethylaminophenyl is a heteroatom-substituted ring substituent.

Substituted heterocyclic also means a heterocyclic group where at least one hydrogen atom of the heterocyclic radical has been substituted with at least a non-hydrogen group, such as a hydrocarbyl group, a heteroatom, or a heteroatom containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*, —SiR*₃, —GeR*, —GeR*₃, —SnR*, —SnR*₃, —PbR*₃, and the like, where each R* is independently a hydrocarbyl or halocarbyl radical.

The terms “hydrocarbyl radical,” “hydrocarbyl group,” or “hydrocarbyl” may be used interchangeably and are defined to mean a group consisting of hydrogen and carbon atoms only and bearing at least one unfilled valence position when removed from a parent compound. A hydrocarbyl group can be saturated or unsaturated, linear or branched, cyclic or acyclic, aromatic or non-aromatic. Preferred hydrocarbyls are C₁-C₁₀₀ radicals that may be linear or branched. Examples of such radicals include, but are not limited to, alkyl groups such as methyl, ethyl, n-propyl, isopropyl, n-butyl, isobutyl, sec-butyl, tert-butyl, pentyl, iso-amyl (isopentyl), hexyl, octyl, cyclopropyl, cyclobutyl, cyclopentyl, cyclohexyl, cyclooctyl, and the like. The term “hydrocarbyl group having 1 to about 100 carbon atoms” refers to a moiety selected from a linear, cyclic or branched C₁-C₁₀₀ hydrocarbyl group.

The term “optionally substituted” means that a hydrocarbon or hydrocarbyl group may be unsubstituted or substituted. For example, the term “optionally substituted hydrocarbyl” refers to replacement of at least one hydrogen atom or carbon atom in a hydrocarbyl group with a heteroatom or heteroatom functional group. Unless otherwise specified, any of the hydrocarbyl groups herein may be optionally substituted.

Silylcarbyl radicals (also referred to as silylcarbyls, silylcarbyl groups, or silylcarbyl substituents) are radicals in which one or more hydrocarbyl hydrogen atoms have been substituted with at least one SiR*₃ containing group or where at least one —Si(R*)₂— has been inserted within the hydrocarbyl radical or substituted for carbon within the hydrocarbyl radical, where R* is independently a hydrocarbyl or halocarbyl radical, and two or more R* may join together to form a substituted or unsubstituted saturated, partially unsaturated or aromatic cyclic or polycyclic ring structure. Silylcarbyl radicals may be bonded via a silicon atom or a carbon atom.

Substituted silylcarbyl radicals are silylcarbyl radicals in which at least one hydrogen atom has been substituted with at least one functional group such as NR*₂, OR*, SeR*, TeR*, PR*₂, AsR*₂, SbR*₂, SR*, BR*₂, GeR*₃, SnR*₃, PbR₃ and the like or where at least one non-hydrocarbon atom or group has been inserted within the silylcarbyl radical, such as —O—, —S—, —Se—, —Te—, —N(R*)—, ═N—, —P(R*)—, ═P—, —As(R*)—, ═As—, —Sb(R*)—, ═Sb—, —B(R*)—, ═B—, —Ge(R*)₂—, —Sn(R*)₂—, —Pb(R*)₂— and the like, where R* is independently a hydrocarbyl or halocarbyl radical, and two or more R* may join together to form a substituted or unsubstituted saturated, partially unsaturated or aromatic cyclic or polycyclic ring structure.

Halocarbyl radicals (also referred to as halocarbyls, halocarbyl groups or halocarbyl substituents) are radicals in which one or more hydrocarbyl hydrogen atoms have been substituted with at least one halogen (e.g., F, Cl, Br, I) or halogen-containing group (e.g., CF₃).

Substituted halocarbyl radicals are radicals in which at least one halocarbyl hydrogen or halogen atom has been substituted with at least one functional group such as NR*₂, OR*, SeR*, TeR*, PR*₂, AsR*₂, SbR*₂, SR*, BR*₂, SiR*₃, GeR*₃, SnR*₃, PbR*₃, and the like or where at least one non-carbon atom or group has been inserted within the halocarbyl radical such as —O—, —S—, —Se—, —Te—, —N(R*)—, ═N—, —P(R*)—, ═P—, —As(R*)—, ═As—, —Sb(R*)—, ═Sb—, —B(R*)—, ═B—, —Si(R*)₂—, —Ge(R*)₂—, —Sn(R*)₂—, —Pb(R*)₂— and the like, where R* is independently a hydrocarbyl or halocarbyl radical, provided that at least one halogen atom remains on the original halocarbyl radical. Additionally, two or more R* may join together to form a substituted or unsubstituted saturated, partially unsaturated or aromatic cyclic or polycyclic ring structure.

Germylcarbyl radicals (also referred to as germylcarbyls, germylcarbyl groups or germylcarbyl substituents) are radicals in which one or more hydrocarbyl hydrogen atoms have been substituted with at least one GeR*₃ containing group or where at least one —Ge(R*)₂— has been inserted within the hydrocarbyl radical where R* is independently a hydrocarbyl or halocarbyl radical, and two or more R* may join together to form a substituted or unsubstituted saturated, partially unsaturated or aromatic cyclic or polycyclic ring structure. Germylcarbyl radicals may be bonded via a germanium atom or a carbon atom.

Substituted germylcarbyl radicals are germylcarbyl radicals in which at least one hydrogen atom has been substituted with at least one functional group such as NR*₂, OR*, SeR*, TeR*, PR*₂, AsR*₂, SbR*₂, SR*, BR*₂, SiR*₃, SnR*₃, PbR₃ and the like or where at least one non-hydrocarbon atom or group has been inserted within the germylcarbyl radical, such as —O—, —S—, —Se—, —Te—, —N(R*)—, ═N—, —P(R*)—, ═P—, —As(R*)—, ═As—, —Sb(R*)—, ═Sb—, —B(R*)—, ═B—, —Si(R*)₂—, —Sn(R*)₂—, —Pb(R*)₂— and the like, where R* is independently a hydrocarbyl or halocarbyl radical, and two or more R* may join together to form a substituted or unsubstituted saturated, partially unsaturated or aromatic cyclic or polycyclic ring structure.

The terms “linear” or “linear hydrocarbon” refer to a hydrocarbon or hydrocarbyl group having a continuous carbon chain without side chain branching.

The terms “branched” or “branched hydrocarbon” refer to a hydrocarbon or hydrocarbyl group having a linear carbon chain or a carbocyclic ring, in which a hydrocarbyl side chain extends from the linear carbon chain or the carbocyclic ring.

The terms “saturated” or “saturated hydrocarbon” refer to a hydrocarbon or hydrocarbyl group in which all carbon atoms are bonded to four other atoms, with the exception of an unfilled valence position being present upon carbon in a hydrocarbyl group.

The terms “unsaturated” or “unsaturated hydrocarbon” refer to a hydrocarbon or hydrocarbyl group in which one or more carbon atoms are bonded to less than four other atoms, exclusive of an open valence position upon carbon being present. That is, the term “unsaturated” refers to a hydrocarbon or hydrocarbyl group bearing one or more double and/or triple bonds, with the double and/or triple bonds being between two carbon atoms and/or between a carbon atom and a heteroatom.

The terms “alkyl radical,” and “alkyl” are used interchangeably throughout the present disclosure and refer to a hydrocarbyl group having no unsaturated carbon-carbon bonds, and which may be optionally substituted. An alkyl group can be linear, branched, cyclic, or a combination thereof “Alkyl radicals” are defined to be C₁-C₁₀₀ alkyls that may be linear, branched, or cyclic. Examples of such radicals can include methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and the like. Substituted alkyl radicals are radicals in which at least one hydrogen atom of the alkyl radical has been substituted with at least a non-hydrogen group, such as a hydrocarbyl group, a heteroatom, or a heteroatom containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*, —SiR*₃, —GeR*, —GeR*₃, —SnR*, —SnR*₃, —PbR*₃, and the like, where each R* is independently a hydrocarbyl or halocarbyl radical, and two or more R* may join together to form a substituted or unsubstituted saturated, partially unsaturated or aromatic cyclic or polycyclic ring structure, or where at least one heteroatom has been inserted within a hydrocarbyl ring.

The term “branched alkyl” means that an alkyl group contains a tertiary or quaternary carbon (a tertiary carbon is a carbon atom bound to three other carbon atoms; a quaternary carbon is a carbon atom bound to four other carbon atoms). For example, 3,5,5 trimethylhexylphenyl is an alkyl group (hexyl) having three methyl branches (hence, one tertiary and one quaternary carbon) and thus is a branched alkyl bound to a phenyl group.

The terms “cycloalkyl” or “cycloalkyl group” interchangeably refer to a saturated hydrocarbyl group wherein the carbon atoms form one or more ring structures. The terms “cycloalkenyl” or “cycloalkenyl group” interchangeably refer to a cyclic hydrocarbyl group comprising a carbon-carbon double bond in the ring.

The terms “alkene” and “olefin” are used synonymously herein. Similarly, the terms “alkenic” and “olefinic” are used synonymously herein. Unless otherwise noted, all possible geometric isomers are encompassed by these terms. The term “alkenyl” refers to a hydrocarbyl group having a carbon-carbon double bond. Alkenyl groups may be straight-chain, branched-chain, or cyclic and contain one or more carbon-carbon double bonds. Alkenyl radicals may be optionally substituted. Examples of alkenyl can include ethenyl, propenyl, allyl, 1,4-butadienyl, cyclopropenyl, cyclobutenyl, cyclopentenyl, cyclohexenyl, cyclooctenyl and the like.

The term “arylalkenyl” refers to an aryl group where a hydrogen atom has been replaced with an alkenyl or substituted alkenyl group. For example, styryl indenyl is an indene substituted with an arylalkenyl group (a styrene group).

The carbon-carbon double bond in an alkene may be in various structural or geometric isomer forms, which may include vinylidenes, vinyls, disubstituted vinylenes and trisubstituted vinylenes.

The term “vinyl” refers to an olefin represented by the following formula

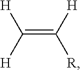

wherein R is a hydrocarbyl group, preferably a saturated hydrocarbyl group such as an alkyl group.

The term “vinylidene” refers to an olefin represented by the following formula

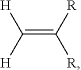

wherein each R is an independently selected hydrocarbyl group, preferably a saturated hydrocarbyl group such as an alkyl group. Vinylidenes are 1,1-disubstituted vinylene groups.

The term “disubstituted vinylene” refers to

(i) an olefin represented by the following formula

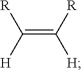

or

(ii) an olefin represented by the following formula

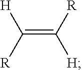

or

(iii) a mixture thereof in any proproption,

wherein each R is an independently selected hydrocarbyl group, preferably a saturated hydrocarbyl group such as an alkyl group. The term “disubstituted vinylene” is not inclusive of the term “vinylidene.” That is, disubstituted vinylenes represent only 1,2-disubstituted vinylene groups and do not include vinylidene groups.

The term “trisubstituted vinylene” refers to an olefin represented by the following formula

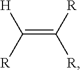

wherein each R is an independently selected hydrocarbyl group, preferably a saturated hydrocarbyl group such as an alkyl group. Alternatively, two R groups on adjacent carbon atoms may together form a non-aromatic ring structure, with a third R group remaining as a pendant hydrocarbyl group.

The term “alpha olefin” refers to an olefin having a terminal carbon-carbon double bond in the structure thereof (R″HC═CH₂, where R″ is hydrogen or a hydrocarbyl group; preferably R″ is an alkyl group). Non-limiting examples of alpha olefins include, for instance, ethylene, propylene, 1-butene, 1-pentene, 1-hexene, 1-heptene, 1-octene, 1-nonene, 1-decene, 1-undecene 1-dodecene, 1-tridecene, 1-tetradecene, 1-pentadecene, 1-hexadecene, 1-heptadecene, 1-octadecene, 1-nonadecene, 1-eicosene, 1-heneicosene, 1-docosene, 1-tricosene, 1-tetracosene, 1-pentacosene, 1-hexacosene, 1-heptacosene, 1-octacosene, 1-nonacosene, 1-triacontene, 4-methyl-1-pentene, 3-methyl-1-pentene, 5-methyl-1-nonene, 3,5,5-trimethyl-1-hexene, vinylcyclohexane, and vinylnorbornane. Any of these alpha olefins may be used to form polyalphaolefins in the disclosure herein.

In the present disclosure, ethylene shall be considered an alpha olefin.

The terms “aromatic,” “aromatic group,” or “aromatic hydrocarbon” refer to a hydrocarbon or hydrocarbyl group having a cyclic arrangement of delocalized, conjugated pi-electrons that satisfies the Hückel rule. The terms “heteroaryl,” “heteroaryl group,” or “heteroaromatic” refer to an aromatic ring containing a heteroatom and which satisfies the Hückel rule, such as an aryl group where a ring carbon atom (or two or three ring carbon atoms) has/have been replaced with a heteroatom, such as N, O, or S.

The term “aryl” is equivalent to the term “aromatic” as defined herein. The term “aryl” refers to both aromatic compounds and heteroaromatic compounds, which may be optionally substituted. Both mononuclear and polynuclear aromatic compounds are encompassed by these terms. As used herein, the term “aromatic” also refers to pseudoaromatic heterocycles, which are heterocyclic compounds having similar properties and structures (nearly planar) to aromatic heterocycles, but are not by definition aromatic. Examples of aryl groups include phenyl and naphthyl.

A substituted aryl is an aryl group where at least one hydrogen atom of the aryl radical has been substituted with at least a non-hydrogen group, such as a hydrocarbyl group, a heteroatom, or a heteroatom containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*, —SiR*₃, —GeR*, —GeR*₃, —SnR*, —SnR*₃, —PbR*₃, and the like, where each R* is independently a hydrocarbyl or halocarbyl radical, and two or more R* may join together to form a substituted or unsubstituted saturated, partially unsaturated or aromatic cyclic or polycyclic ring structure, or where at least one heteroatom has been inserted within a hydrocarbyl ring. For example, 3,5-dimethylphenyl is a substituted aryl group.

The terms “substituted phenyl” and “substituted phenyl group” refer to a phenyl group having one or more hydrogen groups replaced by a hydrocarbyl, substituted hydrocarbyl, heteroatom or heteroatom containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*, —SiR*₃, —GeR*, —GeR*₃, —SnR*, —SnR*₃, —PbR*₃, and the like, where each R* is independently a hydrocarbyl, halogen, or halocarbyl radical. Preferably the “substituted phenyl” group is represented by the formula

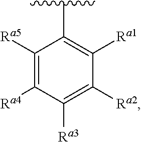

where each of R^{a1}, R^{a2}, R^{a3}, R^{a4}, and R^{a5} is independently selected from hydrogen, C₁-C₄₀ hydrocarbyl or C₁-C₄₀ substituted hydrocarbyl, a heteroatom, such as halogen, or a heteroatom-containing group (provided that at least one of R^{a1}, R^{a2}, R^{a3}, R^{a4}, and R^{a5} is not H), or a combination thereof.

A “fluorophenyl” or “fluorophenyl group” is a phenyl group substituted with one, two, three, four or five fluorine atoms. A “perfluorophenyl” or “perfluorophenyl group” is a phenyl group in which all aromatic ring hydrogen atoms have been substituted with fluorine atoms.

A “fluoronaphthyl” or “fluoronaphthyl group” is a naphthyl group substituted with one, two, three, four, five, six, or seven fluorine atoms. A “perfluoronaphthyl” or “perfluoronaphthyl group” is a naphthyl group in which all aromatic ring hydrogen atoms have been substituted with fluorine atoms.

The term “arylalkyl” refers to an aryl group where a hydrogen has been replaced with an alkyl group or substituted alkyl group. For example, 3,5′-di-tert-butylphenyl indenyl is an indene substituted with an arylalkyl group. When an arylalkyl group is a substituent on another group, it is bound to that group via the aryl.

The term “alkylaryl” refers to an alkyl group where a hydrogen has been replaced with an aryl group or substituted aryl group. For example, phenethyl indenyl is an indene substituted with an ethyl group bound to a phenyl group. When an alkylaryl group is a substituent on another group, it is bound to that group via the alkyl.

The term “aromatic solvent” refers to a solvent comprising one or more aromatic hydrocarbons.

The term “non-aromatic solvent” refers to a solvent comprising any compound that is not an aromatic hydrocarbon and the solvent being substantially devoid of an aromatic hydrocarbon.

The term “aliphatic hydrocarbon solvent” refers to a solvent comprising any alkane solvent and the solvent being substantially devoid of an aromatic hydrocarbon.

Examples of saturated hydrocarbyl groups include, but are not limited to, alkyl groups such as methyl, ethyl, n-propyl, isopropyl, n-butyl, isobutyl, sec-butyl, tert-butyl, pentyl, iso-amyl (isopentyl), neopentyl, hexyl, octyl, cyclopropyl, cyclobutyl, cyclopentyl, cyclohexyl, cyclooctyl, and the like, including their substituted analogues. Examples of unsaturated hydrocarbyl groups include, but are not limited to, ethenyl, propenyl, allyl, butadienyl, cyclopropenyl, cyclobutenyl, cyclopentenyl, cyclohexenyl, cyclooctenyl and the like, including their substituted analogues.

The term “catalyst system” refers to the combination of a transition metal complex and at least one activator, or an activated reaction product form thereof. When used to describe such a combination before activation, the term “catalyst system” refers to the unactivated transition metal complex (precatalyst) together with the at least one activator (cocatalyst). When used to describe such a combination after activation, the term “catalyst system” refers to the activated complex and the at least one activator or other charge-balancing moiety. The transition metal complex may be neutral as in a precatalyst, or a charged species with a counter ion as in an activated catalyst system. For the purposes of this disclosure and the claims associated therewith, when catalyst systems are described as comprising neutral stable forms of the components, it is well understood by one of ordinary skill in the art that the ionic form of the component is the form that reacts with one or more monomers to produce a polymer or oligomre. A polymerization catalyst system is a catalyst system that can polymerize one or more monomers to form a polymer or oligomer containing the one or more monomers.

A scavenger is a compound typically added to a polymerization reaction to facilitate the reaction by scavenging impurities. Some scavengers may also act as activators and may be referred to as co-activators. A co-activator, that is not a scavenger, may be used in conjunction with an activator in order to form an activated catalyst. In some embodiments, a co-activator can be pre-mixed with a catalyst compound to form an alkylated catalyst compound.

A “solution polymerization” refers to a polymerization process in which the polymerization is conducted in a liquid polymerization medium, such as an inert solvent or monomer(s) or their blends. A solution polymerization is typically homogeneous. A homogeneous polymerization is one where the polymer product and catalyst is dissolved in the polymerization medium. Such systems are typically not turbid, as described in Oliveira, J. V. et al. (2000) “High-Pressure Phase Equilibria for Polypropylene-Hydrocarbon Systems,” Ind. Eng. Chem. Res., v. 39(12), pp. 4627-4633.

A bulk polymerization refers to a polymerization process in which the monomers and/or comonomers being polymerized are used as a solvent or diluent using little or no inert solvent or diluent. A small fraction of inert solvent may be used as a carrier for catalyst and scavenger, if desired. A bulk polymerization system contains less than about 25 wt % of inert solvent or diluent, such as less than about 10 wt %, or less than about 1 wt %, including 0 wt %.

The following abbreviations may be used through this specification: o-biphenyl is an ortho-biphenyl moiety represented by the structure

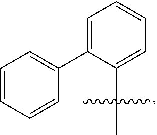 [SMILES: *c1ccccc1-c1ccccc1]

dme is 1,2-dimethoxyethane, Me is methyl, Ph is phenyl, Et is ethyl, Pr is propyl, iPr is isopropyl, n-Pr is normal propyl, cPr is cyclopropyl, Bu is butyl, iBu is isobutyl, tBu is tertiary butyl, p-tBu is para-tertiary butyl, nBu is normal butyl, sBu is sec-butyl, TMS is trimethylsilyl, TIBAL is triisobutylaluminum, TNOAL is tri(n-octyl)aluminum, MAO is methylalumoxane, p-Me is para-methyl, Ph is phenyl, Bn is benzyl (i.e., CH₂Ph), THF (also referred to as thf) is tetrahydrofuran, RT is room temperature (and is 23° C. unless otherwise indicated), tol is toluene, EtOAc is ethyl acetate, MeCy is methylcyclohexane, and Cy is cyclohexyl.

A metallocene catalyst is defined as an organometallic compound with at least one π-bound cyclopentadienyl moiety or substituted cyclopentadienyl moiety (such as substituted or unsubstituted Cp, Ind, or Flu) and more frequently two (or three) π-bound cyclopentadienyl moieties or substituted cyclopentadienyl moieties (such as substituted or unsubstituted Cp, Ind, or Flu). (Cp=cyclopentadienyl, Ind=indenyl, Flu=fluorenyl). Two or more cyclopentadienyl moieties may be bridged together in a metallocene catalyst. A metallocene catalyst may be a transition metal complex as defined herein.

Substituted cyclopentadienyl, indenyl, tetrahydroindenyl or fluorenyl groups are cyclopentadienyl, indenyl, tetrahydroindenyl or fluorenyl groups where at least one hydrogen atom has been replaced with at least a non-hydrogen group, such as a hydrocarbyl group, a heteroatom, or a heteroatom containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*, —SiR*₃, —GeR*, —GeR*₃, —SnR*, —SnR*₃, —PbR*₃, and the like, where each R* is independently a hydrocarbyl or halocarbyl radical, and two or more R* may join together to form a substituted or unsubstituted saturated, partially unsaturated or aromatic cyclic or polycyclic ring structure, or where at least one heteroatom has been inserted within a ring structure.

The terms “alkoxy”, “alkoxyl”, and “alkoxide” refer to an alkyl ether or aryl ether radical, wherein the terms alkyl and aryl are as defined herein. Examples of suitable alkyl ether radicals can include methoxy, ethoxy, n-propoxy, iso-propoxy, n-butoxy, iso-butoxy, sec-butoxy, tert-butoxy, phenoxy, and the like.

The terms “aryloxy” and “aryloxide” refer to an aryl ether radical, wherein the term aryl is as defined herein.

Reference to an alkyl, alkenyl, alkoxide, or aryl group without specifying a particular isomer (e.g., butyl) expressly discloses all isomers (e.g., n-butyl, iso-butyl, sec-butyl, tert-butyl, and cyclobutyl), unless otherwise indicated.

The term “ring atom” refers to an atom that is part of a cyclic ring structure. Accordingly, a benzyl group has six ring atoms and tetrahydrofuran has 5 ring atoms.

In the description herein, a catalyst may be described as a catalyst precursor, a precatalyst compound, a catalyst compound, a transition metal compound, or a transition metal complex, with terms being used interchangeably. A polymerization catalyst or polymerization catalyst system is a catalyst system that can polymerize one or more monomers into a polymer.

An “anionic ligand” is a negatively charged ligand which donates one or more pairs of electrons to a metal ion. A “neutral donor ligand” is a neutrally charged ligand which donates one or more pairs of electrons to a metal ion.

The term “catalyst productivity” refers to a measure of how many grams of polymer (P) are produced using a polymerization catalyst comprising W g of catalyst (cat), over a period of time of T hours; and may be expressed by the following formula: P/(T×W) and expressed in units of gPgcat⁻¹ hr⁻¹. The term “conversion” refers to the amount of monomer that is converted to polymer product, and is reported as mol % and is calculated based on the polymer yield and the amount of monomer fed into the reactor. The term “catalyst activity” is a measure of the level of activity of the catalyst and is reported as the mass of product polymer (P) produced per mole (or mmol) of catalyst (cat) used (kgP/molcat or gP/mmolCat), and catalyst activity can also be expressed per unit of time, for example, per hour (hr), e.g., (Kg/mmol h).

The term “continuous” refers to a system that operates without interruption or cessation for a period of time, such as where reactants are continually fed into a reaction zone and products are continually or regularly withdrawn without stopping the reaction in the reaction zone. For example, a continuous process to produce a polymer is one where the reactants are continually introduced into one or more reactors and polymer product is continually withdrawn.

### Supported Activators and Catalyst Systems

Accordingly, the present disclosure provides supported activators, catalyst systems comprising the supported activators, and methods for polymerizing olefins using the catalyst systems, wherein the use of aromatic solvents is eliminated or substantially minimized during or prior to polymerization. In particular, the activators employed herein are non-coordinating anion activators featuring ammonium or phosphonium cations with long-chain aliphatic hydrocarbyl groups for improved solubility of the activator in aliphatic hydrocarbon solvents, as compared to conventional activator compounds. Useful borate anions that may be present include, but are not limited to, fluorophenyl and fluoronaphthyl borates, preferably perfluorophenyl and perfluoronaphthyl borates. Fluoronaphthyl borates, in particular, may exhibit improved solubility in aliphatic hydrocarbon solvents, as compared to conventional activator compounds. Activators useful in the present disclosure may provide polyolefins having a weight average molecular weight (Mw) of about 100,000 or greater and a melt temperature (Tm) of about 110° C. or greater, with the ability to maintain this performance when deposited upon a suitable support material. The support material may be passivated to aid in maintaining the activator performance.

In another aspect, the present disclosure relates to polymer compositions obtained from the catalyst systems and processes set forth herein. The components of the catalyst systems and the polymerization processes of the present disclosure, as well as the resulting polymer compositions, are described in more detail herein below. Advantageously, the catalyst systems and polymer compositions obtained therefrom may be substantially free of aromatic solvent, in view of catalyst system processing facilitated by the activator solubility in aliphatic hydrocarbon solvents.

Supported activators of the present disclosure may comprise a support material, preferably a passivated support material, and a non-coordinating anion activator deposited on the support material, in which the non-coordinating anion activator has a solubility of at least about 5 mM at 25° C. in at least one aliphatic hydrocarbon solvent. Preferably the solubility is at least about 10 mM at 25° C. in at least one aliphatic hydrocarbon solvent. Suitable non-coordinating anion activators having solubility in aliphatic hydrocarbon solvents and passivated support materials are described in further detail hereinafter.

In non-limiting examples, such supported activators may be prepared by contacting at least one support material with a non-coordinating anion activator dissolved in at least one aliphatic hydrocarbon solvent, and removing the at least one aliphatic hydrocarbon solvent to deposit the non-coordinating anion activator upon the at least one support material, thereby forming the supported activator.

Suitable support materials are not believed to be particularly limited, provided that the support material does not degrade or interfere with the activating capabilities of the non-coordinating anion activator disposed thereon. Preferably, the suitable support materials may be passivated in order to limit degradation or interference with the activating capabilities (e.g., to remove reactive surface groups from the support material). In more specific examples, the support material may be passivated using a hydrocarbyl aluminum compound, such that the passivated support material comprises a reaction product of an unpassivated support material and the hydrocarbyl aluminum compound.

Hydrocarbyl aluminum compounds suitable for passivating reactive surface groups may be alkylaluminum compounds, preferably trialkylaluminum compounds, where the alkyl groups comprise up to 10 carbon atoms. Thus, suitable hydrocarbyl aluminum compounds include, but are not limited to, trimethylaluminum, triethylaluminum, tripropylalumiuum, tri-n-butylaluminum, tri-isobutylaluminum, tri(2-methylpentyl)aluminum, trihexylaluminum, tri-n-octylaluminum, and tri-n-decylaluminum, preferably trimethylaluminum or tri-n-octylaluminum. Other suitable hydrocarbyl aluminum compounds may include, but are not limited to, dimethyl aluminum methoxide, dimethyl aluminum ethoxide, dimethyl aluminum isopropoxide, dimethyl aluminum n-butoxide, dimethyl aluminum isobutoxide, diethyl aluminum methoxide, diethyl aluminum ethoxide, diethyl aluminum isopropoxide, diethyl aluminum n-butoxide, diethyl aluminum isobutoxide, diisobutyl aluminum methoxide, diisobutyl aluminum ethoxide, diisobutyl aluminum isopropoxide, diisobutyl aluminum n-butoxide, diisobutyl aluminum isobutoxide, di-n-hexyl aluminum methoxide, di-n-hexyl aluminum ethoxide, di-n-hexyl aluminum isopropoxide, di-n-hexyl aluminum n-butoxide, di-n-hexyl aluminum isobutoxide, methyl aluminum dimethoxide, methyl aluminum diethoxide, methyl aluminum diisopropoxide, methyl aluminum di-n-butoxide, methyl aluminum diisobutoxide, ethyl aluminum dimethoxide, ethyl aluminum diethoxide, ethyl aluminum diisopropoxide, ethyl aluminum di-n-butoxide, ethyl aluminum diisobtutoxide, isobutyl aluminum dimethoxide, isobutyl aluminum diethoxide, isobutyl aluminum diisopropoxide, isobutyl aluminum di-n-butoxide, isobutyl aluminum diisobutoxide, n-hexylaluminum dimethoxide, n-hexyl aluminum diethoxide, n-hexyl aluminum diisopropoxide, n-hexyl aluminum di-n-butoxide, n-hexyl aluminum diisobutoxide, aluminum trimethoxide, aluminum triethoxide, aluminum triisopropoxide, aluminum tri-n-butoxide, tetramethyldialuminumdiiso-propoxide, tetramethyldialuminumdi-tert-butoxide, tetramethyldialuminumditert-butoxide, pentamethyldialuminumtert-butoxide and aluminum triisobutoxide.

Unpassivated support materials that may be passivated in accordance with the disclosure herein include inorganic oxides such as, but are not limited to, Al₂O₃, ZrO₂, SiO₂, SiO₂/Al₂O₃, SiO₂/TiO₂, silica/clay, silicon oxide/clay, and mixtures thereof, preferably passivated with a trialkylaluminum compound, more preferably silica passivated with a trialkylaluminum compound.

Some or other support materials comprising inorganic oxides suitable for use in supporting a non-coordinating anion activator following passivation include, for example, magnesia, titania, zirconia, montmorillonite, organoclays, phyllosilicate, zeolites, talc, clays, or the like, any of which may be used in combination with silica and/or alumina. Also, combinations of these support materials may be used, for example, silica-chromium, silica-alumina, silica-titania, and the like. Non-oxide support materials such as aluminum phosphate and heteropolytungstates may be used similarly.

Polymeric support materials may also be used in some instances, such as functionalized polyolefins, such as polypropylene.

The support material, such as an inorganic oxide, can have a surface area of about 10 m²/g to about 700 m²/g, a pore volume in the range of about 0.1 cc/g to about 4.0 cc/g and average particle size in the range of about 5 μm to about 500 μm. In at least one embodiment, the surface area of the support material may be in the range of about 50 m²/g to about 500 m²/g, the pore volume may range from about 0.5 cc/g to about 3.5 cc/g, and the average particle size may range from about 10 μm to about 200 μm. In at least one embodiment, the surface area of the support material may be in the range of about 100 m²/g to about 400 m²/g, the pore volume may range from about 0.8 cc/g to about 3.0 cc/g, and the average particle size may range from about 5 μm to about 100 m. The average pore size of support materials useful in the present disclosure may range from about 10 Å to about 1000 Å, such as about 50 Å to about 500 Å, or about 75 Å to about 350 Å.

In at least some embodiments, the support material may be a high surface area, amorphous silica (e.g., surface area of about 300 m²/gm and a pore volume of about 1.65 cm³/g). Exemplary silicas are marketed under the tradenames of DAVISON 952, DAVISON 955, and DAVISON 948 by the Davison Chemical Division of W.R. Grace and Company.

The support material may be dried, that is, substantially free of absorbed water, either before being passivated or before depositing the non-coordinating anion activator thereon. Drying of the support material can be promoted by heating or calcining at about 100° C. to about 1,000° C., such as at least about 600° C., preferably at least before passivating with a hydrocarbyl aluminum compound. When the support material is silica, the unpassivated silica may be heated to at least about 200° C., such as about 200° C. to about 850° C., including at about 600° C., and for a time of about 1 minute to about 100 hours, such as from about 12 hours to about 72 hours, including from about 24 hours to about 60 hours.

To deposit the non-coordinating anion activator upon the support material, an aliphatic hydrocarbon solution of the at least one activator may be contacted with the support material for a period of time, followed by removal of the at least one aliphatic hydrocarbon solvent. Contacting may take place for a period of time ranging from about 0.5 hours to about 24 hours, including from about 2 hours to about 16 hours, or from about 4 hours to about 8 hours. Contact temperatures of about 0° C. to about 70° C. may be used, such as about 23° C. to about 60° C., including contact at room temperature. Following solvent removal, the supported activator may then be isolated. Preferably, at least one transition metal complex may then be deposited upon the passivated support material in a similar manner, again using at least one aliphatic hydrocarbon solvent. Alternately, the at least one transition metal complex may be deposited upon the passivated support material before depositing the non-coordinating anion activator.

Suitable aliphatic hydrocarbon solvents in which contact with the non-coordinating anion activator and/or transition metal complex may take place include, but are not limited to, alkanes, such as isopentane, hexane, isohexane, n-heptane, octane, nonane, and decane, and cycloalkanes, such as cyclohexane, cyclopentane, and methylcyclopentane. As such, the supported activators of the present disclosure and catalyst systems derived therefrom may be substantially free of aromatic solvent.

If desired, the support material may be treated with an electron-withdrawing component that increases the Lewis or Brønsted acidity of the support material as compared to the unmodified support material. In at least one embodiment, the electron-withdrawing component may be an electron-withdrawing anion derived from a salt, an acid, or other compound, such as a volatile organic compound, that serves as a source or precursor for that anion. Electron-withdrawing anions can include, for example, sulfate, bisulfate, fluoride, chloride, bromide, iodide, fluorosulfate, fluoroborate, phosphate, fluorophosphate, trifluoroacetate, triflate, fluorozirconate, fluorotitanate, phosphotungstate, or combinations thereof. Preferable electron-withdrawing anions may include fluoride, chloride, bromide, phosphate, triflate, bisulfate, sulfate, or any combination thereof. Preferably, the electron-withdrawing anion is sulfate, bisulfate, fluoride, chloride, bromide, iodide, fluorosulfate, fluoroborate, phosphate, fluorophosphate, trifluoroacetate, triflate, fluorozirconate, fluorotitanate, or any combination thereof.

Thus, support materials suitable for use in the disclosure herein can include one or more of fluorided alumina, chlorided alumina, bromided alumina, sulfated alumina, fluorided silica-alumina, chlorided silica-alumina, bromided silica-alumina, sulfated silica-alumina, fluorided silica-zirconia, chlorided silica-zirconia, bromided silica-zirconia, sulfated silica-zirconia, fluorided silica-titania, fluorided silica-coated alumina, sulfated silica-coated alumina, phosphated silica-coated alumina, or combinations thereof. In at least one embodiment, the support material may comprise fluorided alumina, sulfated alumina, fluorided silica-alumina, sulfated silica-alumina, fluorided silica-coated alumina, sulfated silica-coated alumina, phosphated silica-coated alumina, or combinations thereof. In another embodiment, the support material may comprise alumina treated with hexafluorotitanic acid, silica-coated alumina treated with hexafluorotitanic acid, silica-alumina treated with hexafluorozirconic acid, silica-alumina treated with trifluoroacetic acid, fluorided boria-alumina, silica treated with tetrafluoroboric acid, alumina treated with tetrafluoroboric acid, alumina treated with hexafluorophosphoric acid, or combinations thereof. Further, any of these support materials optionally can be treated with a metal ion.

Nonlimiting examples of cations suitable for use in combination with an electron-withdrawing anion include ammonium, trialkylammonium, tetraalkylammonium, tetraalkyl phosphonium, H⁺, [H(OEt₂)₂]⁺, or combinations thereof.

Further, combinations of one or more different electron-withdrawing anions, in varying proportions, can be used to tailor the specific acidity of the support material to a desired level. Combinations of electron-withdrawing anions can be contacted with the support material simultaneously or individually, and in any order that provides a desired chemically-treated support material acidity. For example, in at least one embodiment, two or more different electron-withdrawing anions may be contacted with the support material in two or more separate contacting steps.

### Non-Coordinating Anion Activators

Non-coordinating anion (NCA) refers to an anion either that does not coordinate to a transition metal cation within a transition metal complex or that does coordinate to the metal cation, but only weakly. The term NCA is also defined to include multicomponent NCA-containing activators, such as N,N-dioctadecylanilinium tetrakis(perfluoronaphthyl)borate, that contain an acidic cationic group and the non-coordinating anion. The term NCA is also defined to include neutral Lewis acids, such as tris(pentafluorophenyl)boron, that can react with a catalyst compound to form an activated species by abstraction of an anionic group. A NCA coordinates weakly enough that a neutral Lewis base, such as an olefinically or acetylenically unsaturated monomer, can displace the anion from the transition metal cation. Any metal or metalloid that can form a compatible, weakly coordinating complex may be used or contained in the non-coordinating anion. Suitable metals can include aluminum, gold, and platinum. Suitable metalloids can include boron, aluminum, phosphorus, and silicon. The term non-coordinating anion activator includes neutral activators, ionic activators, and Lewis acid activators.

“Compatible” non-coordinating anions include those which are not degraded to neutrality when the initially formed complex decomposes. Further, the anion will not transfer an anionic substituent or fragment to the cation so as to cause it to form a neutral transition metal compound and a neutral by-product from the anion. Non-coordinating anions useful in accordance with the present disclosure are those that are compatible, stabilize the transition metal cation in the sense of balancing its ionic charge at +1, and yet retain sufficient lability to permit displacement during polymerization.

Ammonium or phosphonium metallate or metalloid activator compounds, preferably ammonium or phosphonium borates bearing long-chain aliphatic hydrocarbyl groups and/or long-chain hydrocarbyl ether groups, may possess sufficient solubility in aliphatic hydrocarbon solvents for subsequent deposition upon a support material, as described further herein. Surprisingly, the non-coordinating anion activator may remain active for promoting catalyst activation and olefin polymerization once deposited from aliphatic hydrocarbon solvents, which may particularly be beneficial for promoting gas-phase and slurry phase polymerization reactions in which aromatic solvents are excluded or substantially excluded. Particular non-coordinating anion activators suitable for use in the disclosure herein may have a solubility of at least 5 mM (or at least about 10 mM, or at least 20 mM, or at least 50 mM) at 25° C. in at least one aliphatic hydrocarbon solvent, including a solubility of about 5 mM to about 100 mM, or about 20 mM to about 80 mM, or about 50 mM to about 75 mM at 25° C. in isohexane or methylcyclohexane.

Although ammonium borate non-coordinating anion activators, particularly anilinium borate non-coordinating anion activators, are described as suitable non-coordinating anion activators in particular examples of the present disclosure, it is to be appreciated that other ammonium borate activators and phosphonium borate activators may be employed in a similar manner.

Preferably, supported activators, catalyst systems and polymerization reactions conducted therewith may be substantially free of toluene and other aromatic solvents, such that no detectable toluene or other aromatic solvents are present in the supported activators or the polymer products obtained therewith. For purposes of the present disclosure, “detectable toluene or other aromatic solvents” means 0.1 mg/m² or more as determined by gas phase chromatography. Preferably, supported activators comprising a non-coordinating borate anion, catalyst systems comprising the supported activators, and polymers obtained therewith contain 0 ppm of toluene and other aromatic solvents, alternately about 1 ppm or less of toluene and other aromatic solvents. That is, the supported activators, catalyst systems, polymer compositions, and polymerization reactions conducted in accordance with the disclosure herein may be free (devoid) or substantially free of toluene and other aromatic solvents.

Some non-coordinating anion activators suitable for use in the disclosure herein may have a structure represented by Formula 1

[Ar(EHR¹R²)(Z)]_{d}⁺[G^{k+}Qₙ]^{d-} Formula 1

wherein Ar is an aryl group; E is nitrogen or phosphorous, preferably nitrogen; R¹ and R² are independently selected and comprise a C₁-C₃₀, optionally substituted, alkyl group, preferably a linear alkyl group; Z is R³ or OR³, wherein R³ is a C₁-C₃₀, optionally substituted, alkyl group, preferably a linear alkyl group; G is an element selected from group 13 of the Periodic Table of the Elements, preferably B; d is 1, 2 or 3; k is 1, 2, or 3; n is 1, 2, 3, 4, 5, or 6; n−k=d; and each Q is independently hydride, bridged or unbridged dialkylamido, halide, alkoxide, aryloxide, hydrocarbyl, substituted hydrocarbyl, halocarbyl, substituted halocarbyl, or halosubstituted-hydrocarbyl radical. Among R¹, R², and R³, at least one C₁₀₊ alkyl group and/or at least one C₁₀₊ alkoxy group is present.

In some aspects, Ar may be a phenyl group and E may be nitrogen, such that the activators comprise an anilinium cation. Preferably, such activators may comprise a borate anion, such that the activators have a structure represented by Formula 2

[Ph(NHR¹R²)(Z)]⁺[BQ₄]⁻ Formula 2

wherein the variables are defined as above. Further preferably, each Q may be a halosubstituted aryl group, more preferably a perfluorinated aryl group such as perfluorophenyl, perfluoronaphthyl, perfluorobiphenyl, or the like.

Further, R¹, R², and R³ together may comprise 14 or more carbon atoms, alternately 15 or more carbon atoms, alternately 16 or more carbon atoms, alternately 17 or more carbon atoms, alternately 18 or more carbon atoms, alternately 19 or more carbon atoms, alternately 20 or more carbon atoms, alternately 21 or more carbon atoms, alternately 22 or more carbon atoms, alternately 23 or more carbon atoms, alternately 24 or more carbon atoms, alternately 25 or more carbon atoms, alternately 26 or more carbon atoms, alternately 27 or more carbon atoms, alternately 28 or more carbon atoms, alternately 29 or more carbon atoms, or alternately 30 or more carbon atoms.

In some aspects, R¹ may be a C₁ to C₁₀ linear alkyl group. In particular, in some aspects, R¹ may be methyl, ethyl, propyl, butyl, pentyl, hexyl, heptyl, octyl, nonyl, or decyl. In some aspects, R² may be a C₁-C₂₀, optionally substituted, linear alkyl group, which may be selected independently of R¹. In some aspects, R³ is a C₁₀-C₂₀, optionally substituted, linear alkyl group, which may be selected independently of R¹ and R².

In some aspects, R may be methyl; R² may be methyl, ethyl, n-propyl, n-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, or n-eicosyl; and R³ may be n-decyl, n-undecyl, n-dodecyl, n-tridecyl, n-tetradecyl, n-pentadecyl, n-hexadecyl, n-heptadecyl, n-octadecyl, n-nonadecyl, or n-eicosyl. In certain non-coordinating anion activators, R¹ and R² may both be methyl, and R³ may be n-decyl, n-undecyl, n-dodecyl, n-tridecyl, n-tetradecyl, n-pentadecyl, n-hexadecyl, n-heptadecyl, n-octadecyl, n-nonadecyl, or n-eicosyl.

In some aspects of Formula 1 or Formula 2, R¹, R² and/or R³ may be independently optionally substituted with at least one of halide, C₁-C₅₀ alkyl, C₅-C₅₀ aryl, C₆-C₃₅ arylalkyl, C₆-C₃₅ alkylaryl, —NR′₂, —OR′ or —SiR′₃, where each R′ is independently hydrogen or a C₁-C₂₀ hydrocarbyl group.

In at least one aspect of Formula 1 or Formula 2, E is nitrogen or phosphorous, Ar is an ortho, meta, or para substituted phenyl, preferably a para substituted phenyl, each of R¹ and R² is independently a C₁-C₃₀, optionally substituted, linear alkyl group, and R³ is a C₁₀-C₃₀, optionally substituted, linear alkyl group.

In another aspect of Formula 1 or Formula 2, R¹ is methyl, R² is C₁ to C₃₀ alkyl, and R³ is C₁₀ to C₃₀ linear alkyl.

In another aspect of Formula 1 or Formula 2, R¹ is methyl, R² is methyl, n-decyl, n-tridecyl, or n-eicosyl, and R³ is C₁₀ to C₃₀ linear alkyl.

In another aspect of Formula 1 or Formula 2, R¹ is methyl, R² is methyl, n-decyl, n-tridecyl, or n-icosyl, and R³ is n-decyl, n-tridecyl, or n-eicosyl.

In various aspects, the non-coordinating anion activator may be an ammonium or phosphonium borate having a structure represented by Formula 3

[R¹¹R¹²R¹³EH]⁺[BR¹⁴R¹⁵R¹⁶R¹⁷]⁻ Formula 3

wherein E is nitrogen or phosphorous, preferably nitrogen; R¹¹, R¹², and R¹³ are independently a C₁-C₃₀, optionally substituted, alkyl group (preferably a linear alkyl group), an aryl group, an aryl group substituted with at least one C₁-C₃₀, optionally substituted, alkyl group (preferably a linear alkyl group), an aryl group substituted with at least one C₁-C₃₀, optionally substituted, alkoxy group (preferably a linear alkoxy group), or any combination thereof, provided that among R¹¹, R¹², and R¹³ at least one C₁₀₊ alkyl group or C₁₀₊ alkoxy group is present; and R¹⁴, R¹⁵, R¹⁶, and R¹⁷ are each an independently selected halosubstituted aryl group.

Preferably, each of R¹⁴, R¹⁵, R¹⁶, and R¹⁷ is independently an aryl group substituted with from one to nine fluorine atoms. More preferably, R¹⁴, R¹⁵, R¹⁶, and R¹⁷ are each independently selected perfluoroaryl groups, including perfluoroaryl, perfluoronaphthyl, or perfluorobiphenyl. In at least one aspect, each of R¹⁴, R¹⁵, R¹⁶, and R¹⁷ may independently comprise a naphthyl group comprising one fluorine atom, two fluorine atoms, three fluorine atoms, four fluorine atoms, five fluorine atoms, six fluorine atoms, or seven fluorine atoms, preferably seven fluorine atoms. In at least one aspect, each of R¹⁴, R¹⁵, R¹⁶, and R¹⁷ may independently comprise a phenyl group comprising one fluorine atom, two fluorine atoms, three fluorine atoms, four fluorine atoms, or five fluorine atoms, preferably five fluorine atoms. In at least one aspect, each of R¹⁴, R¹⁵, R¹⁶, and R¹⁷ may independently comprise a biphenyl group comprising one fluorine atom, two fluorine atoms, three fluorine atoms, four fluorine atoms, five fluorine atoms, six fluorine atoms, seven fluorine atoms, eight fluorine atoms, or nine fluorine atoms, preferably nine fluorine atoms.

R¹¹, R¹², and R¹³ together may comprise 14 or more carbon atoms, alternately 15 or more carbon atoms, alternately 16 or more carbon atoms, alternately 17 or more carbon atoms, alternately 18 or more carbon atoms, alternately 19 or more carbon atoms, alternately 20 or more carbon atoms, alternately 21 or more carbon atoms, alternately 22 or more carbon atoms, alternately 23 or more carbon atoms, alternately 24 or more carbon atoms, alternately 25 or more carbon atoms, alternately 26 or more carbon atoms, alternately 27 or more carbon atoms, alternately 28 or more carbon atoms, alternately 29 or more carbon atoms, or alternately 30 or more carbon atoms.

In some aspects of Formula 3, R¹¹ may be a C₁ to C₁₀ linear alkyl group. In particular, in some aspects, R¹¹ may be methyl, ethyl, propyl, butyl, pentyl, hexyl, heptyl, octyl, nonyl, or decyl. In some aspects, R¹² may be a C₁-C₂₀, optionally substituted, linear alkyl group, which may be selected independently of R¹¹. In some aspects, R¹³ is a C₁₀-C₂₀, optionally substituted, linear alkyl group, which may be selected independently of R¹¹ and R¹².

In some aspects of Formula 3, R¹¹ may be methyl; R¹² may be methyl, ethyl, n-propyl, n-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, or n-eicosyl; and R³ may be n-decyl, n-undecyl, n-dodecyl, n-tridecyl, n-tetradecyl, n-pentadecyl, n-hexadecyl, n-heptadecyl, n-octadecyl, n-nonadecyl, or n-eicosyl. In certain non-coordinating anion activators, R¹¹ and R¹² may both be methyl, and R¹³ may be n-decyl, n-undecyl, n-dodecyl, n-tridecyl, n-tetradecyl, n-pentadecyl, n-hexadecyl, n-heptadecyl, n-octadecyl, n-nonadecyl, or n-eicosyl.

In some aspects of Formula 3, R¹¹, R¹² and/or R¹³ may be independently optionally substituted with at least one of halide, C₁-C₅₀ alkyl, C₅-C₅₀ aryl, C₆-C₃₅ arylalkyl, C₆-C₃₅ alkylaryl, —NR′₂, —OR′ or —SiR′₃, where each R′ is independently hydrogen or a C₁-C₂₀ hydrocarbyl group.

In at least one aspect of Formula 3, each of R¹¹ and R¹² is independently a C₁-C₃₀, optionally substituted, linear alkyl group, and R¹³ is a C₁₀-C₃₀, optionally substituted, linear alkyl group.

In another aspect of Formula 3, R¹¹ is methyl, R¹² is C₁ to C₃₀ alkyl, and R¹³ is C₁₀ to C₃₀ linear alkyl.

In another aspect of Formula 3, R¹¹ is methyl, R¹² is methyl, n-decyl, n-tridecyl, or n-eicosyl, and R¹³ is C₁₀ to C₃₀ linear alkyl.

In another aspect of Formula 3, R¹¹ is methyl, R¹² is methyl, n-decyl, n-tridecyl, or n-icosyl, and R³ is n-decyl, n-tridecyl, or n-eicosyl.

In still another aspect of Formula 3, R¹¹ is methyl, R¹² is methyl, n-decyl or n-octadecyl, and R¹³ is n-decyl or n-octadecyl, wherein R¹³ comprises an alkoxy group located upon an aromatic ring.

In at least one aspect of Formula 3, R¹¹ is a methyl group; R¹² is C₁-C₃₀ alkyl group, and R³ is an aryl group substituted with at least one C₁₀-C₃₀ linear alkoxy group, wherein R¹¹, R¹², and R¹³ together comprise 26 or more carbon atoms, such as 30 or more carbon atoms, or such as 40 or more carbon atoms. In at least one aspect, each of R¹ and R² is independently selected from methyl, ethyl, n-propyl, n-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, and n-icosyl, and R³ is selected from phenyl alkoxydecyl, phenyl alkoxyundecyl, phenyl alkoxydodecyl, phenyl alkoxytridecyl, phenyl alkoxytetradecyl, phenyl alkoxypentadecyl, phenyl alkoxyhexadecyl, phenyl alkoxyheptadecyl, phenyl alkoxyoctadecyl, phenyl alkoxynonadecyl, and phenyl alkoxyeicosyl.

The cation portion and anion portion associated with Formulas 1-3 are described in further detail below. Any combination of cations and anions associated with a non-coordinating anion activator disclosed herein may be suitable for use in forming a supported activator of the present disclosure and are thus incorporated herein.

Particular examples of cation portions bearing at least one long-chain alkyl group and/or a long-chain alkoxy group that may be present in the non-coordinating anion activators suitable for use in the disclosure herein include

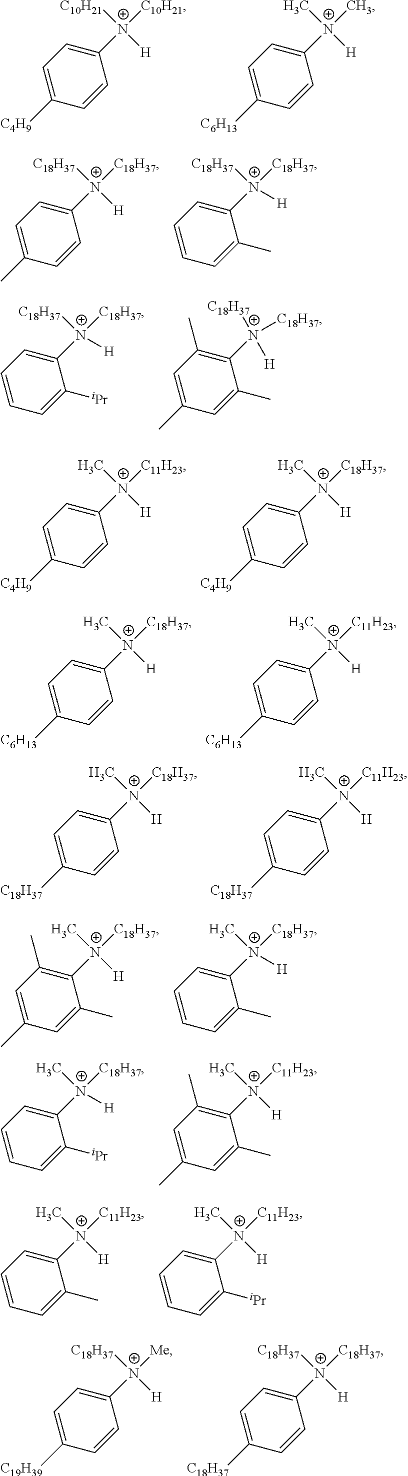

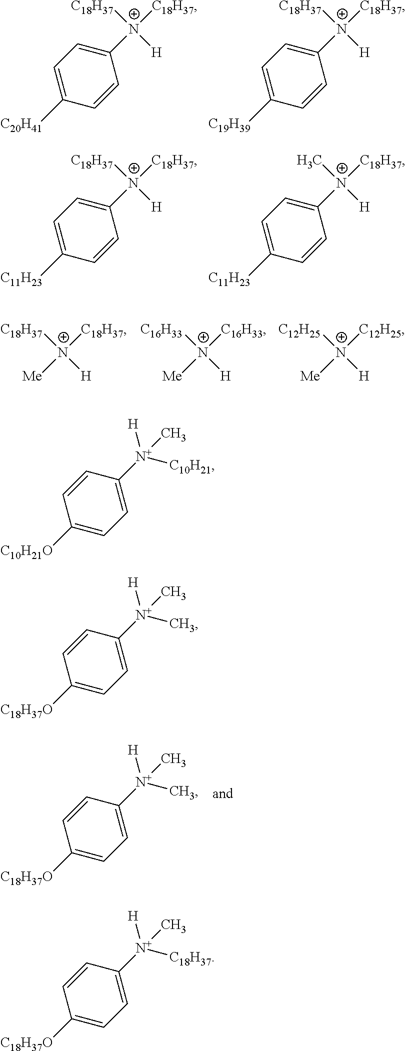

The cation portion of the non-coordinating anion activators disclosed herein are protonated Lewis bases that can be capable of protonating a moiety, such as an alkyl or aryl, from a transition metal complex. Upon release of a neutral leaving group (e.g., an alkane resulting from the combination of a proton donated from the cation portion of the activator and an alkyl substituent of the transition metal complex), a catalytically active transition metal cation results.

Non-coordinating anions that may be present in the non-coordinating anion activators suitable for use herein include those having a structure represented by Formula 4 below

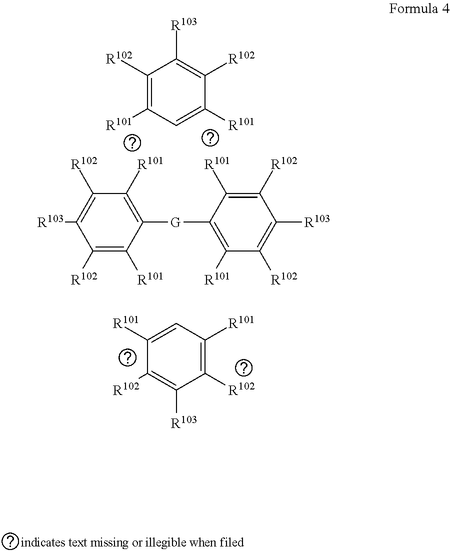

wherein

G is a group 13 atom, preferably B or Al, more preferably B;

each R¹⁰¹ is, independently, a halide, preferably a fluoride;

each R¹⁰² is, independently, a halide, a C₆ to C₂₀ substituted aromatic hydrocarbyl group or a siloxy group of the formula —O—Si—R^{a}, where R^{a} is a C₁ to C₂₀ hydrocarbyl or hydrocarbylsilyl group, preferably R¹⁰² is a fluoride or a perfluorinated phenyl group; each R¹⁰³ is a halide, a C₆ to C₂₀ substituted aromatic hydrocarbyl group or a siloxy group of the formula —O—Si—R^{a}, where R^{a} is a C₁ to C₂₀ hydrocarbyl or hydrocarbylsilyl group, preferably R¹⁰³ is a fluoride or a perfluorinated phenyl group;

wherein R¹⁰² and R¹⁰³ can form one or more saturated or unsaturated, substituted or unsubstituted rings, preferably R¹⁰² and R¹⁰³ form a perfluorinated phenyl ring. Preferably, each R¹⁰¹ is a fluoride, each R¹⁰² is a fluoride or a perfluorinated phenyl ring, and each R¹⁰³ is a fluoride or a perfluorinated phenyl ring, wherein R¹⁰² and R¹⁰³ may be joined together to form the perfluorinated phenyl ring.

In particular examples, G is boron, such that the anion portion is a non-coordinating tetraarylborate. More preferably, the non-coordinating anion activator may comprise an anion portion selected from the group consisting of tetrakis(perfluorophenylborate), tetrakis(perfluoronaphthyl)borate, and tetrakis(perfluorobiphenyl)borate, preferably tetrakis(pentafluorophenyl)borate or tetrakis(heptafluoronaphthyalen-2-yl)borate.

Preferably the anion portion may have a molecular weight of greater than about 700 g/mol, and, more preferably, at least three of the substituents on the G have a molecular volume of greater than 180 cubic Å. “Molecular volume” is used herein as an approximation of spatial steric bulk of an activator molecule in solution. Comparison of substituents with differing molecular volumes allows the substituent with the smaller molecular volume to be considered “less bulky” in comparison to the substituent with the larger molecular volume. Conversely, a substituent with a larger molecular volume may be considered “more bulky” than a substituent with a smaller molecular volume.

Molecular volume may be calculated as reported in Girolami, G. S. (1994) “A Simple “Back of the Envelope” Method for Estimating the Densities and Molecular Volumes of Liquids and Solids,” Journal of Chemical Education, v. 71(11), November 1994, pp. 962-964. Molecular volume (MV), in units of cubic Å, is calculated using the formula: MV=8.3V_{S}, where V_{S} is the scaled volume. V_{S} is the sum of the relative volumes of the constituent atoms, and is calculated from the molecular formula of the substituent using Table 1 below of relative volumes. For fused rings, the V_{S} is decreased by 7.5% per fused ring. The Calculated Total MV of the anion is the sum of the MV per substituent, for example, the MV of perfluorophenyl is 183 Å³, and the Calculated Total MV for tetrakis(perfluorophenyl)borate is four times 183 Å³, or 732 Å³.

TABLE 1

| Element | Relative Volume |
|---|---|
| H | 1 |
| 1^{st} short period, Li to F | 2 |
| 2^{nd} short period, Na to Cl | 4 |
| 1^{st} long period, K to Br | 5 |
| 2^{nd} long period, Rb to I | 7.5 |
| 3^{rd} long period, Cs to Bi | 9 |

Exemplary anions useful herein and their respective scaled volumes and molecular volumes are shown in Table 2 below. The dashed bonds indicate bonding to boron.

TABLE 2

| | | Molecular | | MV | |
|---|---|---|---|---|---|
| | | Formula of | | Per | Calculated |
| | | Each | | subst. | Total MV |
| Ion | Structure of Boron Substituents | Substituent | Vₛ | (Å³) | (Å³) |
| tetrakis(perfluorophenyl)borate | 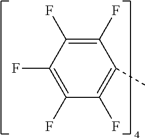 | C₆F₅ | 22 | 183 | 732 |
| tris(perfluorophenyl)- (perfluoronaphthyl)borate | 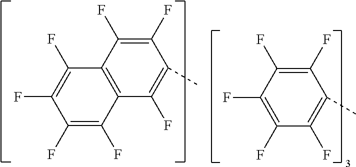 | C₆F₅ C₁₀F₇ | 22 34 | 183 261 | 810 |
| (perfluorophenyl)tris- (perfluoronaphthyl)borate | 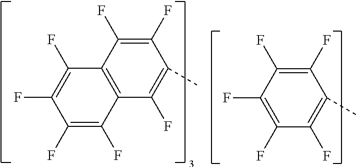 | C₆F₅ C₁₀F₇ | 22 34 | 183 261 | 966 |
| tetrakis(perfluoronaphthyl) borate | 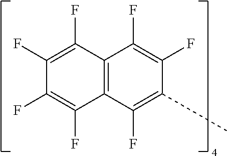 | C₁₀F₇ | 34 | 261 | 1044 |
| tetrakis(perfluorobiphenyl) borate | 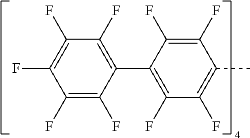 | C₁₂F₉ | 42 | 349 | 1396 |
| [(C₆F₃(C₆F₅)₂)₄B] | 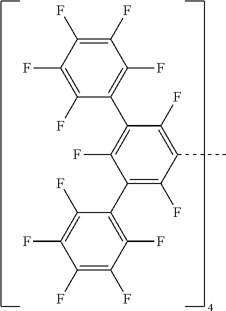 | C₁₈F₁₃ | 62 | 515 | 2060 |

Other non-coordinating anion activators suitable for use in the disclosure herein include those having a cation portion comprising [M2HTH]+, in which a di(hydrogenated tallow)methylamine (“M2HTH”) cation reacts with a basic leaving group on the transition metal complex to form a transition metal complex cation. Alternatively, the transition metal complex may be reacted with a neutral NCA precursor, such as B(C₁₀F₇)₃, which abstracts an anionic group from the complex to form an activated species. Useful activators also include di(hydrogenated tallow)methylamine(perfluoronaphthyl)borate (i.e., [M2HTH]B(C₁₀F₇)₄) and di(octadecyl)tolylamine (perfluoronaphthyl)borate (i.e., [DOdTH]B(C₁₀C₇)₄).

The aliphatic hydrocarbon solubility of the non-coordinating anion activators used in the present disclosure may increase with the number of aliphatic carbons in the cation portion (i.e., the ammonium or the phosphonium cation). In at least one embodiment, an aliphatic hydrocarbon solubility of at least about 5 mM or at least about 10 mM may be achieved with an activator having an ammonium or phosphonium group of about 15 aliphatic carbon atoms or more, such as about 20 aliphatic carbon atoms or more, or such as about 25 aliphatic carbons atoms or more, or such as about 30 carbon atoms or more, or such as about 35 carbon atoms or more. Preferably, the cation may comprise an ammonium cation, which may be an anilinium cation in some instances.

Useful aliphatic hydrocarbon solvents in which the non-coordinating anion activators may be soluble at 25° C. at the foregoing concentrations can include isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof. In at least one embodiment, aromatic solvents are present in the solvent at less than 1 wt %, such as less than 0.5 wt %, such as at 0 wt % based upon the weight of the solvents. The activators of the present disclosure can be dissolved in one or more additional solvents, if desired. Additional solvents may include ethereal, halogenated or N,N-dimethylformamide solvents.

In more specific examples, the non-coordinating anion activator may have a solubility of at least about 5 mM at 25° C. in methylcyclohexane or isohexane.

Preferable examples of supported non-coordinating anion activators include N-methyl-4-nonadecyl-N-octadecylanilinium tetrakis(perfluorophenylborate) and N-methyl-4-nonadecyl-N-octadecylanilinium tetrakis(perfluorophenylborate).

### Catalyst Systems

Catalyst systems of the present disclosure may comprise a supported activator of the present disclosure in combination with a transition metal complex activatable by the supported activator. The supported activator may comprise a support material, preferably a passivated support material, and a non-coordinating anion activator deposited on the support material, in which the non-coordinating anion activator has a solubility of at least about 5 mM at 25° C. in at least one aliphatic solvent. Preferably, the catalyst system may be substantially free of aromatic solvent. Any of the support materials and non-coordinating anion activators provided above may be present in the catalyst systems described herein.

The typical activator-to-catalyst ratio (e.g., the activator to transition metal complex molar ratio) may be about a 1:1 molar ratio. Alternate preferred ranges may include from 0.1:1 to 100:1, alternately from 0.5:1 to 200:1, alternately from 1:1 to 500:1 alternately from 1:1 to 1000:1. A particularly useful range is from 0.5:1 to 10:1, preferably 1:1 to 5:1.

The transition metal complex activatable by the non-coordinating anion activator may also be deposited upon the passivated support material. Alternately, the present disclosure provides catalyst systems in which the transition metal complex is deposited upon a support material different from the passivated support material. That is, the catalyst systems of the present disclosure may feature the transition metal complex deposited in the same location as the non-coordinating anion activator or in a different location.

Suitable transition metal complexes for incorporation in the catalyst systems are discussed in further detail below. Preferably, the transition metal complex may have a solubility of at least about 5 mM at 25° C. in at least one aliphatic hydrocarbon solvent.

In addition to the non-coordinating anion activators, scavengers or co-activators may be present in the catalyst systems disclosed herein. Aluminum alkyl or organozinc compounds which may be utilized as scavengers or co-activators in the disclosure herein include, for example, trimethylaluminum, triethylaluminum, triisobutylaluminum, tri-n-hexylaluminum, tri-n-octylaluminum, and diethyl zinc. The scavenger may be deposited upon a support material in some instances.

In at least one embodiment, little or no scavenger is used in the process to produce the ethylene polymer. Scavenger (such as trialkyl aluminum) can be present at zero mol %. Alternately, the scavenger may be present at a molar ratio of scavenger metal to transition metal of less than 100:1, such as less than 50:1, such as less than 15:1, or such as less than 10:1.

### Transition Metal Complexes

Any transition metal complex capable of catalyzing a reaction, particularly a polymerization reaction, upon activation with a non-coordinating anion activator as specified above may be suitable for use in forming a catalyst system and conducting a polymerization process according to the present disclosure. Both metallocene catalysts and non-metallocene catalysts, both of which are transition metal complexes, may be suitably used in the various embodiments of the present disclosure.

Transition metal complexes suitable for use in the disclosure herein may comprise a group 3 through group 12 metal atom, such as a group 3 through group 10 metal atom, or a lanthanide atom. The transition metal complex may be monodentate or multidentate, such as bidentate, tridentate, or tetradentate, where a heteroatom of the complex, such as phosphorous, oxygen, nitrogen, or sulfur is chelated to the metal atom of the complex. In at least one embodiment, the group 3 through group 12 metal atom is selected from group 5, group 6, group 8, or group 10 metal atoms. In at least one embodiment, a group 3 through group 10 metal atom is selected from Cr, Sc, Ti, Zr, Hf, V, Nb, Ta, Mn, Re, Fe, Ru, Os, Co, Rh, Ir, and Ni. In at least one embodiment, a metal atom is selected from groups 4, 5, and 6 metal atoms. In at least one embodiment, a metal atom is a group 4 metal atom selected from Ti, Zr, or Hf. The oxidation state of the metal atom can range from 0 to +7, for example +1, +2, +3, +4, or +5, for example +2, +3, or +4.

A “metallocene” complex is preferably a transition metal catalyst compound having one, two, or three, typically one or two, substituted or unsubstituted cyclopentadienyl ligands (such as substituted or unsubstituted Cp, Ind or Flu) bound to the transition metal. Metallocene complexes useful herein include metallocenes comprising group 3 to group 12 metal complexes, such as, group 4 to group 6 metal complexes, for example, group 4 metal complexes. The metallocene complexes of catalyst systems of the present disclosure may be unbridged metallocene catalyst compounds represented by the formula: Cp^{A}Cp^{B}M′X′n, wherein each Cp^{A} and Cp^{B} is independently selected from cyclopentadienyl ligands (for example, Cp, Ind, or Flu) and ligands isolobal to cyclopentadienyl, one or both Cp^{A} and Cp^{B} may contain heteroatoms, and one or both Cp^{A} and Cp^{B} may be substituted by one or more R″ groups; M′ is selected from groups 3 through 12 atoms and lanthanide group atoms; X is an anionic leaving group; n is 0 or an integer from 1 to 4; each R″ is independently selected from alkyl, substituted alkyl, heteroalkyl, alkenyl, substituted alkenyl, heteroalkenyl, alkynyl, substituted alkynyl, heteroalkynyl, alkoxy, aryloxy, alkylthio, arylthio, aryl, substituted aryl, heteroaryl, aralkyl, aralkylene, alkaryl, alkarylene, haloalkyl, haloalkenyl, haloalkynyl, heteroalkyl, heterocycle, heteroaryl, a heteroatom-containing group, hydrocarbyl, substituted hydrocarbyl, heterohydrocarbyl, silyl, boryl, phosphino, phosphine, amino, amine, ether, and thioether.

In at least one embodiment, each Cp^{A} and Cp^{B} is independently selected from cyclopentadienyl, indenyl, fluorenyl, indacenyl, tetrahydroindenyl, cyclopentaphenanthreneyl, benzindenyl, fluorenyl, octahydrofluorenyl, cyclooctatetraenyl, cyclopentacyclododecene, phenanthrindenyl, 3,4-benzofluorenyl, 9-phenylfluorenyl, 8-H-cyclopent[a]acenaphthylenyl, 7-H-dibenzofluorenyl, indeno[1,2-9]anthrene, thiophenoindenyl, thiophenofluorenyl, hydrogenated and substituted versions thereof. Each Cp^{A} and Cp^{B} may independently be indacenyl or tetrahydroindenyl.

The metallocene may be a bridged metallocene catalyst compound represented by the formula: Cp^{A}(T)Cp^{B}M′X′ₙ, wherein each Cp^{A} and Cp^{B} is independently selected from cyclopentadienyl ligands (for example, Cp, Ind, or Flu) and ligands isolobal to cyclopentadienyl, where one or both Cp^{A} and Cp^{B} may contain heteroatoms, and one or both Cp^{A} and Cp^{B} may be substituted by one or more R″ groups; M′ is selected from groups 3 through 12 atoms and lanthanide group atoms, preferably group 4; X is an anionic leaving group; n is 0 or an integer from 1 to 4; (T) is a bridging group selected from divalent alkyl, divalent substituted alkyl, divalent heteroalkyl, divalent alkenyl, divalent substituted alkenyl, divalent heteroalkenyl, divalent alkynyl, divalent substituted alkynyl, divalent heteroalkynyl, divalent alkoxy, divalent aryloxy, divalent alkylthio, divalent arylthio, divalent aryl, divalent substituted aryl, divalent heteroaryl, divalent aralkyl, divalent aralkylene, divalent alkaryl, divalent alkarylene, divalent haloalkyl, divalent haloalkenyl, divalent haloalkynyl, divalent heteroalkyl, divalent heterocycle, divalent heteroaryl, a divalent heteroatom-containing group, divalent hydrocarbyl, divalent substituted hydrocarbyl, divalent heterohydrocarbyl, divalent silyl, divalent boryl, divalent phosphino, divalent phosphine, divalent amino, divalent amine, divalent ether, and divalent thioether. R″ is selected from alkyl, substituted alkyl, heteroalkyl, alkenyl, substituted alkenyl, heteroalkenyl, alkynyl, substituted alkynyl, heteroalkynyl, alkoxy, aryloxy, alkylthio, arylthio, aryl, substituted aryl, heteroaryl, aralkyl, aralkylene, alkaryl, alkarylene, haloalkyl, haloalkenyl, haloalkynyl, heteroalkyl, heterocycle, heteroaryl, a heteroatom-containing group, hydrocarbyl, substituted hydrocarbyl, heterohydrocarbyl, silyl, boryl, phosphino, phosphine, amino, amine, germanium, ether, and thioether.

In at least one embodiment, each of Cp^{A} and Cp^{B} is independently selected from cyclopentadienyl, indenyl, fluorenyl, cyclopentaphenanthreneyl, benzindenyl, fluorenyl, octahydrofluorenyl, cyclooctatetraenyl, cyclopentacyclododecene, phenanthrindenyl, 3,4-benzofluorenyl, 9-phenylfluorenyl, 8-H-cyclopent[a]acenaphthylenyl, 7-H-dibenzofluorenyl, indeno[1,2-9]anthrene, thiophenoindenyl, thiophenofluorenyl, hydrogenated, and substituted versions thereof, preferably cyclopentadienyl, n-propylcyclopentadienyl, indenyl, pentamethylcyclopentadienyl, tetramethylcyclopentadienyl, and n-butylcyclopentadienyl. Each Cp^{A} and Cp^{B} may independently be indacenyl or tetrahydroindenyl.

(T) is a bridging group containing at least one group 13, 14, 15, or 16 element, in particular boron or a group 14, 15 or 16 element, preferably (T) is O, S, NR′, or SiR′₂, where each R′ is independently hydrogen or C₁-C₂₀ hydrocarbyl.

In another embodiment, the metallocene may be represented by the formula T_{y}CpₘMGₙX_{q}, where Cp is independently a substituted or unsubstituted cyclopentadienyl ligand (for example, substituted or unsubstituted Cp, Ind, or Flu) or substituted or unsubstituted ligand isolobal to cyclopentadienyl; M is a group 4 transition metal; G is a heteroatom group represented by the formula JR*z where J is N, P, O or S, and R* is a linear, branched, or cyclic C₁-C₂₀ hydrocarbyl; z is 1 or 2; T is a bridging group; y is 0 or 1; X is a leaving group; m=1, n=1, 2, or 3, q=0, 1, 2, or 3, and the sum of m+n+q is equal to the coordination number of the transition metal.

In at least one embodiment, J is N, and R* is methyl, ethyl, propyl, butyl, pentyl, hexyl, heptyl, octyl, nonyl, cyclooctyl, cyclododecyl, decyl, undecyl, dodecyl, adamantly, or an isomer thereof.

In at least one embodiment, the metallocene is represented by Formula 4

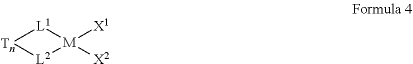

wherein M is a group 4 metal, such as titanium, zirconium or hafnium; n is 0 or 1; T is an optional bridging group selected from dialkylsilyl, diarylsilyl, dialkylmethyl, diarylmethyl, ethylenyl, or hydrocarbylethylenyl wherein one, two, three or four of the hydrogen atoms in ethylenyl are substituted by hydrocarbyl; L¹ and L² are independently cyclopentadienyl, substituted cyclopentadienyl, indenyl, substituted indenyl, tetrahydroindenyl, substituted tetrahydroindenyl, fluorenyl, or substituted fluorenyl groups; and X¹ and X² are, independently, hydrogen, halogen, hydrocarbyl, substituted hydrocarbyl, halocarbyl, substituted halocarbyl, silyl, silylcarbyl, substituted silylcarbyl, germylcarbyl, substituted germylcarbyl, aryl, substituted aryl, heteroaryl, substituted heteroaryl, alkoxy, substituted alkoxy, aryloxy, substituted aryloxy, boryl, amino, phosphino, ether, thioether, phosphine, amine, carboxylate, alkylthio, arylthio, 1,3-dionate, oxalate, carbonate, nitrate, or sulphate, or both X¹ and X² are joined and bound to the metal atom to form a metallacycle ring containing from about 3 to about 20 carbon atoms; or both together can be an olefin, diolefin or aryne ligand.

Preferably, T in any formula herein is present and is a bridging group containing at least one group 13, 14, 15, or 16 element, in particular a group 14 element. Examples of suitable bridging groups T include, for example, P(═S)R′, P(═Se)R′, P(═O)R′, R′₂C, R′₂Si, R′₂Ge, R′₂CCR′₂, R′₂CCR′₂CR′₂, R′₂CCR′₂CR′₂CR′₂, R′C═CR′, R′C═CR′CR′₂, R′₂CCR′═CR′CR′₂, R′C═CR′CR′═CR′, R′C═CR′CR′₂CR′₂, R′₂CSiR′₂, R′₂SiSiR′₂, R′₂SiOSiR′₂, R′₂CSiR′₂CR′₂, R′₂SiCR′₂SiR′₂, R′C═CR′SiR′₂, R′₂CGeR′₂, R′₂GeGeR′₂, R′₂CGeR′₂CR′₂, R′₂GeCR′₂GeR′₂, R′₂SiGeR′₂, R′C═CR′GeR′₂, R′B, R′₂C—BR′, R′₂C—BR′—CR′₂, R′₂C—O—CR′₂, R′₂CR′₂C—O—CR′₂CR′₂, R′₂C—O—CR′₂CR′₂, R′₂C—O—CR′═CR′, R′₂C—S—CR′₂, R′₂CR′₂C—S—CR′₂CR′₂, R′₂C—S—CR′₂CR′₂, R′₂C—S—CR′═CR′, R′₂C—Se—CR′₂, R′₂CR′₂C—Se—CR′₂CR′₂, R′₂C—Se—CR′₂CR′₂, R′₂C—Se—CR′═CR′, R′₂C—N═CR′, R′₂C—NR′—CR′₂, R′₂C—NR′—CR′₂CR′₂, R′₂C—NR′—CR′═CR′, R′₂CR′₂C—NR′—CR′₂CR′₂, R′₂C—P═CR′, R′₂C—PR′—CR′₂, O, S, Se, Te, NR′, PR′, AsR′, SbR′, O—O, S—S, R′N—NR′, R′P—PR′, O—S, O—NR′, O—PR′, S—NR′, S—PR′, and R′N—PR′ where R′ is hydrogen or a C₁-C₂₀ containing hydrocarbyl, substituted hydrocarbyl, halocarbyl, substituted halocarbyl, silylcarbyl or germylcarbyl substituent and optionally two or more adjacent R′ may join to form a substituted or unsubstituted, saturated, partially unsaturated or aromatic, cyclic or polycyclic substituent. Preferred examples for bridging group T include CH₂, CH₂CH₂, SiMe₂, SiPh₂, SiMePh, Si(CH₂)₃, Si(CH₂)₄, O, S, NPh, PPh, NMe, PMe, NEt, NPr, NBu, PEt, PPr, Me₂SiOSiMe₂, and PBu.

In at least one aspect, T may be represented by the formula R^{a}₂J or (R^{a}₂J)₂, where J is C, Si, or Ge, and each R^{a} is, independently, hydrogen, halogen, C₁ to C₂₀ hydrocarbyl (such as methyl, ethyl, propyl, butyl, pentyl, hexyl, heptyl, octyl, nonyl, decyl, undecyl, or dodecyl) or a C₁ to C₂₀ substituted hydrocarbyl, and two R^{a} can form a cyclic structure including aromatic, partially saturated, or saturated cyclic, or fused ring system. Preferably, T is a bridging group comprising carbon or silicon, such as dialkylsilyl. More preferably, T is selected from CH₂, CH₂CH₂, C(CH₃)₂, SiMe₂, SiPh₂, SiMePh, silylcyclobutyl (Si(CH₂)₃), (Ph)₂C, (μ-(Et)₃SiPh)₂C, Me₂SiOSiMe₂, and cyclopentasilylene (Si(CH₂)₄).

In at least one aspect, the transition metal complex has a symmetry that is C₂ symmetrical.

Suitable metallocenes useful herein include, but are not limited to, the metallocenes disclosed and referenced in the US patents cited above, as well as those disclosed and referenced in U.S. Pat. Nos. 7,179,876; 7,169,864; 7,157,531; 7,129,302; 6,995,109; 6,958,306; 6,884,748; 6,689,847; US Patent publication 2007/0055028, and published PCT Applications WO 1997/022635; WO 2000/069922; WO 2001/030860; WO 2001/030861; WO 2002/046246; WO 2002/050088; WO 2004/026921; and WO 2006/019494, all fully incorporated herein by reference. Additional transition metal complexes suitable for use herein include those referenced in U.S. Pat. Nos. 6,309,997; 6,265,338; US Patent publication 2006/019925, and the following articles: Resconi, L. et al. (2000) “Selectivity in Propene Polymerization with Metallocene Catalysts,” Chem. Rev., v. 100(4), pp. 1253-1346; Gibson, V. C. et al. (2003) “Advances in Non-Metallocene Olefin Polymerization Catalysis,” Chem. Rev., v. 103(1), pp. 283-316; Chem Eur. J (2006), v. 12, p. 7546; Nakayama, Y. et al. (2004), “Olefin Polymerization Behavior of bis(phenoxy-imine) Zr, Ti, and V complexes with MgCl₂-based Cocatalysts,” J Mol. Catalysis A: Chemical, v. 213, pp. 141-150; Nakayama, Y. et al. (2005), Propylene Polymerization Behavior of Fluorinated Bis(phenoxy-imine) Ti Complexes with an MgCl₂-Based Compound (MgCl₂-Supported Ti-Based Catalysts),” Macromol. Chem. Phys., v. 206(18), pp. 1847-1852; and Matsui, S. et al. (2001) “A Family of Zirconium Complexes Having Two Phenoxy-Imine Chelate Ligands for Olefin Polymerization,” J. Am. Chem. Soc., v. 123(28), pp. 6847-6856.

Exemplary metallocenes useful herein include:
bis(cyclopentadienyl)zirconium dichloride,
bis(n-butylcyclopentadienyl)zirconium dichloride,
bis(n-butylcyclopentadienyl)zirconium dimethyl,
bis(pentamethylcyclopentadienyl)zirconium dichloride,
bis(pentamethylcyclopentadienyl)zirconium dimethyl,
bis(pentamethylcyclopentadienyl)hafnium dichloride,
bis(pentamethylcyclopentadienyl)zirconium dimethyl,
bis(1-methyl-3-n-butylcyclopentadienyl)zirconium dichloride,
bis(1-methyl-3-n-butylcyclopentadienyl)zirconium dimethyl,
bis(1-methyl-3-n-butylcyclopentadienyl)hafnium dichloride,
bis(1-methyl-3-n-butylcyclopentadienyl)zirconium dimethyl,
bis(indenyl)zirconium dichloride, bis(indenyl)zirconium dimethyl,
bis(tetrahydro-1-indenyl)zirconium dichloride,
bis(tetrahydro-1-indenyl)zirconium dimethyl,
(n-propyl cyclopentadienyl, pentamethyl cyclopentadienyl)zirconium dichloride, and
(n-propyl cyclopentadienyl, pentamethyl cyclopentadienyl)zirconium dimethyl.

In at least one aspect, the transition metal complex may be selected from:
dimethylsilylbis(tetrahydroindenyl)MXₙ,
dimethylsilyl bis(2-methylindenyl)MXₙ,
dimethylsilyl bis(2-methylfluorenyl)MXₙ,
dimethylsilyl bis(2-methyl-5,7-propylindenyl)MXₙ,
dimethylsilyl bis(2-methyl-4-phenylindenyl)MXₙ,
dimethylsilyl bis(2-ethyl-5-phenylindenyl)MXₙ,
dimethylsilyl bis(2-methyl-4-biphenylindenyl)MXₙ,
dimethylsilylene bis(2-methyl-4-carbazolylindenyl)MXₙ,
rac-dimethylsilyl-bis-(5,6,7,8-tetrahydro-5,5,8,8-tetramethyl-2-methyl-1H-benz(f)indene)MXₙ,
diphenylmethylene (cyclopentadienyl)(fluoreneyl)MXₙ,
bis(methylcyclopentadienyl)MXₙ,
rac-dimethylsiylbis(2-methyl,3-propyl indenyl)MXₙ,
dimethylsilylbis(indenyl)MXₙ,
rac-meso-diphenylsilyl-bis(n-propylcyclopentadienyl)MXₙ,
1,1′-bis(4-triethylsilylphenyl)methylene-(cyclopentadienyl)(3,8-di-tertiary-butyl-1-fluorenyl)MX (bridge is considered the 1 position),
bis-trimethylsilylphenyl-methylene(cyclopentadienyl)(di-t-butylfluorenyl)MXₙ,
bis-trimethylsilylphenyl-methylene(cyclopentadienyl)(fluorenyl)MXₙ,
bisphenylmethylene(cyclopentadienyl)(dimethylfluorenyl)MXₙ,
bis(n-propylcyclopentadienyl)MXₙ,
bis(n-butylcyclopentadienyl)MXₙ,
bis(n-pentylcyclopentadienyl)MXₙ,
(n-propyl cyclopentadienyl)(n-butylcyclopentadienyl)MXₙ,
bis[(2-trimethylsilylethyl)cyclopentadienyl]MXₙ,
bis(trimethylsilyl cyclopentadienyl)MXₙ,
dimethylsilylbis(n-propylcyclopentadienyl)MXₙ,
dimethylsilylbis(n-butylcyclopentadienyl)MXₙ,
bis(1-n-propyl-2-methylcyclopentadienyl)MXₙ,
(n-propylcyclopentadienyl)(1-n-propyl-3-n-butylcyclopentadienyl)MXₙ,
bis(1-methyl, 3-n-butyl cyclopentadienyl)MXₙ,
bis(indenyl)MXₙ,
dimethylsilyl (tetramethylcyclopentadienyl)(cyclododecylamido)MXₙ,
dimethylsilyl (tetramethylcyclopentadienyl)(t-butylamido)MXₙ,
1,1′-bis(4-triethylsilylphenyl)(methylene)(cyclopentadienyl)(fluorenyl)MXₙ;
μ-(CH₃)₂Si(cyclopentadienyl)(1-adamantylamido)MXₙ,
μ-(CH₃)₂Si(3-tertbutylcyclopentadienyl)(1-adamantylamido)MXₙ,
μ-(CH₃)₂(tetramethylcyclopentadienyl)(1-adamantylamido)MXₙ,
μ-(CH₃)₂Si(tetramethylcyclopentadienyl)(1-adamantylamido)MXₙ,
μ-(CH₃)₂C(tetramethylcyclopentadienyl)(1-adamantylamido)MXₙ,
μ-(CH₃)₂Si(tetramethylcyclopentadienyl)(1-tertbutylamido)MXₙ,
μ-(CH₃)₂Si(fluorenyl)(1-tertbutylamido)MXₙ,
μ-(CH₃)₂Si(tetramethylcyclopentadienyl)(1-cyclododecylamido)MXₙ,
μ-(C₆H₅)₂C(tetramethylcyclopentadienyl)(1-cyclododecylamido)MXₙ, and
μ-(CH₃)₂Si(η⁵-2,6,6-trimethyl-1,5,6,7-tetrahydro-s-indacen-1-yl)(tertbutylamido)MXₙ,
   where M is selected from Ti, Zr, and Hf; where X is selected from the group consisting of halogens, hydrides, C₁₋₁₂ alkyls, C₂₋₁₂ alkenyls, C₆₋₁₂ aryls, C₇₋₂₀ alkylaryls, C₁₋₁₂ alkoxys, C₆₋₁₆ aryloxys, C₇₋₁₈ alkylaryloxys, C₁₋₁₂ fluoroalkyls, C₆₋₁₂ fluoroaryls, and C₁₋₁₂ heteroatom-containing hydrocarbons, substituted derivatives thereof, and combinations thereof, and where n is zero or an integer from 1 to 4, and preferably X is selected from halogens (such as bromide, fluoride, chloride), or C₁ to C₂₀ alkyls (such as methyl, ethyl, propyl, butyl, and pentyl) and n is 1 or 2, preferably 2.

The transition metal complex may also include one or more of:
bis(1-methyl, 3-n-butyl cyclopentadienyl) M(R)₂;
dimethylsilyl bis(indenyl)M(R)₂;
bis(indenyl)M(R)₂;
dimethylsilyl bis(tetrahydroindenyl)M(R)₂;
bis(n-propylcyclopentadienyl)M(R)₂;
dimethylsilyl (tetramethylcyclopentadienyl)(cyclododecylamido)M(R)₂;
dimethylsilyl (tetramethylcyclopentadienyl)(cyclododecylamido)M(R)₂;
dimethylsilyl (tetramethylcyclopentadienyl)(t-butylamido)M(R)₂;
dimethylsilyl (tetramethylcyclopentadienyl)(t-butylamido)M(R)₂;
1,1′-bis(4-triethylsilylphenyl)(methylene)(cyclopentadienyl)(fluorenyl)M(R)₂;
μ-(CH₃)₂Si(cyclopentadienyl)(1-adamantylamido)M(R)₂;
μ-(CH₃)₂Si(3-tertbutylcyclopentadienyl)(1-adamantylamido)M(R)₂;
μ-(CH₃)₂(tetramethylcyclopentadienyl)(1-adamantylamido)M(R)₂;
μ-(CH₃)₂Si(tetramethylcyclopentadienyl)(1-adamantylamido)M(R)₂;
μ-(CH₃)₂C(tetramethylcyclopentadienyl)(1-adamantylamido)M(R)₂;
μ-(CH₃)₂Si(tetramethylcyclopentadienyl)(1-tertbutylamido)M(R)₂;
μ-(CH₃)₂Si(fluorenyl)(1-tertbutylamido)M(R)₂;
μ-(CH₃)₂Si(tetramethylcyclopentadienyl)(1-cyclododecylamido)M(R)₂;
μ-(C₆H₅)₂C(tetramethylcyclopentadienyl)(1-cyclododecylamido)M(R)₂; and
μ-(CH₃)₂Si(η⁵-2,6,6-trimethyl-1,5,6,7-tetrahydro-s-indacen-1-yl)(tertbutylamido)M(R)₂;
   where M is selected from Ti, Zr, and Hf; and R is selected from halogen or C₁ to C₅ alkyl.

In preferred aspects, the transition metal complex may comprise one or more of: dimethylsilyl (tetramethylcyclopentadienyl)(cyclododecylamido)titanium dimethyl; dimethylsilyl (tetramethylcyclopentadienyl)(cyclododecylamido)titanium dimethyl; dimethylsilyl (tetramethylcyclopentadienyl)(t-butylamido)titanium dimethyl; dimethylsilyl (tetramethylcyclopentadienyl)(t-butylamido)titanium dimethyl;
μ-(CH₃)₂Si(cyclopentadienyl)(1-adamantylamido)titanium dimethyl;
μ-(CH₃)₂Si(3-tertbutylcyclopentadienyl)(1-adamantylamido)titanium dimethyl;
μ-(CH₃)₂(tetramethylcyclopentadienyl)(1-adamantylamido)titanium dimethyl;
μ-(CH₃)₂Si(tetramethylcyclopentadienyl)(1-adamantylamido)titanium dimethyl;
μ-(CH₃)₂C(tetramethylcyclopentadienyl)(1-adamantylamido)titanium dimethyl;
μ-(CH₃)₂Si(tetramethylcyclopentadienyl)(1-tertbutylamido)titanium dimethyl₂;
μ-(CH₃)₂Si(fluorenyl)(1-tertbutylamido)titanium dimethyl;
μ-(CH₃)₂Si(tetramethylcyclopentadienyl)(1-cyclododecylamido)titanium dimethyl;
μ-(C₆H₅)₂C(tetramethylcyclopentadienyl)(1-cyclododecylamido)titanium dimethyl; and/or
μ-(CH₃)₂Si(η⁵-2,6,6-trimethyl-1,5,6,7-tetrahydro-s-indacen-1-yl)(tertbutylamido)titanium dimethyl.

In at least one aspect, the transition metal complex may comprise rac-dimethylsilyl-bis(indenyl)hafnium dimethyl and/or 1,1′-bis(4-triethylsilylphenyl)methylene-(cyclopentadienyl)(3,8-di-tertiary-butyl-1-fluorenyl)hafnium dimethyl and/or dimethylsilyl bis(tetrahydroindenyl)zirconium dimethyl.

In at least one aspect, the transition metal complex may comprise one or more of
bis(1-methyl, 3-n-butyl cyclopentadienyl)hafnium dimethyl,
bis(1-methyl, 3-n-butyl cyclopentadienyl)zirconium dimethyl,
dimethylsilyl bis(indenyl)zirconium dimethyl,
dimethylsilyl bis(indenyl)hafnium dimethyl,
bis(indenyl)zirconium dimethyl,
bis(indenyl)hafnium dimethyl,
dimethylsilyl bis(tetrahydroindenyl)zirconium dimethyl,
bis(n-propylcyclopentadienyl)zirconium dimethyl,
dimethylsilylbis(tetrahydroindenyl)hafnium dimethyl,
dimethylsilyl bis(2-methylindenyl)zirconium dimethyl,
dimethylsilyl bis(2-methylfluorenyl)zirconium dimethyl,
dimethylsilyl bis(2-methylindenyl)hafnium dimethyl,
dimethylsilyl bis(2-methylfluorenyl)hafnium dimethyl,
dimethylsilyl bis(2-methyl-5,7-propylindenyl) zirconium dimethyl,
dimethylsilyl bis(2-methyl-4-phenylindenyl) zirconium dimethyl,
dimethylsilyl bis(2-ethyl-5-phenylindenyl) zirconium dimethyl,
dimethylsilyl bis(2-methyl-4-biphenylindenyl) zirconium dimethyl,
dimethylsilylene bis(2-methyl-4-carbazolylindenyl) zirconium dimethyl,
rac-dimethylsilyl-bis-(5,6,7,8-tetrahydro-5,5,8,8-tetramethyl-2-methyl-1H-benz(f)indene)hafnium dimethyl,
diphenylmethylene (cyclopentadienyl)(fluoreneyl)hafnium dimethyl,
bis(methylcyclopentadienyl)zirconium dimethyl,
rac-dimethylsiylbis(2-methyl,3-propyl indenyl)hafnium dimethyl,
dimethylsilylbis(indenyl)hafnium dimethyl,
dimethylsilylbis(indenyl)zirconium dimethyl,
dimethyl rac-dimethylsilyl-bis-(5,6,7,8-tetrahydro-5,5,8,8-tetramethyl-2-methyl-1H-benz(f)indene)hafnium dimethyl,
rac-meso-diphenylsilyl-bis(n-propylcyclopentadienyl)hafnium dimethyl,
1,1′-bis(4-triethylsilylphenyl)methylene-(cyclopentadienyl)(3,8-di-tertiary-butyl-1-fluorenyl)hafnium dimethyl,
1,1′-bis(4-triethylsilylphenyl)methylene-(cyclopentadienyl)(3,8-di-tertiary-butyl-1-fluorenyl)hafnium Xₙ (bridge is considered the 1 position),
bis-trimethylsilylphenyl-methylene(cyclopentadienyl)(di-t-butylfluorenyl)hafnium dimethyl,
bis-trimethylsilylphenyl-methylene(cyclopentadienyl)(fluorenyl)hafnium dimethyl,
bisphenylmethylene(cyclopentadienyl)(dimethylfluorenyl)hafnium dimethyl,
bis(n-propylcyclopentadienyl)hafnium dimethyl,
bis(n-butylcyclopentadienyl)hafnium dimethyl,
bis(n-pentylcyclopentadienyl)hafnium dimethyl,
(n-propyl cyclopentadienyl)(n-butylcyclopentadienyl)hafnium dimethyl,
bis[(2-trimethylsilylethyl)cyclopentadienyl]hafnium dimethyl,
bis(trimethylsilyl cyclopentadienyl)hafnium dimethyl,
dimethylsilylbis(n-propylcyclopentadienyl)hafnium dimethyl,
dimethylsilylbis(n-butylcyclopentadienyl)hafnium dimethyl,
bis(1-n-propyl-2-methylcyclopentadienyl)hafnium dimethyl,
(n-propylcyclopentadienyl)(1-n-propyl-3-n-butylcyclopentadienyl)hafnium dimethyl,
bis(n-propylcyclopentadienyl)hafnium dimethyl,
bis(n-butylcyclopentadienyl)hafnium dimethyl,
bis(n-pentylcyclopentadienyl)hafnium dimethyl,
(n-propyl cyclopentadienyl)(n-butylcyclopentadienyl)hafnium dimethyl,
bis[(2-trimethylsilylethyl)cyclopentadienyl]hafnium dimethyl,
bis(trimethylsilyl cyclopentadienyl)hafnium dimethyl,
dimethylsilylbis(n-propylcyclopentadienyl)hafnium dimethyl,
dimethylsilylbis(n-butylcyclopentadienyl)hafnium dimethyl,
bis(1-n-propyl-2-methylcyclopentadienyl)hafnium dimethyl,
(n-propylcyclopentadienyl)(1-n-propyl-3-n-butylcyclopentadienyl)hafnium dimethyl, and
dimethylsilyl(3-n-propylcyclopentadienyl)(tetramethylcyclopentadienyl)zirconium dimethyl.

Transition metal complexes other than metallocenes also may be suitable for use as a polymerization catalyst in the disclosure herein. Suitable transition metal complexes may include “non-metallocene complexes” that are defined to be transition metal complexes that do not feature a cyclopentadienyl anion or substituted cyclopentadienyl anion donors (e.g., cyclopentadienyl, fluorenyl, indenyl, methylcyclopentadienyl). Examples of families of non-metallocene transition metal complexes that may be suitable can include late transition metal pyridylbisimines (e.g., U.S. Pat. No. 7,087,686), group 4 pyridyldiamidos (e.g., U.S. Pat. No. 7,973,116), quinolinyldiamidos (e.g., US Patent Pub. No. 2018/0002352 A1), pyridylamidos (e.g., U.S. Pat. No. 7,087,690), phenoxyimines (e.g., Makio, H. et al. (2009) “Development and Application of FI Catalysts for Olefin Polymerization: Unique Catalysis and Distinctive Polymer Formation,” Accounts of Chemical Research, v. 42(10), pp. 1532-1544), and bridged bi-aromatic complexes (e.g., U.S. Pat. No. 7,091,292), the disclosures of which are incorporated herein by reference.

Particular transition metal complexes that are suitable for use in combination with the non-coordinating anion activators described herein include: diphenolate complexes; oxadiazolylphenolate complexes; diethylenetriamine complexes; and oxybis(ethylamine) complexes; or any combination thereof, including any combination with one or more metallocene complexes.

Some transition metal complexes that are suitable for use in combination with the supported activators described herein include: pyridyldiamido complexes; quinolinyldiamido complexes; phenoxyimine complexes; bisphenolate complexes; cyclopentadienyl-amidinate complexes; and iron pyridyl bis(imine) complexes or any combination thereof, including any combination with metallocene complexes.

The term “pyridyldiamido complex” or “pyridyldiamide complex” or “pyridyldiamido catalyst” or “pyridyldiamide catalyst” refers to a class of coordination complexes described in U.S. Pat. No. 7,973,116 B2, US Patent Publication 2012/0071616 A1, US Patent Publication 2011/0224391 A1, US Patent Publication 2011/0301310 A1, US Patent Publication 2015/0141601 A1, U.S. Pat. Nos. 6,900,321 and 8,592,615 that feature a dianionic tridentate ligand that is coordinated to a metal center through one neutral Lewis basic donor atom (e.g., a pyridine group) and a pair of anionic amido or phosphido (i.e., deprotonated amine or phosphine) donors. In these complexes the pyridyldiamido ligand is coordinated to the metal with the formation of one five-membered chelate ring and one seven-membered chelate ring. It is possible for additional atoms of the pyridyldiamido ligand to be coordinated to the metal without affecting the catalyst function upon activation; an example of this could be a cyclometalated substituted aryl group that forms an additional bond to the metal center.

The term “quinolinyldiamido complex” or “quinolinyldiamido catalyst” or “quinolinyldiamide complex” or “quinolinyldiamide catalyst” refers to a related class of pyridyldiamido complex/catalyst described in US Patent Publication 2018/0002352 where a quinolinyl moiety is present instead of a pyridyl moiety.

The term “phenoxyimine complex” or “phenoxyimine catalyst” refers to a class of coordination complexes described in EP 0 874 005 that feature a monoanionic bidentate ligand that is coordinated to a metal center through one neutral Lewis basic donor atom (e.g., an imine moiety) and an anionic aryloxy (i.e., deprotonated phenoxy) donor. Typically two of these bidentate phenoxyimine ligands are coordinated to a group 4 metal to form a complex that is useful as a catalyst component.

The term “bisphenolate complex” or “bisphenolate catalyst” refers to a class of transition metal complexes described in U.S. Pat. No. 6,841,502, WO 2017/004462, and WO 2006/020624 that feature a dianionic tetradentate ligand that is coordinated to a metal center through two neutral Lewis basic donor atoms (e.g., oxygen bridge moieties) and two anionic aryloxy (i.e., deprotonated phenoxy) donors.

The term “cyclopentadienyl-amidinate complex” or “cyclopentadienyl-amidinate catalyst” refers to a class of transition metal complexes described in U.S. Pat. No. 8,188,200 that typically feature a group 4 metal bound to a cyclopentadienyl anion, a bidentate amidinate anion, and a couple of other anionic groups.

The term “iron pyridyl bis(imine) complex” refers to a class of iron coordination complexes described in U.S. Pat. No. 7,087,686 that typically feature an iron metal center coordinated to a neutral, tridentate pyridyl bis(imine) ligand and two other anionic ligands.

Non-metallocene complexes suitable for use in the disclosure herein can include iron complexes of tridentate pyridylbisimine ligands, zirconium and hafnium complexes of pyridylamido ligands, zirconium and hafnium complexes of tridentate pyridyldiamido ligands, zirconium and hafnium complexes of tridentate quinolinyldiamido ligands, zirconium and hafnium complexes of bidentate phenoxyimine ligands, and zirconium and hafnium complexes of bridged bi-aromatic ligands.

Suitable non-metallocene complexes can include zirconium and hafnium non-metallocene complexes. In at least one embodiment, suitable non-metallocene complexes include group 4 non-metallocene complexes including two anionic donor atoms and one or two neutral donor atoms. Suitable non-metallocene complexes for the present disclosure include group 4 non-metallocene complexes including an anionic amido donor. Suitable non-metallocene complexes for the present disclosure include group 4 non-metallocene complexes including an anionic aryloxide donor atom. Suitable non-metallocene complexes for the present disclosure include group 4 non-metallocene complexes including two anionic aryloxide donor atoms and two additional neutral donor atoms.

Suitable quinolinyldiamido (QDA) transition metal complexes may include those having a structure represented by Formula 5, such as by Formulas 5A or 5B

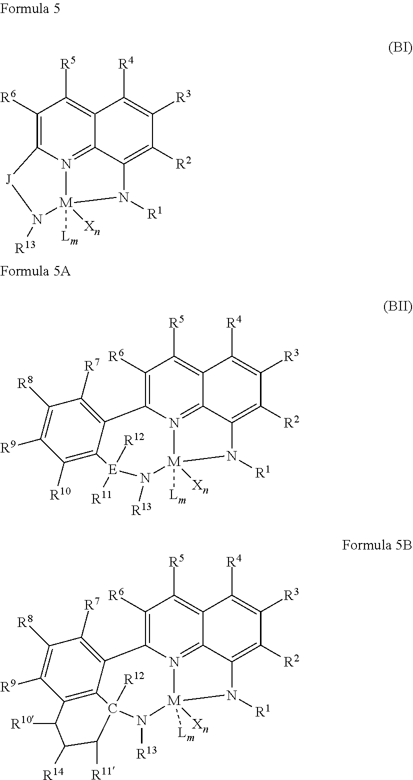

wherein in Formulas 5-5B:

M is a group 3, 4, 5, 6, 7, 8, 9, 10, 11, or 12 metal, such as a group 4 metal;

J is group including a three-atom-length bridge between the quinoline and the amido nitrogen, such as a group containing up to 50 non-hydrogen atoms;

E is carbon, silicon, or germanium;

X is an anionic leaving group, (such as a hydrocarbyl group or a halogen);

L is a neutral Lewis base;

R¹ and R¹³ are independently selected from the group including of hydrocarbyls, substituted hydrocarbyls, and silyl groups;

R², R³, R⁴, R⁵, R⁶, R⁷, R⁸, R⁹, R¹⁰, R^{10′}, R¹¹, R^{11′}, R¹², and R¹⁴ are independently hydrogen, hydrocarbyl, alkoxy, silyl, amino, aryloxy, substituted hydrocarbyl, halogen, or phosphino;

n is 1 or 2;

m is 0, 1, or 2, where

n+m is not greater than 4; and

any two R groups (e.g., R¹ & R², R² & R³, R¹⁰ and R¹¹, etc.) may be joined to form a substituted hydrocarbyl, unsubstituted hydrocarbyl, substituted heterocyclic, or unsubstituted heterocyclic, saturated or unsaturated ring, where the ring has 5, 6, 7, or 8 ring atoms and where substitutions on the ring can join to form additional rings;

any two X groups may be joined together to form a dianionic group;

any two L groups may be joined together to form a bidentate Lewis base; and

any X group may be joined to an L group to form a monoanionic bidentate group.

In at least one embodiment, M is a group 4 metal, such as zirconium or hafnium, such as M is hafnium.

Representative non-metallocene transition metal complexes usable for in the present disclosure also include tetrabenzyl zirconium, tetra bis(trimethylsilymethyl) zirconium, oxotris(trimethlsilylmethyl) vanadium, tetrabenzyl hafnium, tetrabenzyl titanium, bis(hexamethyl disilazido)dimethyl titanium, tris(trimethyl silyl methyl) niobium dichloride, and tris(trimethylsilylmethyl) tantalum dichloride.

In at least one embodiment, J is an aromatic substituted or unsubstituted hydrocarbyl having from 3 to 30 non-hydrogen atoms, such as J is represented by the formula:

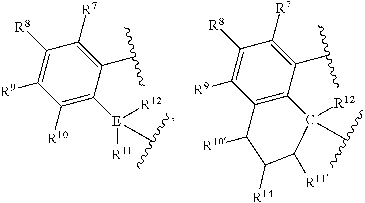

such as J is

where R⁷, R⁸, R⁹, R¹⁰, R^{10′}, R¹¹, R^{11′}, R¹², R¹⁴ and E are as defined above, and any two R groups (e.g., R⁷ & R⁸, R⁸ & R⁹, R⁹ & R¹⁰R¹⁰ & R¹¹, etc.) may be joined to form a substituted or unsubstituted hydrocarbyl or heterocyclic ring, where the ring has 5, 6, 7, or 8 ring atoms (such as 5 or 6 atoms), and said ring may be saturated or unsaturated (such as partially unsaturated or aromatic), such as J is an arylalkyl (such as arylmethyl, etc.) or dihydro-1H-indenyl, or tetrahydronaphthalenyl group.

In at least one embodiment, J is selected from the following structures:

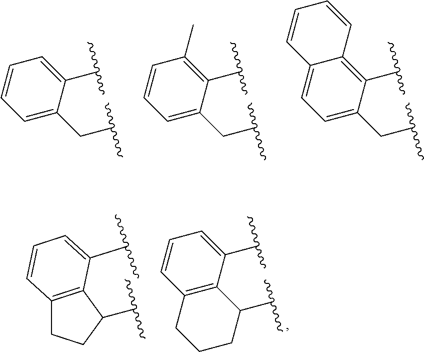

where [symbol] indicates connection to the complex.

In at least one embodiment, E is carbon.

X may be an alkyl (such as alkyl groups having 1 to 10 carbons, such as methyl, ethyl, propyl, butyl, pentyl, hexyl, heptyl, octyl, nonyl, decyl, and isomers thereof), aryl, hydride, alkylsilane, fluoride, chloride, bromide, iodide, triflate, carboxylate, amido (such as NMe₂), or alkylsulfonate.

In at least one embodiment, L is an ether, amine or thioether.

In at least one embodiment, R⁷ and R⁸ are joined to form a six-membered aromatic ring with the joined R⁷/R⁸ group being —CH═CHCH═CH—.

R¹⁰ and R¹¹ may be joined to form a five-membered ring with the joined R¹⁰R¹¹ group being —CH₂CH₂—.

In at least one embodiment, R¹⁰ and R¹¹ are joined to form a six-membered ring with the joined R¹⁰R¹¹ group being —CH₂CH₂CH₂—.

R¹ and R¹³ may be independently selected from phenyl groups that are variously substituted with between zero to five substituents that include F, Cl, Br, I, CF₃, NO₂, alkoxy, dialkylamino, aryl, and alkyl groups having 1 to 10 carbons, such as methyl, ethyl, propyl, butyl, pentyl, hexyl, heptyl, octyl, nonyl, decyl, and isomers thereof.

In at least one embodiment, the QDA transition metal complex represented by Formula 5A above where:

M is a group 4 metal (such as hafnium);

E is selected from carbon, silicon, or germanium (such as carbon);

X is an alkyl, aryl, hydride, alkylsilane, fluoride, chloride, bromide, iodide, triflate, carboxylate, amido, alkoxo, or alkylsulfonate;

L is an ether, amine, or thioether;

R¹ and R¹³ are independently selected from the group consisting of hydrocarbyls, substituted hydrocarbyls, and silyl groups (such as aryl);

R², R³, R⁴, R⁵, R⁶, R⁷, R⁸, R⁹, R¹⁰, R¹¹, and R¹² are independently hydrogen, hydrocarbyl, alkoxy, silyl, amino, aryloxy, substituted hydrocarbyls, halogen, and phosphino;

n is 1 or 2;

m is 0, 1, or 2;

n+m is from 1 to 4;

two X groups may be joined together to form a dianionic group;

two L groups may be joined together to form a bidentate Lewis base;

an X group may be joined to an L group to form a monoanionic bidentate group;

R⁷ and R⁸ may be joined to form a ring (such as an aromatic ring, a six-membered aromatic ring with the joined R⁷R⁸ group being —CH═CHCH═CH—); and

R¹⁰ and R¹¹ may be joined to form a ring (such as a five-membered ring with the joined R¹⁰R¹¹ group being —CH₂CH₂—, a six-membered ring with the joined R¹⁰R¹¹ group being —CH₂CH₂CH₂—).

In at least one embodiment of Formulas 5-5B, R⁴, R⁵, and R⁶ are independently selected from the group including hydrogen, hydrocarbyls, substituted hydrocarbyls, alkoxy, aryloxy, halogen, amino, and silyl, and wherein adjacent R groups (R⁴ and R⁵ and/or R⁵ and R⁶) are joined to form a substituted hydrocarbyl, unsubstituted hydrocarbyl, unsubstituted heterocyclic ring or substituted heterocyclic ring, where the ring has 5, 6, 7, or 8 ring atoms and where substitutions on the ring can join to form additional rings.

In at least one embodiment of Formulas 5-5B, R⁷, R⁸, R⁹, and R¹¹ are independently selected from the group including hydrogen, hydrocarbyls, substituted hydrocarbyls, alkoxy, halogen, amino, and silyl, and wherein adjacent R groups (R⁷ and R⁸ and/or R⁹ and R¹⁰) may be joined to form a saturated, substituted hydrocarbyl, unsubstituted hydrocarbyl, unsubstituted heterocyclic ring or substituted heterocyclic ring, where the ring has 5, 6, 7, or 8 ring carbon atoms and where substitutions on the ring can join to form additional rings.

In at least one embodiment of Formulas 5-5B, R² and R³ are each, independently, selected from the group including hydrogen, hydrocarbyls, and substituted hydrocarbyls, alkoxy, silyl, amino, aryloxy, halogen, and phosphino, R² and R³ may be joined to form a saturated, substituted or unsubstituted hydrocarbyl ring, where the ring has 4, 5, 6, or 7 ring carbon atoms and where substitutions on the ring can join to form additional rings, or R² and R³ may be joined to form a saturated heterocyclic ring, or a saturated substituted heterocyclic ring where substitutions on the ring can join to form additional rings.

In at least one embodiment of Formulas 5-5B, R¹¹ and R¹² are each, independently, selected from the group including hydrogen, hydrocarbyls, and substituted hydrocarbyls, alkoxy, silyl, amino, aryloxy, halogen, and phosphino, R¹¹ and R¹² may be joined to form a saturated, substituted or unsubstituted hydrocarbyl ring, where the ring has 4, 5, 6, or 7 ring carbon atoms and where substitutions on the ring can join to form additional rings, or R¹¹ and R¹² may be joined to form a saturated heterocyclic ring, or a saturated substituted heterocyclic ring where substitutions on the ring can join to form additional rings, or R¹¹ and R¹⁰ may be joined to form a saturated heterocyclic ring, or a saturated substituted heterocyclic ring where substitutions on the ring can join to form additional rings.

In at least one embodiment of Formulas 5-5B, R¹ and R¹³ are independently selected from phenyl groups that are variously substituted with between zero to five substituents that include F, Cl, Br, I, CF₃, NO₂, alkoxy, dialkylamino, aryl, and alkyl groups having 1 to 10 carbons, such as methyl, ethyl, propyl, butyl, pentyl, hexyl, heptyl, octyl, nonyl, decyl, and isomers thereof.

In at least one embodiment of Formula 5B, suitable R¹²-E-R¹¹ groups include CH₂, CMe₂, SiMe₂, SiEt₂, SiPr₂, SiBu₂, SiPh₂, Si(aryl)₂, Si(alkyl)₂, CH(aryl), CH(Ph), CH(alkyl), and CH(2-isopropylphenyl), where alkyl is a C₁ to C₄₀ alkyl group (such as C₁ to C₂₀ alkyl, such as one or more of methyl, ethyl, propyl, butyl, pentyl, hexyl, heptyl, octyl, nonyl, decyl, undecyl, dodecyl, and isomers thereof), aryl is a C₅ to C₄₀ aryl group (such as a C₆ to C₂₀ aryl group, such as phenyl or substituted phenyl, such as phenyl, 2-isopropylphenyl, or 2-tertbutylphenyl).

In at least one embodiment of Formula 5B, R¹¹, R¹², R⁹, R¹⁴, and R¹⁰ are independently selected from the group consisting of hydrogen, hydrocarbyls, substituted hydrocarbyls, alkoxy, halogen, amino, and silyl, and wherein adjacent R groups (R¹⁰ and R¹⁴, and/or R¹¹ and R¹⁴, and/or R⁹ and R¹⁰) may be joined to form a saturated, substituted hydrocarbyl, unsubstituted hydrocarbyl, unsubstituted heterocyclic ring or substituted heterocyclic ring, where the ring has 5, 6, 7, or 8 ring carbon atoms and where substitutions on the ring can join to form additional rings.

The R groups above (i.e., any of R² to R¹⁴) and other R groups mentioned hereafter may contain from 1 to 30, such as 2 to 20 carbon atoms, such as from 6 to 20 carbon atoms. The R groups above (i.e., any of R² to R¹⁴) and other R groups mentioned hereafter, may be independently selected from the group including hydrogen, methyl, ethyl, phenyl, isopropyl, isobutyl, trimethylsilyl, and —CH₂—Si(Me)₃.

In at least one embodiment, the quinolinyldiamide complex is linked to one or more additional transition metal complex, such as a quinolinyldiamide complex or another suitable non-metallocene, through an R group in such a fashion as to make a bimetallic, trimetallic, or multimetallic complex that may be used as a catalyst component for olefin polymerization. The linker R group in such a complex may contain 1 to 30 carbon atoms.

In at least one embodiment, E is carbon and R¹¹ and R¹² are independently selected from phenyl groups that are substituted with 0, 1, 2, 3, 4, or 5 substituents selected from the group consisting of F, Cl, Br, I, CF₃, NO₂, alkoxy, dialkylamino, hydrocarbyl, and substituted hydrocarbyl groups with from one to ten carbons.

In at least one embodiment of Formulas 5A and 5B, R¹¹ and R¹² are independently selected from hydrogen, methyl, ethyl, phenyl, isopropyl, isobutyl, —CH₂—Si(Me)₃, and trimethylsilyl.

In at least one embodiment of Formulas 5A and 5B, R⁷, R⁸, R⁹, and R¹⁰ are independently selected from hydrogen, methyl, ethyl, propyl, isopropyl, phenyl, cyclohexyl, fluoro, chloro, methoxy, ethoxy, phenoxy, —CH₂—Si(Me)₃, and trimethylsilyl.

In at least one embodiment of Formulas 5-5B, R², R³, R⁴, R⁵, and R⁶ are independently selected from the group consisting of hydrogen, hydrocarbyls, alkoxy, silyl, amino, substituted hydrocarbyls, and halogen.

In at least one embodiment of Formula 5B, R¹⁰, R¹¹ and R¹⁴ are independently selected from hydrogen, methyl, ethyl, phenyl, isopropyl, isobutyl, —CH₂—Si(Me)₃, and trimethylsilyl.

In at least one embodiment of Formulas 5-5B, each L is independently selected from Et₂O, MeOtBu, Et₃N, PhNMe₂, MePh₂N, tetrahydrofuran, and dimethylsulfide.

In at least one embodiment of Formulas 5-5B, each X is independently selected from methyl, benzyl, trimethylsilyl, neopentyl, ethyl, propyl, butyl, phenyl, hydrido, chloro, fluoro, bromo, iodo, dimethylamido, diethylamido, dipropylamido, and diisopropylamido.

In at least one embodiment of Formulas 5-5B, R¹ is 2,6-diisopropylphenyl, 2,4,6-triisopropylphenyl, 2,6-diisopropyl-4-methylphenyl, 2,6-diethylphenyl, 2-ethyl-6-isopropylphenyl, 2,6-bis(3-pentyl)phenyl, 2,6-dicyclopentylphenyl, or 2,6-dicyclohexylphenyl.

In at least one embodiment of Formulas 5-5B, R¹³ is phenyl, 2-methylphenyl, 2-ethylphenyl, 2-propylphenyl, 2,6-dimethylphenyl, 2-isopropylphenyl, 4-methylphenyl, 3,5-dimethylphenyl, 3,5-di-tert-butylphenyl, 4-fluorophenyl, 3-methylphenyl, 4-dimethylaminophenyl, or 2-phenylphenyl.

In at least one embodiment of Formula 5B, J is dihydro-TH-indenyl and R¹ is 2,6-dialkylphenyl or 2,4,6-trialkylphenyl.

In at least one embodiment of Formulas 5-5B, R¹ is 2,6-diisopropylphenyl and R¹³ is a hydrocarbyl group containing 1, 2, 3, 4, 5, 6, or 7 carbon atoms.

An exemplary transition metal complex useful for polymerization reactions according to the present disclosure is (QDA-1)HfMe₂, represented by Formula 6, as described in US Patent Pub. No. 2018/0002352 A1.

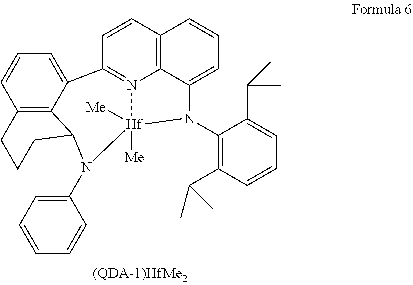

In at least one embodiment, the catalyst compound is a bis(phenolate) catalyst compound represented b Formula 7:

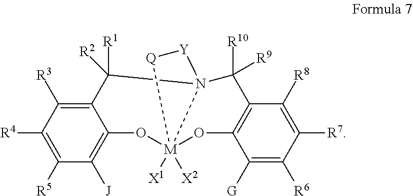

M is a group 4 metal, such as Hf or Zr. X¹ and X² are independently a univalent C₁-C₂₀ hydrocarbyl, C₁-C₂₀ substituted hydrocarbyl, a heteroatom or a heteroatom-containing group, or X¹ and X² join together to form a C₄-C₆₂ cyclic or polycyclic ring structure. R¹, R², R³, R⁴, R⁵, R⁶, R⁷, R⁸, R⁹, and R¹⁰ is independently hydrogen, C₁-C₄₀ hydrocarbyl, C₁-C₄₀ substituted hydrocarbyl, a heteroatom or a heteroatom-containing group, or two or more of R¹, R², R³, R⁴, R⁵, R⁶, R⁷, R⁸, R⁹, or R¹⁰ are joined together to form a C₄-C₆₂ cyclic or polycyclic ring structure, or a combination thereof, Q is a neutral donor group; J is heterocycle, a substituted or unsubstituted C₇-C₆₀ fused polycyclic group, where at least one ring is aromatic and where at least one ring, which may or may not be aromatic, has at least five ring atoms, G is as defined for J or may be hydrogen, C₂-C₆₀ hydrocarbyl, C₁-C₆₀ substituted hydrocarbyl, or may independently form a C₄-C₆₀ cyclic or polycyclic ring structure with R⁶, R⁷, or R⁸ or a combination thereof, Y is divalent C₁-C₂₀ hydrocarbyl or divalent C₁-C₂₀ substituted hydrocarbyl or (-Q-Y—) together form a heterocycle; and heterocycle may be aromatic and/or may have multiple fused rings.

In at least one embodiment, the bis phenolate complex may be represented by Formula 7A or Formula 7B:

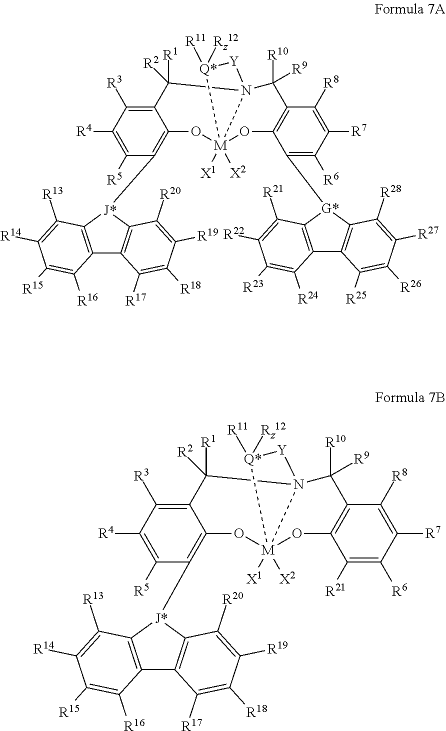

M is Hf, Zr, or Ti. X¹, X², R¹, R², R³, R⁴, R⁵, R⁶, R⁷, R⁸, R⁹, R¹⁰, and Y are as defined for Formula 7. R¹¹, R¹², R¹³, R¹⁴, R¹⁵, R¹⁶, R¹⁷, R¹⁸, R¹⁹, R²⁰, R²¹, R²², R²³, R²⁴, R²⁵, R²⁶, R²⁷, and R²⁸ is independently a hydrogen, C₁-C₄₀ hydrocarbyl, C₁-C₄₀ substituted hydrocarbyl, a functional group comprising elements from groups 13 to 17, or two or more of R¹, R², R³, R⁴, R⁵, R⁶, R⁷, R⁸, R⁹, R¹⁰ R¹¹, R¹², R¹³, R¹⁴, R¹⁵, R¹⁶, R¹⁷, R¹⁸, R¹⁹, R²⁰, R²¹, R²², R²³, R²⁴, R²⁵, R²⁶, R²⁷, and R²⁸ may independently join together to form a C₄-C₆₂ cyclic or polycyclic ring structure, or a combination thereof, R¹¹ and R¹² may join together to form a five- to eight-membered heterocycle; Q* is a group 15 or 16 atom; z is 0 or 1; J* is CR″ or N, and G* is CR″ or N, where R″ is C₁-C₂₀ hydrocarbyl or carbonyl-containing C₁-C₂₀ hydrocarbyl; and z=0 if Q* is a group 16 atom, and z=1 if Q* is a group 15 atom.

In at least one embodiment the transition metal complex is an iron complex represented by Formula 8:

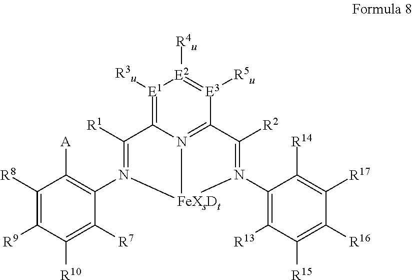

wherein:

A is chlorine, bromine, iodine, —CF₃ or —OR¹;

each of R¹ and R² is independently hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or five-, six- or seven-membered heterocyclyl comprising at least one atom selected from the group consisting of N, P, O and S;

wherein each of R¹ and R² is optionally substituted by halogen, —NR¹¹₂, —OR¹¹ or —SiR¹²₃;

wherein R¹ optionally bonds with R³, and R² optionally bonds with R⁵, in each case to independently form a five-, six- or seven-membered ring;

R⁷ is a C₁-C₂₀ alkyl;

each of R³, R⁴, R⁵, R⁸, R⁹, R¹⁰, R¹⁵, R¹⁶, and R¹⁷ is independently hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, —NR¹¹₂, —OR¹¹, halogen, —SiR¹²₃ or five-, six- or seven-membered heterocyclyl comprising at least one atom selected from the group consisting of N, P, O, and S;

wherein R³, R⁴, R⁵, R⁷, R⁸, R⁹, R¹⁰, R¹⁵, R¹⁶, and R¹⁷ are optionally substituted by halogen, —NR¹¹₂, —OR¹¹ or —SiR¹²₃;

wherein R³ optionally bonds with R⁴, R⁴ optionally bonds with R⁵, R⁷ optionally bonds with R¹⁰, R¹⁰ optionally bonds with R⁹, R⁹ optionally bonds with R⁸, R¹⁷ optionally bonds with R¹⁶, and R¹⁶ optionally bonds with R¹⁵, in each case to independently form a five-, six- or seven-membered carbocyclic or heterocyclic ring, the heterocyclic ring comprising at least one atom from the group consisting of N, P, O and S;

R¹³ is C₁-C₂₀-alkyl bonded with the aryl ring via a primary or secondary carbon atom;

R¹⁴ is chlorine, bromine, iodine, —CF₃ or —OR¹, or C₁-C₂₀-alkyl bonded with the aryl ring;

each R¹¹ is independently hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or —SiR¹²³, wherein R¹¹ is optionally substituted by halogen, or two R¹¹ radicals optionally bond to form a five- or six-membered ring;

each R¹² is independently hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or two R¹² radicals optionally bond to form a five- or six-membered ring; each of E¹, E², and E³ is independently carbon, nitrogen or phosphorus;

each u is independently 0 if E¹, E², and E³ is nitrogen or phosphorus and is 1 if E¹, E², and E³ is carbon;

each X is independently fluorine, chlorine, bromine, iodine, hydrogen, C₁-C₂₀-alkyl, C₂-C₁₀-alkenyl, C₆-C₂₀-aryl, arylalkyl where alkyl has from 1 to 10 carbon atoms and aryl has from 6 to 20 carbon atoms, —NR¹⁸₂, —OR¹⁸, —SR¹⁸, —SO₃R¹⁸, —OC(O)R¹⁸, —CN, —SCN, β-diketonate, —CO, —BF₄⁻, —PF₆⁻ or bulky non-coordinating anions, and the radicals X can be bonded with one another;

each R¹⁸ is independently hydrogen, C₁-C₂₀-alkyl, C₂-C₂₀-alkenyl, C₆-C₂₀-aryl, arylalkyl where alkyl has from 1 to 10 carbon atoms and aryl has from 6 to 20 carbon atoms, or —SiR¹⁹³, wherein R¹⁸ can be substituted by halogen or nitrogen- or oxygen-containing groups and two R¹⁸ radicals optionally bond to form a five- or six-membered ring;

each R¹⁹ is independently hydrogen, C₁-C₂₀-alkyl, C₂-C₂₀-alkenyl, C₆-C₂O-aryl or arylalkyl where alkyl has from 1 to 10 carbon atoms and aryl has from 6 to 20 carbon atoms, wherein R¹⁹ can be substituted by halogen or nitrogen- or oxygen-containing groups or two R¹⁹ radicals optionally bond to form a five- or six-membered ring;

s is 1, 2, or 3;

D is a neutral donor; and

t is 0 to 2.

In another embodiment, the transition metal complex is a phenoxyimine compound represented by Formula 9

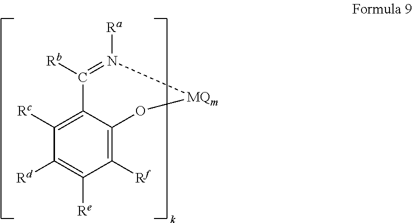

wherein M represents a transition metal atom selected from the groups 3 to 11 metals in the periodic table; k is an integer of 1 to 6; m is an integer of 1 to 6; R^{a} to R^{f} may be the same or different from one another and each represent a hydrogen atom, a halogen atom, a hydrocarbon group, a heterocyclic compound residue, an oxygen-containing group, a nitrogen-containing group, a boron-containing group, a sulfur-containing group, a phosphorus-containing group, a silicon-containing group, a germanium-containing group or a tin-containing group, among which 2 or more groups may be bound to each other to form a ring; when k is 2 or more, R^{a} groups, R^{b} groups, R^{c} groups, R^{d} groups, R^{e} groups, or R^{f} groups may be the same or different from one another, one group of R^{a} to R^{f} contained in one ligand and one group of R^{a} to R^{f} contained in another ligand may form a linking group or a single bond, and a heteroatom contained in R^{a} to R^{f} may coordinate with or bind to M; m is a number satisfying the valence of M; Q represents a hydrogen atom, a halogen atom, an oxygen atom, a hydrocarbon group, an oxygen-containing group, a sulfur-containing group, a nitrogen-containing group, a boron-containing group, an aluminum-containing group, a phosphorus-containing group, a halogen-containing group, a heterocyclic compound residue, a silicon-containing group, a germanium-containing group or a tin-containing group; when m is 2 or more, a plurality of groups represented by Q may be the same or different from one another, and a plurality of groups represented by Q may be mutually bound to form a ring.

In another embodiment, the transition metal complex is a bis(imino)pyridyl represented by Formula 10

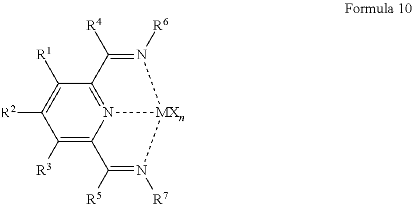

wherein:

M is Co or Fe; each X is an anion; n is 1, 2 or 3, so that the total number of negative charges on said anion or anions is equal to the oxidation state of a Fe or Co atom present in (VIII);

R¹, R² and R³ are each independently hydrogen, hydrocarbyl, substituted hydrocarbyl, or an inert functional group;

R⁴ and R⁵ are each independently hydrogen, hydrocarbyl, an inert functional group or substituted hydrocarbyl;

R⁶ is Formula 11:

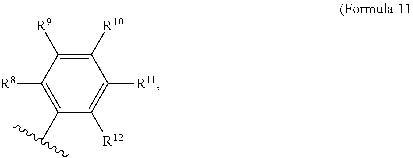

and R⁷ is Formula 12:

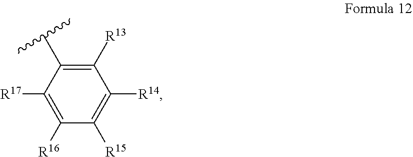

R⁸ and R¹³ are each independently hydrocarbyl, substituted hydrocarbyl or an inert functional group;

R⁹, R¹⁰, R¹¹, R¹⁴, R¹⁵ and R¹⁶ are each independently hydrogen, hydrocarbyl, substituted hydrocarbyl or an inert functional group;

R¹² and R¹⁷ are each independently hydrogen, hydrocarbyl, substituted hydrocarbyl or an inert functional group;

and provided that any two of R⁸, R⁹, R¹⁰, R¹¹, R¹², R¹³, R¹⁴, R¹⁵, R¹⁶ and R¹⁷ that are adjacent to one another, together may form a ring.

In at least one embodiment, the transition metal complex is represented by Formula 13

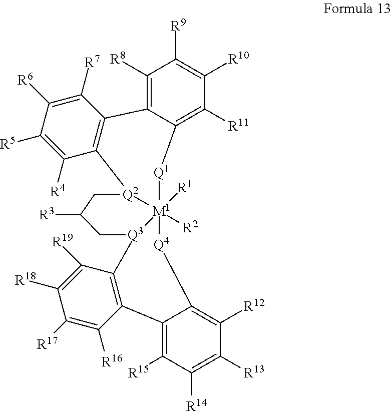

M¹ is selected from the group consisting of titanium, zirconium, hafnium, vanadium, niobium, tantalum, chromium, molybdenum and tungsten. In at least one embodiment, M¹ is zirconium.

Each of Q¹, Q², Q³, and Q⁴ is independently oxygen or sulfur. In at least one embodiment, at least one of Q¹, Q², Q³, and Q⁴ is oxygen, alternately all of Q¹, Q², Q³, and Q⁴ are oxygen.

R¹ and R² are independently hydrogen, halogen, hydroxyl, hydrocarbyl, or substituted hydrocarbyl (such as C₁-C₁₀ alkyl, C₁-C₁₀ alkoxy, C₆-C₂₀ aryl, C₆-C₁₀ aryloxy, C₂-C₁₀ alkenyl, C₂-C₄₀ alkenyl, C₇-C₄₀ arylalkyl, C₇-C₄₀ alkylaryl, C₈-C₄₀ arylalkenyl, or conjugated diene which is optionally substituted with one or more hydrocarbyl, tri(hydrocarbyl) silyl or tri(hydrocarbyl) silylhydrocarbyl, the diene having up to 30 atoms other than hydrogen). R¹ and R² can be a halogen selected from fluorine, chlorine, bromine, or iodine. Preferably, R¹ and R² are chlorine.

Alternatively, R¹ and R² may also be joined together to form an alkanediyl group or a conjugated C₄-C₄₀ diene ligand which is coordinated to M¹. R¹ and R² may also be identical or different conjugated dienes, optionally substituted with one or more hydrocarbyl, tri(hydrocarbyl) silyl or tri(hydrocarbyl) silylhydrocarbyl, the dienes having up to 30 atoms not counting hydrogen and/or forming a π-complex with M¹.

Exemplary groups suitable for R¹ and or R² can include 1,4-diphenyl, 1,3-butadiene, 1,3-pentadiene, 2-methyl 1,3-pentadiene, 2,4-hexadiene, 1-phenyl, 1,3-pentadiene, 1,4-dibenzyl, 1,3-butadiene, 1,4-ditolyl-1,3-butadiene, 1,4-bis (trimethylsilyl)-1,3-butadiene, and 1,4-dinaphthyl-1,3-butadiene. R¹ and R² can be identical and are C₁-C₃ alkyl or alkoxy, C₆-C₁₀ aryl or aryloxy, C₂-C₄ alkenyl, C₇-C₁₀ arylalkyl, C₇-C₁₂ alkylaryl, or halogen.

Each of R⁴, R⁵, R⁶, R⁷, R⁸, R⁹, R¹⁰, R¹¹, R¹², R¹³, R¹⁴, R¹⁵, R¹⁶, R¹⁷, R¹⁸, and R¹⁹ is independently hydrogen, halogen, C₁-C₄₀ hydrocarbyl or C₁-C₄₀ substituted hydrocarbyl (such as C₁-C₁₀ alkyl, C₁-C₁₀ alkoxy, C₆-C₂₀ aryl, C₆-C₁₀ aryloxy, C₂-C₁₀ alkenyl, C₂-C₄₀ alkenyl, C₇-C₄₀ arylalkyl, C₇-C₄₀ alkylaryl, C₅-C₄₀ arylalkenyl, or conjugated diene which is optionally substituted with one or more hydrocarbyl, tri(hydrocarbyl) silyl or tri(hydrocarbyl) silylhydrocarbyl, the diene having up to 30 atoms other than hydrogen), —NR′₂, —SR′, —OR, —OSiR′₃, —PR′₂, where each R′ is hydrogen, halogen, C₁-C₁₀ alkyl, or C₆-C₁₀ aryl, or one or more of R⁴ and R⁵, R⁵ and R⁶, R⁶ and R⁷, R⁸ and R⁹, R⁹ and R¹⁰, R¹⁰ and R¹¹, R¹² and R¹³, R¹³ and R¹⁴, R¹⁴ and R¹⁵, R¹⁶ and R¹⁷, R¹⁷ and R¹⁸, and R¹⁸ and R¹⁹ are joined to form a saturated ring, unsaturated ring, substituted saturated ring, or substituted unsaturated ring. In at least one embodiment, C₁-C₄₀ hydrocarbyl is selected from methyl, ethyl, propyl, n-propyl, isopropyl, n-butyl, isobutyl, sec-butyl, n-pentyl, isopentyl, sec-pentyl, n-hexyl, isohexyl, sec-hexyl, n-heptyl, isoheptyl, sec-heptyl, n-octyl, isooctyl, sec-octyl, n-nonyl, isononyl, sec-nonyl, n-decyl, isodecyl, and sec-decyl. Preferably, R¹¹ and R¹² are C₆-C₁₀ aryl such as phenyl or naphthyl optionally substituted with C₁-C₄₀ hydrocarbyl, such as C₁-C₁₀ hydrocarbyl. Preferably, R⁶ and R¹⁷ are C₁₋₄₀ alkyl, such as C₁-C₁₀ alkyl.

In at least one embodiment, each of R⁴, R⁵, R⁶, R⁷, R⁸, R⁹, R¹⁰, R¹³, R¹⁴, R¹⁵, R¹⁶, R¹⁷, R¹⁸, and R¹⁹ is independently hydrogen or C₁-C₄₀ hydrocarbyl. In at least one embodiment, the C₁-C₄₀ hydrocarbyl is selected from methyl, ethyl, propyl, n-propyl, isopropyl, n-butyl, isobutyl, sec-butyl, n-pentyl, isopentyl, sec-pentyl, n-hexyl, isohexyl, sec-hexyl, n-heptyl, isoheptyl, sec-heptyl, n-octyl, isooctyl, sec-octyl, n-nonyl, isononyl, sec-nonyl, n-decyl, isodecyl, and sec-decyl. Preferably, each of R⁶ and R¹⁷ is C₁-C₄₀ hydrocarbyl and R⁴, R⁵, R⁷, R⁸, R⁹, R¹⁰, R¹³, R¹⁴, R¹⁵, R¹⁶, R¹⁸, and R¹⁹ is hydrogen. In at least one embodiment, C₁-C₄₀ hydrocarbyl is selected from methyl, ethyl, propyl, n-propyl, isopropyl, n-butyl, isobutyl, sec-butyl, n-pentyl, isopentyl, sec-pentyl, n-hexyl, isohexyl, sec-hexyl, n-heptyl, isoheptyl, sec-heptyl, n-octyl, isooctyl, sec-octyl, n-nonyl, isononyl, sec-nonyl, n-decyl, isodecyl, and sec-decyl.

R³ is a C₁-C₄₀ unsaturated alkyl or substituted C₁-C₄₀ unsaturated alkyl (such as C₁-C₁₀ alkyl, C₁-C₁₀ alkoxy, C₆-C₂₀ aryl, C₆-C₁₀ aryloxy, C₂-C₁₀ alkenyl, C₂-C₄₀ alkenyl, C₇-C₄₀ arylalkyl, C₇-C₄₀ alkylaryl, C₈-C₄₀ arylalkenyl, or conjugated diene which is optionally substituted with one or more hydrocarbyl, tri(hydrocarbyl) silyl or tri(hydrocarbyl) silylhydrocarbyl, the diene having up to 30 atoms other than hydrogen).

Preferably, R³ is a hydrocarbyl comprising a vinyl moiety. Hydrocarbyl of R³ may be further substituted (such as C₁-C₁₀ alkyl, C₁-C₁₀ alkoxy, C₆-C₂₀ aryl, C₆-C₁₀ aryloxy, C₂-C₁₀ alkenyl, C₂-C₄₀ alkenyl, C₇-C₄₀ arylalkyl, C₇-C₄₀ alkylaryl, C₅-C₄₀ arylalkenyl, or conjugated diene which is optionally substituted with one or more hydrocarbyl, tri(hydrocarbyl) silyl or tri(hydrocarbyl) silylhydrocarbyl, the diene having up to 30 atoms other than hydrogen). Preferably, R³ is C₁-C₄₀ unsaturated alkyl that is vinyl or substituted C₁-C₄₀ unsaturated alkyl that is vinyl. R³ can be represented by the structure —R′CH═CH₂ where R′ is C₁-C₄₀ hydrocarbyl or C₁-C₄₀ substituted hydrocarbyl (such as C₁-C₁₀ alkyl, C₁-C₁₀ alkoxy, C₆-C₂₀ aryl, C₆-C₁₀ aryloxy, C₂-C₁₀ alkenyl, C₂-C₄₀ alkenyl, C₇-C₄₀ arylalkyl, C₇-C₄₀ alkylaryl, C₈-C₄₀ arylalkenyl, or conjugated diene which is optionally substituted with one or more hydrocarbyl, tri(hydrocarbyl) silyl or tri(hydrocarbyl) silylhydrocarbyl, the diene having up to 30 atoms other than hydrogen). In at least one embodiment, C₁-C₄₀ hydrocarbyl is selected from methyl, ethyl, propyl, n-propyl, isopropyl, n-butyl, isobutyl, sec-butyl, n-pentyl, isopentyl, sec-pentyl, n-hexyl, isohexyl, sec-hexyl, n-heptyl, isoheptyl, sec-heptyl, n-octyl, isooctyl, sec-octyl, n-nonyl, isononyl, sec-nonyl, n-decyl, isodecyl, and sec-decyl.

In at least one embodiment, R³ is 1-propenyl, 1-butenyl, 1-pentenyl, 1-hexenyl, 1-heptenyl, 1-octenyl, 1-nonenyl, or 1-decenyl.

In at least one embodiment, the transition metal complex is a group 15-containing metal compound represented by Formula 14 or Formula 15

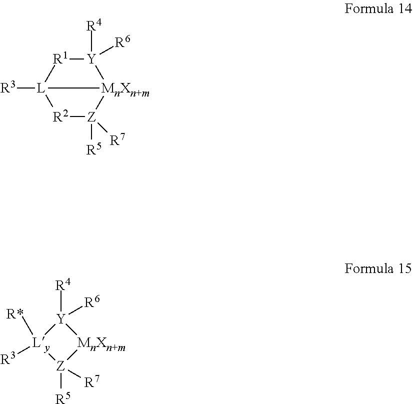

wherein M is a group 3 to 12 transition metal or a group 13 or 14 main group metal, a group 4, 5, or 6 metal. In many embodiments, M is a group 4 metal, such as zirconium, titanium, or hafnium. Each X is independently a leaving group, such as an anionic leaving group. The leaving group may include a hydrogen, a hydrocarbyl group, a heteroatom, a halogen, or an alkyl; y is 0 or 1 (when y is 0 group L′ is absent). The term ‘n’ is the oxidation state of M. In various embodiments, n is +3, +4, or +5. In many embodiments, n is +4. The term ‘m’ represents the formal charge of the YZL or the YZL′ ligand, and is 0, −1, −2 or −3 in various embodiments. In many embodiments, m is −2. L is a group 15 or 16 element, such as nitrogen or oxygen; L′ is a group 15 or 16 element or group 14 containing group, such as carbon, silicon or germanium. Y is a group 15 element, such as nitrogen or phosphorus. In many embodiments, Y is nitrogen. Z is a group 15 element, such as nitrogen or phosphorus. In many embodiments, Z is nitrogen. R¹ and R² are, independently, a C₁ to C₂₀ hydrocarbon group, a heteroatom containing group having up to twenty carbon atoms, silicon, germanium, tin, lead, or phosphorus. In many embodiments, R¹ and R² are a C₂ to C₂₀ alkyl, aryl or aralkyl group, such as a C₂ to C₂₀ linear, branched or cyclic alkyl group, or a C₂ to C₂₀ hydrocarbon group. R¹ and R² may also be interconnected to each other. R³ may be absent or may be a hydrocarbon group, a hydrogen, a halogen, a heteroatom containing group. In many embodiments, R³ is absent, for example, if L is an oxygen, or a hydrogen, or a linear, cyclic, or branched alkyl group having 1 to 20 carbon atoms. R⁴ and R⁵ are independently an alkyl group, an aryl group, substituted aryl group, a cyclic alkyl group, a substituted cyclic alkyl group, a cyclic aralkyl group, a substituted cyclic aralkyl group, or multiple ring system, often having up to 20 carbon atoms. In many embodiments, R⁴ and R⁵ have between 3 and 10 carbon atoms, or are a C₁ to C₂₀ hydrocarbon group, a C₁ to C₂₀ aryl group or a C₁ to C₂₀ aralkyl group, or a heteroatom containing group. R⁴ and R⁵ may be interconnected to each other. R⁶ and R⁷ are independently absent, hydrogen, an alkyl group, halogen, heteroatom, or a hydrocarbyl group, such as a linear, cyclic or branched alkyl group having 1 to 20 carbon atoms. In many embodiments, R⁶ and R⁷ are absent. R* may be absent, or may be a hydrogen, a group 14 atom containing group, a halogen, or a heteroatom containing group.

By “formal charge of the YZL or YZL′ ligand,” it is meant the charge of the entire ligand absent the metal and the leaving groups X. By “R¹ and R² may also be interconnected” it is meant that R¹ and R² may be directly bound to each other or may be bound to each other through other groups. By “R⁴ and R⁵ may also be interconnected” it is meant that R⁴ and R⁵ may be directly bound to each other or may be bound to each other through other groups. An alkyl group may be linear, branched alkyl radicals, alkenyl radicals, alkynyl radicals, cycloalkyl radicals, aryl radicals, acyl radicals, aroyl radicals, alkoxy radicals, aryloxy radicals, alkylthio radicals, dialkylamino radicals, alkoxycarbonyl radicals, aryloxycarbonyl radicals, carbomoyl radicals, alkyl- or dialkyl-carbamoyl radicals, acyloxy radicals, acylamino radicals, aroylamino radicals, straight, branched or cyclic, alkylene radicals, or combination thereof. An aralkyl group is defined to be a substituted aryl group.

In one or more embodiments, R⁴ and R⁵ are independently a group represented by Formula 16

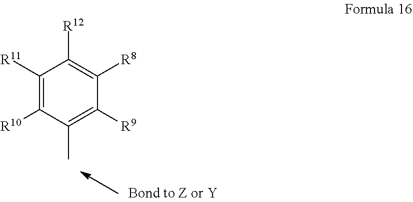

wherein R⁸ to R¹² are each independently hydrogen, a C₁ to C₄₀ alkyl group, a halide, a heteroatom, a heteroatom-containing group containing up to 40 carbon atoms. In many embodiments, R⁸ to R¹² are a C₁ to C₂₀ linear or branched alkyl group, such as a methyl, ethyl, propyl, or butyl group. Any two of the R groups may form a cyclic group and/or a heterocyclic group. The cyclic groups may be aromatic. In one embodiment R⁹, R¹⁰ and R¹² are independently a methyl, ethyl, propyl, or butyl group (including all isomers). In another embodiment, R⁹, R¹⁰ and R¹² are methyl groups, and R⁸ and R¹¹ are hydrogen.

In one or more embodiments, R⁴ and R⁵ are both a group represented by Formula 17

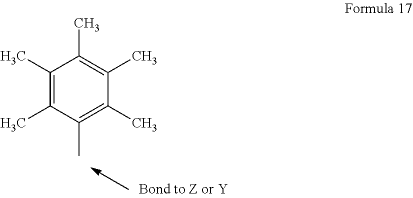

wherein M is a group 4 metal, such as zirconium, titanium, or hafnium. In at least one embodiment, M is zirconium. Each of L, Y, and Z may be a nitrogen. Each of R¹ and R² may be —CH₂—CH₂—. R³ may be hydrogen, and R⁶ and R⁷ may be absent. Representative transition metal complexes may include those described in WO 2019/089144.

In some embodiments, a co-activator is combined with the transition metal complex (such as a halogenated catalyst compound described above) to form an alkylated catalyst compound. Organoaluminum compounds which may be utilized as co-activators include, for example, trialkyl aluminum compounds, such as trimethylaluminum, triethylaluminum, triisobutylaluminum, tri-n-hexylaluminum, tri-n-octylaluminum, and the like, or alumoxanes.

In some embodiments, two or more different transition metal complexes are present in the catalyst systems used herein. In some embodiments, two or more different transition metal complexes are present in the reaction zone where the process(es) described herein occur. When two transition metal complexes are used in one reactor as a mixed catalyst system, the two transition metal compounds are preferably chosen such that the two are compatible. A simple screening method such as by ¹H or ¹³C NMR, known to those of ordinary skill in the art, can be used to determine which transition metal complexes are compatible. It is preferable to use the same activator for the transition metal complexes, however, two different activators can be used in combination. If one or more transition metal complexes contain an anionic ligand as a leaving group which is not a hydride, hydrocarbyl, or substituted hydrocarbyl, then the alumoxane or other alkyl aluminum is typically contacted with the transition metal compounds prior to addition of the non-coordinating anion activator.

The two transition metal complexes may be used in any ratio. Preferred molar ratios of (A) transition metal complex to (B) transition metal complex fall within the range of (A:B) 1:1000 to 1000:1, alternatively 1:100 to 500:1, alternatively 1:10 to 200:1, alternatively 1:1 to 100:1, and alternatively 1:1 to 75:1, and alternatively 5:1 to 50:1. The particular ratio chosen will depend on the exact pre-catalysts chosen, the method of activation, and the end product desired. In a particular embodiment, when using the two pre-catalysts, where both are activated with the same activator, useful mole percents, based upon the molecular weight of the pre-catalysts, are 10 to 99.9% A to 0.1 to 90% B, alternatively 25 to 99% A to 0.5 to 50% B, alternatively 50 to 99% A to 1 to 25% B, and alternatively 75 to 99% A to 1 to 10% B.

The term “diphenolate complex” or “diphenolate catalyst” refers to a class of transition metal complexes that feature a dianionic tetradentate ligand that is coordinated to a metal center through two neutral Lewis basic donor atoms (e.g., oxygen bridge moieties) and two anionic aryloxy (i.e., deprotonated phenoxy) donors and to two other anionic ligands.

The term “oxadiazolylphenolate complex” or “oxadiazolylphenolate catalyst” refers to a class of transition metal complexes that feature a metal center coordinated to a bidentate oxadiazolylphenolate anion via the phenolate oxygen and the oxadiazolyl nitrogen atom and two other anionic ligands.

The term “diethylenetriamine complex” or “diethylenetriamine catalyst” refers to a class of transition metal complexes that feature a metal center coordinated to a tridentate diethylenetriamine ligand and two other anionic ligands.

The term “oxybis(ethylamine) complex” or “oxybis(ethylamine) catalyst” refers to a class of transition metal complexes that feature a metal center coordinated to a tridentate oxybis(ethylamine) ligand via the nitrogen of two amino groups and the oxygen of the ether group and two other anionic ligands.

Suitable non-metallocene complexes can include zirconium and hafnium non-metallocene complexes. In at least one embodiment, non-metallocene complexes for the present disclosure include group 4 non-metallocene complexes including four anionic donor atoms and one or two neutral donor atoms. Suitable non-metallocene complexes for the present disclosure include group 4 non-metallocene complexes including an anionic phenolate donor. Suitable non-metallocene complexes for the present disclosure include group 4 non-metallocene complexes including an anionic amino donor atom. Suitable non-metallocene complexes for the present disclosure include group 4 non-metallocene complexes including two anionic aryloxide donor atoms and two additional neutral donor atoms.

A catalyst compound can be diphenolate transition metal complex represented by Formula 19

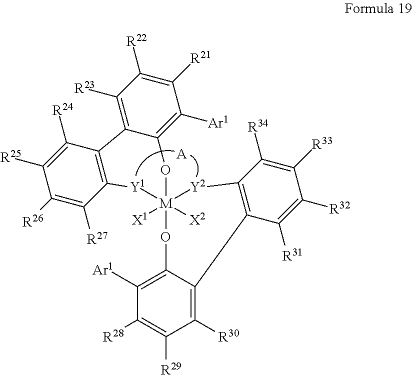

wherein.

M is a group 3, 4, 5, 6, 7, 8, 9, 10, 11, or 12 metal, such as a group 4 metal;

R²¹, R²², R²³, R²⁴, R²⁵, R²⁶, R²⁷, R²⁸, R²⁹, R³⁰, R³¹, R³², R³³ and R³⁴ are independently hydride, halide, optionally substituted hydrocarbyl, heteroatom-containing optionally substituted hydrocarbyl, alkoxy, aryloxy, silyl, boryl, dialkyl amino, alkylthio, arylthio and seleno; optionally two or more R groups can combine together into ring structures with such ring structures having from 3 to 100 non-hydrogen atoms in the ring;

A is a C₁-C₅₀ alkyl group;

Y¹ and Y² are independently selected from O, S, NR^{a} and PR^{a} wherein R^{a} is optionally substituted hydrocarbyl;

Ar¹ is phenyl, naphthyl, biphenyl, anthracenyl, or phenanthrenyl; and

X¹ and X² are, independently, hydrogen, halogen, hydrocarbyl, substituted hydrocarbyl, halocarbyl, substituted halocarbyl, silyl, silylcarbyl, substituted silylcarbyl, germylcarbyl, substituted germylcarbyl, aryl, substituted aryl, alkylaryl, heteroaryl, substituted heteroaryl, alkoxy, substituted alkoxy, aryloxy, substituted aryloxy, boryl, amino, phosphino, ether, thioether, phosphine, amine, carboxylate, alkylthio, arylthio, 1,3-dionate, oxalate, carbonate, nitrate, or sulphate, or both X¹ and X² are joined and bound to the metal atom to form a metallacycle ring containing from about 3 to about 20 carbon atoms; or both together can be an olefin, diolefin or aryne ligand.

In at least one aspect, M is a group 4 metal, such as zirconium or hafnium, such as M is zirconium.

In at least one aspect, Y¹ and Y² are O.

X¹ and X² may be independently alkyl (such as alkyl groups having 1 to 10 carbons, such as methyl, ethyl, propyl, butyl, pentyl, hexyl, heptyl, octyl, nonyl, decyl, and isomers thereof), aryl, alkyaryl (such as benzyl), hydride, alkylsilane, fluoride, chloride, bromide, iodide, triflate, carboxylate, amido (such as NMe₂), or alkylsulfonate.

In at least one aspect, R²¹, R²², R²³, R²⁴, R²⁵, R²⁶, R²⁷, R²⁸, R²⁹, R³⁰, R³¹, R³², R³³ and R³⁴ are independently hydride or alkyl.

R²² may be an alkyl group, such as methyl, ethyl, propyl, butyl, pentyl, hexyl, heptyl, octyl, nonyl, decyl, and isomers thereof.

Ar¹ may be a biphenyl group.

A may be an alkyl group such as propyl or butyl.

An exemplary transition metal complex used for polymerizations of the present disclosure may be represented by Formula 20.

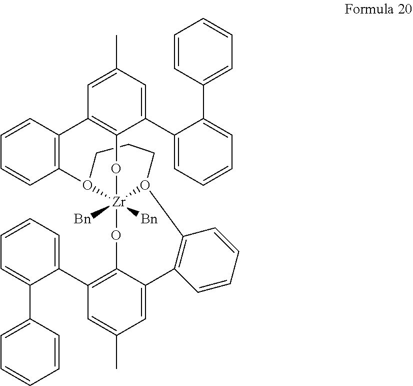

Another exemplary transition metal complex used for polymerizations of the present disclosure may be represented by Formula 21.

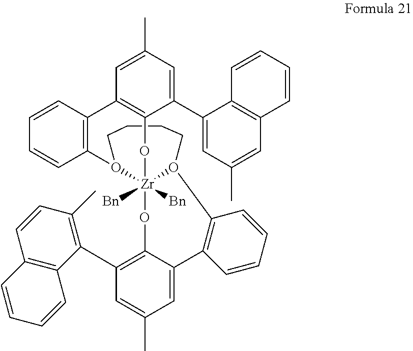

In another aspect, the oxadiazolylphenolate catalyst compound is represented by Formulas 22 or 23:

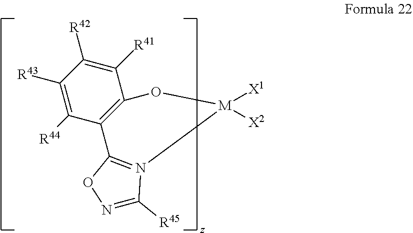

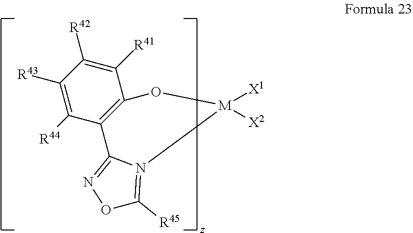

wherein in Formulas 22 or 23:

M is an element selected from group 4 of the Periodic Table of the Elements;

R⁴¹, R⁴², R⁴³, R⁴⁴, and R⁴⁵ are independently selected from the group consisting of hydrogen, alkyl, substituted alkyl, cycloalkyl, substituted cycloalkyl, heteroalkyl, substituted heteroalkyl, heterocycloalkyl, substituted heterocycloalkyl, aryl, substituted aryl, heteroaryl, substituted heteroaryl, alkoxy, aryloxy, halo, silyl, boryl, phosphino, amino, thioalkyl, thioaryl, nitro, and combinations thereof,

X¹ and X² are, independently, hydrogen, halogen, hydrocarbyl, substituted hydrocarbyl, halocarbyl, substituted halocarbyl, silyl, silylcarbyl, substituted silylcarbyl, germylcarbyl, substituted germylcarbyl, aryl, substituted aryl, heteroaryl, substituted heteroaryl, alkoxy, substituted alkoxy, aryloxy, substituted aryloxy, boryl, amino, phosphino, ether, thioether, phosphine, amine, carboxylate, alkylthio, arylthio, 1,3-dionate, oxalate, carbonate, nitrate, or sulphate, or both X¹ and X² are joined and bound to the metal atom to form a metallacycle ring containing from about 3 to about 20 carbon atoms; or both together can be an olefin, diolefin or aryne ligand; and

z is 1, 2, 3, or 4.

In at least one aspect, M is a group 4 metal, such as zirconium or hafnium, such as M is zirconium.

In at least one aspect, X¹ and X² are independently alkyl (such as alkyl groups having 1 to 10 carbons, such as methyl, ethyl, propyl, butyl, pentyl, hexyl, heptyl, octyl, nonyl, decyl, and isomers thereof), aryl, alkyaryl (such as benzyl), hydride, alkylsilane, fluoride, chloride, bromide, iodide, triflate, carboxylate, amido (such as NMe₂), or alkylsulfonate.

In at least one aspect, R⁴¹, R⁴², R⁴³, R⁴⁴, and R⁴⁵ are independently hydride, alkyl, substituted alkyl, aryl, or substituted aryl.

R⁴¹ and R⁴⁵ may be independently substituted aryl groups, such as halogen substituted phenyl or haloalkyl substituted phenyl; R⁴² and R⁴³ may be hydrogens; R⁴³ may be an alkyl group, such as methyl, ethyl, n-propyl, isopropyl, butyl, butyl, pentyl, hexyl, heptyl, octyl, nonyl, decyl, and isomers thereof.

In at least one aspect, R⁴¹ may be a fluoroaryl group, such as a meta-trifluorophenyl group; R⁴² and R⁴³ may be hydrogens; R⁴³ may be a butyl group, such as a tert-butyl group butyl; and R⁴⁵ may a chloroaryl group, such as a dichlorophenyl group.

An exemplary oxadiazolylphenolate catalyst used for polymerizations of the present disclosure may be represented by Formula 24.

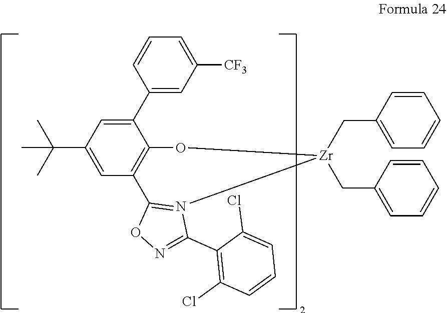

In another aspect, the transition metal complex may be represented by Formula 25:

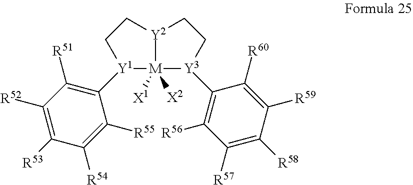

wherein in Formula 25:

M is an element selected from group 4 of the Periodic Table of the Elements;

R⁵¹, R⁵², R⁵³, R⁵⁴, R⁵⁵, R⁵⁶, R⁵⁷, R⁵⁸, R⁵⁹, R⁶⁰ are independently selected from the group consisting of hydrogen, alkyl, substituted alkyl, cycloalkyl, substituted cycloalkyl, heteroalkyl, substituted heteroalkyl, heterocycloalkyl, substituted heterocycloalkyl, aryl, substituted aryl, heteroaryl, substituted heteroaryl, alkoxy, aryloxy, halo, silyl, boryl, phosphino, amino, thioalkyl, thioaryl, nitro, and combinations thereof;

Y¹ and Y² are independently O, N, NH, or S; and

X¹ and X² are, independently, hydrogen, halogen, hydrocarbyl, substituted hydrocarbyl, halocarbyl, substituted halocarbyl, silyl, silylcarbyl, substituted silylcarbyl, germylcarbyl, substituted germylcarbyl, aryl, substituted aryl, heteroaryl, substituted heteroaryl, alkoxy, substituted alkoxy, aryloxy, substituted aryloxy, boryl, amino, phosphino, ether, thioether, phosphine, amine, carboxylate, alkylthio, arylthio, 1,3-dionate, oxalate, carbonate, nitrate, or sulphate, or both X¹ and X² are joined and bound to the metal atom to form a metallacycle ring containing from about 3 to about 20 carbon atoms; or both together can be an olefin, diolefin or aryne ligand.

In at least one aspect, M is a group 4 metal, such as zirconium or hafnium, such as M is zirconium.

In at least one aspect, Y¹ and Y² are independently O or N.

In at least one aspect, X¹ and X² are independently alkyl (such as alkyl groups having 1 to 10 carbons, such as methyl, ethyl, propyl, butyl, pentyl, hexyl, heptyl, octyl, nonyl, decyl, and isomers thereof), aryl, alkyaryl (such as benzyl), hydride, alkylsilane, fluoride, chloride, bromide, iodide, triflate, carboxylate, amido (such as NMe₂), or alkylsulfonate.

In at least one aspect, R⁵¹, R⁵², R⁵³, R⁵⁴, R⁵⁵ R⁵⁶, R⁵⁷, R⁵⁸, R⁵⁹, and R⁶⁰ are independently hydride, alkyl, substituted alkyl, aryl, or substituted aryl groups.

In at least one aspect, R⁵¹, R⁵², R⁵³, R⁵⁴, R⁵⁵ R⁵⁶, R⁵⁷, R⁵⁸, R⁵⁹, and R⁶⁰ are alkyl groups, such as methyl groups.

An exemplary oxybis(ethylamine) complex used for polymerizations of the present disclosure may be represented by Formula 26.

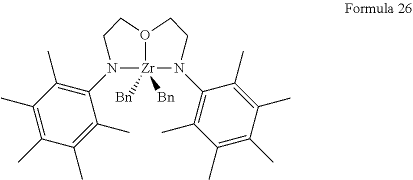

An exemplary diethylenetriamine complex used for polymerizations of the present disclosure may be represented by Formula 27.

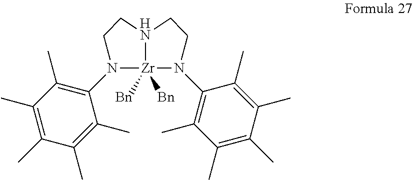

In some embodiments, a co-activator is combined with the transition metal complex (such as a halogenated catalyst compound described above) to form an alkylated catalyst compound. Organoaluminum compounds which may be utilized as co-activators include, for example, trialkyl aluminum compounds, such as trimethylaluminum, triethylaluminum, triisobutylaluminum, tri-n-hexylaluminum, tri-n-octylaluminum, and the like, or alumoxanes.

In some embodiments, two or more different transition metal complexes are present in the catalyst systems used herein. In some embodiments, two or more different transition metal complexes are present in the reaction zone where the process(es) described herein occur. When two transition metal complexes are used in one reactor as a mixed catalyst system, the two transition metal compounds are preferably chosen such that the two are compatible. A simple screening method such as by ¹H or ¹³C NMR, known to those of ordinary skill in the art, can be used to determine which transition metal complexes are compatible. It is preferable to use the same activator for the transition metal complexes, however, two different activators can be used in combination. If one or more transition metal complexes contain an anionic ligand as a leaving group which is not a hydride, hydrocarbyl, or substituted hydrocarbyl, then the alumoxane or other alkyl aluminum is typically contacted with the transition metal compounds prior to addition of the non-coordinating anion activator.

The two transition metal complexes may be used in any ratio. Preferred molar ratios of (A) transition metal complex to (B) transition metal complex fall within the range of (A:B) 1:1000 to 1000:1, alternatively 1:100 to 500:1, alternatively 1:10 to 200:1, alternatively 1:1 to 100:1, and alternatively 1:1 to 75:1, and alternatively 5:1 to 50:1. The particular ratio chosen will depend on the exact pre-catalysts chosen, the method of activation, and the end product desired. In a particular embodiment, when using the two pre-catalysts, where both are activated with the same activator, useful mole percents, based upon the molecular weight of the pre-catalysts, are 10 to 99.9% A to 0.1 to 90% B, alternatively 25 to 99% A to 0.5 to 50% B, alternatively 50 to 99% A to 1 to 25% B, and alternatively 75 to 99% A to 1 to 10% B.

### Polymerization Methods

Polymerization methods using the supported activators described hereinabove are also provided by the present disclosure. The polymerization methods may comprise contacting a catalyst system comprising a supported activator and a transition metal complex with an olefinic feed comprising one or more olefins under polymerization reaction conditions to form a polyolefin. The supported activator comprises a support material, preferably a passivated support material, and a non-coordinating anion activator, preferably an ammonium or phosphonium borate activator, deposited upon the passivated support material. Suitable polymerization reaction conditions are provided herein below.

Polymerization processes of the present disclosure may polymerize at least one olefinic monomer, preferably at least one of propylene or ethylene, and optionally an additional comonomer, through contacting a catalyst system as specified above under polymerization reaction conditions. The transition metal complex and the non-coordinating anion activator may be combined in any order, and typically are combined on the support material prior to contacting with the at least one olefinic monomer. Preferably, the non-coordinating anion activator and the transition metal complex may be pre-deposited on the support material prior to contacting the at least one olefinic monomer.

Olefinic monomers useful in the disclosure herein include substituted or unsubstituted C₂ to C₄₀ alpha olefins, such as C₂ to C₂₀ alpha olefins, such as C₂ to C₁₂ alpha olefins, such as ethylene, propylene, butene, pentene, hexene, heptene, octene, nonene, decene, undecene, dodecene and isomers thereof. In at least one embodiment, the at least one olefinic monomer may comprise propylene and an optional comonomer comprising one or more ethylene or C₄ to C₄₀ olefins, such as C₄ to C₂₀ olefins, such as C₆ to C₁₂ olefins. The C₄ to C₄₀ olefins may be linear, branched, or cyclic. The C₄ to C₄₀ cyclic olefins may be strained or unstrained, monocyclic or polycyclic, and may optionally include heteroatoms and/or one or more functional groups. In at least one embodiment, the at least one olefinic monomer may comprise propylene and an optional comonomer comprising one or more C₃ to C₄₀ olefins, such as C₄ to C₂₀ olefins, such as C₆ to C₁₂ olefins. The C₃ to C₄₀ olefins may be linear, branched, or cyclic. The C₃ to C₄₀ cyclic olefins may be strained or unstrained, monocyclic or polycyclic, and may optionally include heteroatoms and/or one or more functional groups.

Exemplary C₂ to C₄₀ olefin monomers and optional comonomers suitable for polymerization according to the disclosure herein include propylene, propylene, butene, pentene, hexene, heptene, octene, nonene, decene, undecene, dodecene, norbomene, norbomadiene, dicyclopentadiene, cyclopentene, cycloheptene, cyclooctene, cyclooctadiene, cyclododecene, 7-oxanorbomene, 7-oxanorbomadiene, substituted derivatives thereof, and isomers thereof, such as hexene, heptene, octene, nonene, decene, dodecene, cyclooctene, 1,5-cyclooctadiene, 1-hydroxy-4-cyclooctene, 1-acetoxy-4-cyclooctene, 5-methylcyclopentene, cyclopentene, dicyclopentadiene, norbomene, norbomadiene, and their respective homologs and derivatives, such as norbomene, norbomadiene, and dicyclopentadiene.

In at least one embodiment, one or more dienes are present in the polymer produced herein at up to 10 wt %, such as at 0.00001 to 1.0 wt %, such as 0.002 to 0.5 wt %, such as 0.003 to 0.2 wt %, based upon the total weight of the composition. In some embodiments, 500 ppm or less of diene is added to the polymerization, such as 400 ppm or less, such as 300 ppm or less. In other embodiments at least 50 ppm of diene is added to the polymerization, or 100 ppm or more, or 150 ppm or more.

Diene monomers include any hydrocarbon structure, such as C₄ to C₃₀, having at least two unsaturated bonds, wherein at least two of the unsaturated bonds are readily incorporated into a polymer by either a stereospecific or a non-stereospecific catalyst(s). The diene monomers can be selected from alpha, omega-diene monomers (i.e. di-vinyl monomers). The diolefin monomers include linear di-vinyl monomers, such as those containing from 4 to carbon atoms. Examples of diene monomers include butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, and low molecular weight polybutadienes (Mw less than 1000 g/mol). Cyclic dienes include cyclopentadiene, vinylnorbornene, norbomadiene, ethylidene norbornene, divinylbenzene, dicyclopentadiene or higher ring-containing diolefins with or without substituents at various ring positions.

Polymerization processes of the present disclosure can be carried out in any suitable manner. Any suitable suspension, homogeneous, bulk, solution, slurry, or gas phase polymerization process can be used. Such processes can be run in a batch, semi-batch, or continuous mode. Preferably, polymerization processes of the present disclosure may be continuous and run in the gas phase or under slurry conditions. As used herein the term “slurry polymerization process” means a polymerization process where a supported catalyst system is employed and monomers are polymerized on the supported catalyst system. At least 95 wt % of polymer products derived from the supported catalyst systems are in granular form as solid particles (not dissolved in the diluent). Gas phase polymerization processes may similarly grow the polymer product on the supported catalyst systems.

Suitable diluents/solvents for slurry polymerization include non-coordinating, inert liquids. Examples include straight and branched-chain hydrocarbons, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as can be found commercially (Isopar™); perhalogenated hydrocarbons, such as perfluorinated C₄-C₁₀ alkanes, chlorobenzene, and aromatic and alkylsubstituted aromatic compounds, such as benzene, toluene, mesitylene, and xylene. Suitable solvents also include liquid olefins which may act as monomers or comonomers including ethylene, propylene, 1-butene, 1-hexene, 1-pentene, 3-methyl-1-pentene, 4-methyl-1-pentene, 1-octene, 1-decene, and mixtures thereof. In at least one embodiment, the solvent is not aromatic, such that aromatics are present in the solvent at less than 1 wt %, such as less than 0.5 wt %, such as less than 0 wt % based upon the weight of the solvents. More preferably, contacting the catalyst system with the one or more olefinic monomers takes place in a substantial absence of aromatic solvent.

In at least one embodiment, the feed concentration of the monomers and comonomers for the polymerization is 60 vol % solvent or less, such as 40 vol % or less, such as vol % or less, based on the total volume of the feedstream. The polymerization can be performed in a bulk process.

Polymerizations can be performed at any temperature and/or pressure suitable to obtain the desired polymers, such as ethylene and or propylene polymers. Typical temperatures and/or pressures comprising the polymerization reaction conditions include a temperature in the range of about 0° C. to 300° C., such as 20° C. to 200° C., such as 35° C. to 150° C., such as 40° C. to 120° C., such as 45° C. to 80° C., for example about 74° C., and a pressure in the range of about 0.35 MPa to 10 MPa, such as 0.45 MPa to 6 MPa, such as 0.5 MPa to 4 MPa.

The run time of the polymerization reaction may be up to about 300 minutes, such as in the range of from 5 to 250 minutes, such as 10 to 120 minutes.

In at least one embodiment, hydrogen is present in the polymerization reactor at a partial pressure of 0.001 to 50 psig (0.007 to 345 kPa), such as from 0.01 to 25 psig (0.07 to 172 kPa), such as 0.1 to 10 psig (0.7 to 70 kPa).

In at least one embodiment, the activity of the catalyst is from 50 gP/mmolCat/hour to 200,000 gP/mmolCat/hr, such as from 10,000 gP/mmolCat/hr to 150,000 gP/mmolCat/hr, such as from 40,000 gP/mmolCat/hr to 100,000 gP/mmolCat/hr, such as about 50,000 gP/mmolCat/hr or more, such as 70,000 gP/mmolCat/hr or more. In at least one embodiment, the conversion of olefin monomer may be at least 10%, based upon polymer yield and the weight of the monomer entering the reaction zone, such as 20% or more, such as 30% or more, such as 50% or more, such as 80% or more.

In at least one embodiment, a catalyst system of the present disclosure is capable of producing a polyolefin. In at least one embodiment, a polyolefin is a homopolymer of ethylene or propylene or a copolymer of ethylene such as a copolymer of ethylene having from 0.1 to 25 wt % (such as from 0.5 to 20 wt %, such as from 1 to 15 wt %, such as from 5 to 17 wt %) of ethylene with the remaining balance being one or more C₃ to C₂₀ olefin comonomers (such as C₃ to C₁₂ alpha-olefin, such as propylene, butene, hexene, octene, decene, dodecene, such as propylene, butene, hexene, octene). A polyolefin can be a copolymer of propylene such as a copolymer of propylene having from 0.1 to 25 wt % (such as from 0.5 to 20 wt %, such as from 1 to 15 wt %, such as from 3 to 10 wt %) of propylene and from 99.9 to 75 wt % of one or more of C₂ or C₄ to C₂₀ olefin comonomer (such as ethylene or C₄ to C₁₂ alpha-olefin, such as butene, hexene, octene, decene, dodecene, such as ethylene, butene, hexene, octene).

In at least one embodiment, a catalyst system of the present disclosure may be capable of producing polyolefins, such as polyethylene, polypropylene (e.g., iPP), or ethylene-octene copolymers, having an Mw from 500 to 2,500,000, such as from 20,000 to 2,000,000, such as from 30,000 to 1,500,000, such as from 40,000 to 1,000,000, such as from 50,000 to 900,000, such as from 60,000 to 800,000.

In at least one embodiment, a catalyst system of the present disclosure may be capable of producing polyolefins, such as polyethylene, polypropylene (e.g., iPP), or ethylene-octene copolymers having an Mw/Mn value from 1 to 10, such as from 1.5 to 9, such as from 2 to 7, such as from 2 to 4, such as from 2.5 to 3, for example about 2.

In at least one embodiment, a catalyst system of the present disclosure may be capable of producing polyolefins, such as polyethylene, polypropylene (e.g., iPP), or ethylene-octene copolymers having a melting temperature (Tm) of less than 140° C., or 30° C. to 150° C., such as 40° C. to 140° C., such as 45° C. to 135° C., such as 50° C. to 135° C.

In at least one embodiment, little or no scavenger is used in the process to produce polymer, such as propylene polymer. Scavenger (such as trialkyl aluminum) can be present at zero mol %, alternately the scavenger is present at a molar ratio of scavenger metal to transition metal of less than 100:1, such as less than 50:1, such as less than 15:1, such as less than 10:1.

In at least one embodiment, the scavenger may be disposed upon a support material, wherein the support may be separate from the supported catalyst system.

In at least one embodiment, the polymerization: 1) is conducted at temperatures of 0 to 300° C. (such as 25 to 150° C., such as 40 to 120° C., such as 70 to 110° C., such as 85 to 100° C.); 2) is conducted at a pressure of atmospheric pressure to 10 MPa (such as 0.35 to 10 MPa, such as from 0.45 to 6 MPa, such as from 0.5 to 4 MPa); 3) is conducted in an aliphatic hydrocarbon solvent (such as isobutane, butane, pentane, isopentane, hexanes, isohexane, heptane, octane, dodecane, and mixtures thereof, cyclic and alicyclic hydrocarbons, such as cyclohexane, cycloheptane, methylcyclohexane, methylcycloheptane, and mixtures thereof, where aromatics are present in the solvent at less than 1 wt %, such as less than 0.5 wt %, such as at 0 wt % based upon the weight of the solvents); and 4) the productivity of the catalyst compound is at least 30,000 gP/mmolCat/hr (such as at least 50,000 gP/mmolCat/hr, such as at least 60,000 gP/mmolCat/hr, such as at least 80,000 gP/mmolCat/hr, such as at least 100,000 gP/mmolCat/hr).

In at least one embodiment, the catalyst system used in the polymerization comprises no more than one transition metal complex. A “reaction zone” also referred to as a “polymerization zone” is a vessel where polymerization takes place, for example a batch reactor. When multiple reactors are used in either series or parallel configuration, each reactor is considered as a separate polymerization zone. For a multi-stage polymerization in both a batch reactor and a continuous reactor, each polymerization stage is considered as a separate polymerization zone. In at least one embodiment, the polymerization occurs in one reaction zone.

Other additives may also be used in the polymerization, as desired, such as one or more scavengers, promoters, modifiers, chain transfer agents (such as diethyl zinc), hydrogen, or aluminum alkyls. Useful chain transfer agents are typically alkylalumoxanes, a compound represented by the formula AlR₃, ZnR₂ (where each R is, independently, a C₁-C₈ aliphatic radical, such as methyl, ethyl, propyl, butyl, phenyl, hexyl, octyl or an isomer thereof) or a combination thereof, such as diethyl zinc, methylalumoxane, trimethylaluminum, triisobutylaluminum, trioctylaluminum, or a combination thereof.

Gas phase polymerization processes may be conducted under fluidized gas bed conditions used for producing polymers, such that a gaseous stream containing one or more monomers is continuously cycled through a fluidized bed of the catalyst system under polymerization reaction conditions. The gaseous stream is withdrawn from the fluidized bed and recycled back into the reactor. Simultaneously, polymer product is withdrawn from the reactor and fresh monomer is added to replace the polymerized monomer. (See, for example, U.S. Pat. Nos. 4,543,399; 4,588,790; 5,028,670; 5,317,036; 5,352,749; 5,405,922; 5,436,304; 5,453,471; 5,462,999; 5,616,661; and 5,668,228; all of which are fully incorporated herein by reference.)

Slurry phase polymerization processes generally operate between 1 to about 50 atmosphere pressure range (15 psi to 735 psi, 103 kPa to 5068 kPa) or even greater and temperatures in the range of 0° C. to about 120° C. In a slurry polymerization, a suspension of the catalyst system is formed in a liquid polymerization diluent medium to which monomer and comonomers are introduced. The suspension including diluent is intermittently or continuously removed from the reactor where the volatile components are separated from the polymer and recycled, optionally after a distillation, to the reactor. The liquid diluent used in the polymerization medium is typically an alkane having from 3 to 7 carbon atoms, such as a branched alkane. The medium employed should be liquid under the conditions of polymerization and relatively inert. When a propane medium is used, the process must be operated above the reaction diluent critical temperature and pressure. For example, a hexane or an isobutane medium is employed.

In at least one embodiment, polymerization processes of the present disclosure include a particle form polymerization, or a slurry process, where the temperature is kept below the temperature at which the polymer goes into solution. Such techniques are well known in the art, and described in for instance U.S. Pat. No. 3,248,179 which is fully incorporated herein by reference. The temperature in the particle form polymerization process can be from about 85° C. to about 110° C. Two example polymerization methods for the slurry process are those using a loop reactor and those utilizing a plurality of stirred reactors in series, parallel, or combinations thereof. Non-limiting examples of slurry processes include continuous loop or stirred tank processes. Also, other examples of slurry processes are described in U.S. Pat. No. 4,613,484, which is herein fully incorporated by reference.

In another embodiment, the slurry process may be carried out continuously in a loop reactor. The catalyst, as a slurry in isohexane or as a dry free flowing powder, is injected regularly to the reactor loop, which is itself filled with circulating slurry of growing polymer particles in a diluent of isohexane containing monomer and optional comonomer. Hydrogen, optionally, may be added as a molecular weight control. In one embodiment, hydrogen may be added from 50 ppm to 500 ppm, such as from 100 ppm to 400 ppm, such as 150 ppm to 300 ppm.

The reactor may be maintained at a pressure of 2,000 kPa to 5,000 kPa, such as from 3,620 kPa to 4,309 kPa, and at a temperature of from about 60° C. to about 120° C. depending on the desired polymer melting characteristics. Reaction heat is removed through the loop wall since much of the reactor is in the form of a double-jacketed pipe. The slurry is allowed to exit the reactor at regular intervals or continuously to a heated low pressure flash vessel, rotary dryer and a nitrogen purge column in sequence for removal of the isohexane diluent and all unreacted monomer and comonomer. The resulting hydrocarbon free powder is then compounded for use in various applications.

Other additives may also be used in the polymerization, as desired, such as one or more scavengers, promoters, modifiers, chain transfer agents (such as diethyl zinc), reducing agents, oxidizing agents, hydrogen, aluminum alkyls, or silanes.

Useful chain transfer agents are typically alkylalumoxanes, a compound represented by the formula AlR₃, ZnR₂ (where each R is, independently, a C₁-C₈ hydrocarbyl, such as methyl, ethyl, propyl, butyl, penyl, hexyl octyl or an isomer thereof). Examples can include diethyl zinc, methylalumoxane, trimethylaluminum, triisobutylaluminum, trioctylaluminum, or a combination thereof.

### Polymer Products

The present disclosure also provides compositions of matter which can be produced by the methods described herein.

In at least one embodiment, a polyolefin is a propylene homopolymer, an ethylene homopolymer or an ethylene copolymer, such as propylene-ethylene and/or ethylene-alphaolefin (such as C₄ to C₂₀) copolymer (such as an ethylene-hexene copolymer or an ethylene-octene copolymer). A polyolefin can have an Mw/Mn of greater than 1.

In at least one embodiment, a polyolefin is a homopolymer of ethylene or propylene or a copolymer of ethylene such as a copolymer of ethylene having from 0.1 to 25 wt % (such as from 0.5 to 20 wt %, such as from 1 to 15 wt %, such as from 5 to 17 wt %) of ethylene with the remainder balance being one or more C₃ to C₂₀ olefin comonomers (such as C₃ to C₁₂ alpha-olefin, such as propylene, butene, hexene, octene, decene, dodecene, such as propylene, butene, hexene, octene). A polyolefin can be a copolymer of propylene such as a copolymer of propylene having from 0.1 to 25 wt % (such as from 0.5 to 20 wt %, such as from 1 to 15 wt %, such as from 3 to 10 wt %) of propylene and from 99.9 to 75 wt % of one or more of C₂ or C₄ to C₂₀ olefin comonomer (such as ethylene or C₄ to C₁₂ alpha-olefin, such as butene, hexene, octene, decene, dodecene, such as ethylene, butene, hexene, octene).

In at least one embodiment, a catalyst system of the present disclosure is capable of producing polyolefins, such as polyethylene, polypropylene (e.g., iPP), or ethylene-octene copolymers, having an Mw from 500 to 2,500,000, such as from 20,000 to 2,000,000, such as from 30,000 to 1,500,000, such as from 40,000 to 1,000,000, such as from 50,000 to 900,000, such as from 60,000 to 800,000.

In at least one embodiment, a catalyst system of the present disclosure is capable of producing polyolefins, such as polyethylene, polypropylene (e.g., iPP), or ethylene-octene copolymers having an Mw/Mn value from 1 to 10, such as from 1.5 to 9, such as from 2 to 7, such as from 2 to 4, such as from 2.5 to 3, for example about 2.

In at least one embodiment, a catalyst system of the present disclosure is capable of producing polyolefins, such as polyethylene, polypropylene (e.g., iPP), or ethylene-octene copolymers having a melting temperature (Tm) of less than 140° C., or 30° C. to 150° C., such as 40° C. to 140° C., such as 45° C. to 135° C., such as 50° C. to 135° C.

In at least one embodiment, a polymer of the present disclosure has a g′ᵥᵢₛ of greater than 0.9, such as greater than 0.92, such as greater than 0.95.

In at least one embodiment, the polymer is an ethylene copolymer, and the comonomer is octene, at a comonomer content of from 1 wt % to 18 wt % octene, such as from 5 wt % to 15 wt %, such as from 8 wt % to 13 wt %, such as from 9 wt % to 12 wt %.

In at least one embodiment, the polymer produced herein has a unimodal or multimodal molecular weight distribution as determined by Gel Permeation Chromatography (GPC). By “unimodal” is meant that the GPC trace has one peak or inflection point. By “multimodal” is meant that the GPC trace has at least two peaks or inflection points. An inflection point is that point where the second derivative of the curve changes in sign (e.g., from negative to positive or vice versus).

In at least one embodiment, the polymer produced herein has a composition distribution breadth index (CDBI) of 50% or more, such as 60% or more, such as 70% or more. CDBI is a measure of the composition distribution of monomer within the polymer chains and is measured by the procedure described in PCT publication WO 1993/003093, published Feb. 18, 1993, specifically columns 7 and 8 as well as in Wild, L. et al. (1982) “Determination of Branching Distributions in Polyethylene and Ethylene Copolymers,” J. Poly. Sci., Poly. Phys. Ed., v. 20(3), pp. 441-455; and U.S. Pat. No. 5,008,204, including that fractions having a weight average molecular weight (Mw) below 15,000 are ignored when determining CDBI.

Copolymer of the present disclosure can have a reversed comonomer index. The reversed-co-monomer index (RCI,m) is computed from x2 (mol % co-monomer C₃, C₄, C₆, C₈, etc.), as a function of molecular weight, where x2 is obtained from the following expression in which n is the number of carbon atoms in the comonomer (3 for C₃, 4 for C₄, 6 for C₆, etc.):

$$x 2 = - \frac{200 w 2}{- 100 n - 2 w2 + n w 2} .$$

Then the molecular-weight distribution, W(z) where z=log₁₀ M, is modified to W′(z) by setting to 0 the points in w that are less than 5% of the maximum of w; this is to effectively remove points for which the S/N in the composition signal is low. Also, points of W′ for molecular weights below 2000 gm/mole are set to 0. Then W′ is renormalized so that

1=∫_{-∞}^{∞}W′dz

a modified weight-average molecular weight (M′) is calculated over the effectively reduced range of molecular weights as follows:

M_{W}′=∫_{-∞}^{∞}10^{z}*W′dx

The RCI,m is then computed as:

RCI,m=∫_{-∞}^{∞}×2(10²−M_{W}′)W′dz

A reversed-co-monomer index (RCI,w) is also defined on the basis of the weight fraction co-monomer signal (w2/100) and is computed as follows:

$$R C I , w = {\int }_{- ∞}^{∞} \frac{w 2}{100} ( {10}^{z} - {{M}_{w}}^{′} ) {W}^{′} dz .$$

Note that in the above definite integrals the limits of integration are the widest possible for the sake of generality; however, in reality the function is only integrated over a finite range for which data is acquired, considering the function in the rest of the non-acquired range to be 0. Also, by the manner in which W′ is obtained, it is possible that W7 is a discontinuous function, and the above integrations need to be done piecewise.

Three co-monomer distribution ratios are also defined on the basis of the % weight (w2) comonomer signal, denoted as CDR-1,w, CDR-2,w, and CDR-3,w, as follows:

$$\begin{matrix}C D R ‐ 1 , w = \frac{w 2 ( Mz )}{w 2 ( Mw )} \\ C D R ‐ 2 , w = \frac{w 2 ( Mz )}{w 2 ( \frac{Mw + Mn}{2} )} \\ C D R ‐ 3 , w = \frac{w 2 ( \frac{Mz + Mw}{2} )}{w 2 ( \frac{Mw + Mn}{2} )}\end{matrix}$$

where w2(Mw) is the % weight co-monomer signal corresponding to a molecular weight of Mw, w2(Mz) is the % weight co-monomer signal corresponding to a molecular weight of Mz, w2[(Mw+Mn)/2)] is the % weight co-monomer signal corresponding to a molecular weight of (Mw+Mn)/2, and w2[(Mz+Mw)/2] is the % weight co-monomer signal corresponding to a molecular weight of Mz+Mw/2, where Mw is the weight-average molecular weight, Mn is the number-average molecular weight, and Mz is the z-average molecular weight.

Accordingly, the co-monomer distribution ratios can be also defined utilizing the % mole co-monomer signal, CDR-1,m, CDR-2,m, CDR-3,m, as:

$$\begin{matrix}C D R ‐ 1 , m = \frac{x 2 ( Mz )}{x 2 ( Mw )} \\ C D R ‐ 2 , m = \frac{x 2 ( Mz )}{x 2 ( \frac{Mw + Mn}{2} )} \\ C D R ‐ 3 , m = \frac{x 2 ( \frac{Mz + Mw}{2} )}{x 2 ( \frac{Mw + Mn}{2} )}\end{matrix}$$

where x2(Mw) is the % mole co-monomer signal corresponding to a molecular weight of Mw, x2(Mz) is the % mole co-monomer signal corresponding to a molecular weight of Mz, x2[(Mw+Mn)/2)] is the % mole co-monomer signal corresponding to a molecular weight of (Mw+Mn)/2, and x2[(Mz+Mw)/2] is the % mole co-monomer signal corresponding to a molecular weight of Mz+Mw/2, where Mw is the weight-average molecular weight, Mn is the number-average molecular weight, and Mz is the z-average molecular weight.

In at least one embodiment of the present disclosure, the polymer produced by the processes described herein includes ethylene and one or more comonomers and the polymer has an RCI,m of 30 or more (alternatively from 30 to 250).

The distribution and the moments of molecular weight (Mw, Mn, Mw/Mn, etc.), the comonomer content (C₂, C₃, C₆, etc.) and the long chain branching (g′) are determined by using a high temperature Gel Permeation Chromatography (Polymer Char GPC-IR) equipped with a multiple-channel band-filter based Infrared detector IR5, an 18-angle light scattering detector and a viscometer. Three Agilent PLgel 10 μm Mixed-B LS columns are used to provide polymer separation. Aldrich reagent grade 1,2,4-trichlorobenzene (TCB) with 300 ppm antioxidant butylated hydroxytoluene (BHT) is used as the mobile phase. The TCB mixture is filtered through a 0.1 m Teflon filter and degassed with an online degasser before entering the GPC instrument. The nominal flow rate is 1.0 mL/min and the nominal injection volume is 200 μL. The whole system, including transfer lines, columns, and detectors, is contained in an oven maintained at 145° C. A given amount of polymer sample is weighed and sealed in a standard vial with 80 μL flow marker (Heptane) added to it. After loading the vial in the autosampler, polymer is automatically dissolved in the instrument with 8 mL added TCB solvent. The polymer is dissolved at 160° C. with continuous shaking for about 1 hour for most PE samples or 2 hour for PP samples. The TCB densities used in concentration calculation are 1.463 g/ml at room temperature and 1.284 g/ml at 145° C. The sample solution concentration is from 0.2 to 2.0 mg/ml, with lower concentrations being used for higher molecular weight samples.

The concentration (c), at each point in the chromatogram is calculated from the baseline-subtracted IR5 broadband signal intensity (I), using the following equation:

c=βI

where β is the mass constant determined with PE or PP standards. The mass recovery is calculated from the ratio of the integrated area of the concentration chromatography over elution volume and the injection mass which is equal to the pre-determined concentration multiplied by injection loop volume.

The conventional molecular weight (IR MW) is determined by combining universal calibration relationship with the column calibration which is performed with a series of monodispersed polystyrene (PS) standards ranging from 700 to 10M. The MW at each elution volume is calculated with following equation;

$$log M = \frac{log ( {K}_{P S} / K )}{a + 1} + \frac{{a}_{P S} + 1}{a + 1} log {M}_{P S}$$

where the variables with subscript “PS” stands for polystyrene while those without a subscript are for the test samples. In this method, a_{PS}=0.67 and K_{PS}=0.000175 while a and K are calculated as described in the published literature (Sun, T. et al. (2001) “Effect of Short Chain Branching on the Coil Dimensions of Polyolefins in Dilute Solutions,” Macromolecules, v. 34(19), pp. 6812-6820), except that for purposes of this invention and claims thereto, α=0.695 and K=0.000579 for linear ethylene polymers, α=0.705 and K=0.0002288 for linear propylene polymers, α=0.695+(0.01*(wt. fraction propylene)) and K=0.000579-(0.0003502*(wt. fraction propylene)) for ethylene-propylene copolymers. Concentrations are expressed in g/cm³, molecular weight is expressed in g/mole, and intrinsic viscosity (hence K in the Mark-Houwink equation) is expressed in dL/g unless otherwise noted.

The comonomer composition is determined by the ratio of the IR5 detector intensity corresponding to CH₂ and CH₃ channel calibrated with a series of PE and PP homo/copolymer standards whose nominal value are predetermined by NMR or FTIR such as EMCC commercial grades about LLDPE, Vistamaxx, ICP, etc.

The LS detector is the 18-angle Wyatt Technology High Temperature DAWN HELEOSII. The LS molecular weight (M) at each point in the chromatogram is determined by analyzing the LS output using the Zimm model for static light scattering (M. B. Huglin, Light Scattering from Polymer Solutions, Academic Press, 1971):

$$\frac{{K}_{o} c}{Δ R ( θ )} = \frac{1}{MP ( θ )} + 2 {A}_{2} c$$

Here, ΔR(θ) is the measured excess Rayleigh scattering intensity at scattering angle θ, c is the polymer concentration determined from the IR5 analysis, A₂ is the second virial coefficient. P(θ) is the form factor for a monodisperse random coil, and Kₒ is the optical constant for the system:

$${K}_{o} = \frac{4 {π}^{2} {{n}^{2} ( dn / dc )}^{2}}{{λ}^{4} {N}_{A}}$$

where N_{A} is Avogadro's number, and (dn/dc) is the refractive index increment for the system. The refractive index, n=1.500 for TCB at 145° C. and λ=665 nm.

A high temperature Agilent (or Viscotek Corporation) viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, ηₛ, for the solution flowing through the viscometer is calculated from their outputs. The intrinsic viscosity, [η], at each point in the chromatogram is calculated from the following equation:

[η]=ηₛ/c

where c is concentration and was determined from the IR5 broadband channel output. The viscosity MW at each point is calculated from the below equation:

M=K_{PS}M^{α}^{_{PS}}⁺¹/[η].

The branching index (g′ᵥᵢₛ) is calculated using the output of the GPC-IR5-LS-VIS method as follows. The average intrinsic viscosity, [η]_{avg}, of the sample is calculated by:

$${[ η ]}_{a v g} = \frac{\sum {{c}_{i} [ η ]}_{i}}{\sum {c}_{i}}$$

where the summations are over the chromatographic slices, i, between the integration limits. The branching index g′ᵥᵢₛ is defined as:

$${g}_{vis}^{′} = \frac{{[ η ]}_{avg}}{k {M}_{v}^{α}}$$

Mᵥ is the viscosity-average molecular weight based on molecular weights determined by LS analysis. The K/a are for the reference linear polymers are as described above.

All the concentration is expressed in g/cm³, molecular weight is expressed in g/mole, and intrinsic viscosity is expressed in dL/g unless otherwise noted.

All molecular weights are reported in g/mol unless otherwise noted.

### Blends

In another embodiment, the polymer (such as the polyethylene or polypropylene) produced herein is combined with one or more additional polymers prior to being formed into a film, molded part or other article. Other useful polymers include polyethylene, isotactic polypropylene, highly isotactic polypropylene, syndiotactic polypropylene, random copolymer of propylene and ethylene, and/or butene, and/or hexene, polybutene, ethylene vinyl acetate, low density polyethylene (LDPE), linear low density polyethylene (LLDPE), high density polyethylene (HDPE), ethylene vinyl acetate, ethylene methyl acrylate, copolymers of acrylic acid, polymethylmethacrylate or any other polymers polymerizable by a high-pressure free radical process, polyvinylchloride, polybutene-1, isotactic polybutene, ABS resins, ethylene-propylene rubber (EPR), vulcanized EPR, EPDM, block copolymer, styrenic block copolymers, polyamides, polycarbonates, PET resins, cross linked polyethylene, copolymers of ethylene and vinyl alcohol (EVOH), polymers of aromatic monomers such as polystyrene, poly-1 esters, polyacetal, polyvinylidine fluoride, polyethylene glycols, and/or polyisobutylene.

In at least one embodiment, the polymer (such as polyethylene or polypropylene) is present in the above blends, at from 10 to 99 wt %, based upon the weight of the polymers in the blend, such as 20 to 95 wt %, such as at least 30 to 90 wt %, such as at least 40 to 90 wt %, such as at least 50 to 90 wt %, such as at least 60 to 90 wt %, such as at least 70 to 90 wt %.

The blends described above may be produced by mixing the polymers of the present disclosure with one or more polymers (as described above), by connecting reactors together in series to make reactor blends or by using more than one catalyst in the same reactor to produce multiple species of polymer. The polymers can be mixed together prior to being put into the extruder or may be mixed in an extruder.

The blends may be formed using conventional equipment and methods, such as by dry blending the individual components and subsequently melt mixing in a mixer, or by mixing the components together directly in a mixer, such as, for example, a Banbury mixer, a Haake mixer, a Brabender internal mixer, or a single or twin-screw extruder, which may include a compounding extruder and a side-arm extruder used directly downstream of a polymerization process, which may include blending powders or pellets of the resins at the hopper of the film extruder. Additionally, additives may be included in the blend, in one or more components of the blend, and/or in a product formed from the blend, such as a film, as desired. Such additives are well known in the art, and can include, for example: fillers; antioxidants (e.g., hindered phenolics such as IRGANOX™ 1010 or IRGANOX™ 1076 available from Ciba-Geigy); phosphites (e.g., IRGAFOS™ 168 available from Ciba-Geigy); anti-cling additives; tackifiers, such as polybutenes, terpene resins, aliphatic and aromatic hydrocarbon resins, alkali metal and glycerol stearates, and hydrogenated rosins; UV stabilizers; heat stabilizers; anti-blocking agents; release agents; anti-static agents; pigments; colorants; dyes; waxes; silica; fillers; and talc.

Embodiments disclosed herein include:

A. Supported activators. The supported activators comprise: a support material; and a non-coordinating anion activator deposited on the support material, the non-coordinating anion activator having a solubility of at least about 5 mM at 25° C. in at least one aliphatic hydrocarbon solvent.

B. Catalyst systems. The catalyst systems comprise: a supported activator comprising a support material and a non-coordinating anion activator deposited on the support material, the non-coordinating anion activator having a solubility of at least about 5 mM at 25° C. in at least one aliphatic hydrocarbon solvent; and a transition metal complex activatable by the supported activator.

C. Polymerization methods. The methods comprise contacting a catalyst system comprising a supported activator comprising a support material and a non-coordinating anion activator deposited on the support material with an olefinic feed comprising one or more olefins under polymerization reaction conditions to form a polyolefin, the non-coordinating anion activator having a solubility of at least about 5 mM at 25° C. in at least one aliphatic hydrocarbon solvent; and a transition metal complex activatable by the supported activator.

D. Methods for making supported activators. The methods comprise: contacting at least one support material with a non-coordinating anion activator dissolved in at least one aliphatic hydrocarbon solvent; and removing the at least one aliphatic hydrocarbon solvent to deposit the non-coordinating anion activator upon the at least one support material, thereby forming a supported activator.

Embodiments A-D may have one or more of the following elements in any combination:

Element 1: wherein the supported activator is substantially free of aromatic solvent.

Element 2: wherein the support material is passivated and comprises a reaction product of an unpassivated support material and a hydrocarbyl aluminum compound.

Element 3: wherein the hydrocarbyl aluminum compound comprises a trialkylaluminum compound.

Element 4: wherein the unpassivated support material comprises an inorganic oxide selected from the group consisting of Al₂O₃, ZrO₂, SiO₂, SiO₂/Al₂O₃, SiO₂/TiO₂, silica/clay, silicon oxide/clay, and mixtures thereof.

Element 5: wherein the unpassivated support material comprises silica.

Element 6: wherein the non-coordinating anion activator comprises an ammonium or phosphonium borate represented by Formula 3

[R¹¹R¹²R¹³EH]⁺[BR¹⁴R¹⁵R¹⁶R¹⁷]⁻ Formula 3

wherein

E is nitrogen or phosphorus;

R¹¹, R¹², and R¹³ are independently a C₁-C₃₀, optionally substituted, alkyl group, an aryl group, an aryl group substituted with a C₁-C₃₀, optionally substituted, alkyl group, or an aryl group substituted with a C₁-C₃₀, optionally substituted, alkoxy group, provided that among R¹¹, R¹², and R¹³ at least one C₁₀₊ alkyl group or C₁₀₊ alkoxy group is present; and

R¹⁴, R¹⁵, R¹⁶, and R¹⁷ are each an independently selected halosubstituted aryl group.

Element 7: wherein E is N.

Element 8: wherein R¹⁴, R¹⁵, R¹⁶, and R¹⁷ are each an independently selected perfluorinated aryl group.

Element 9: wherein the non-coordinating anion activator comprises a cation portion having a structure represented by a formula selected from the group consisting of

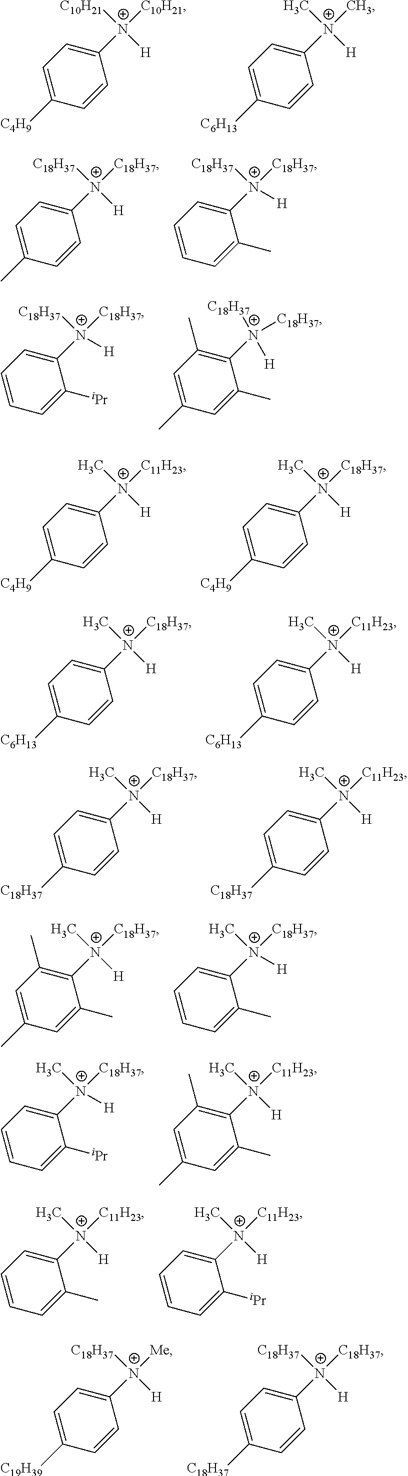

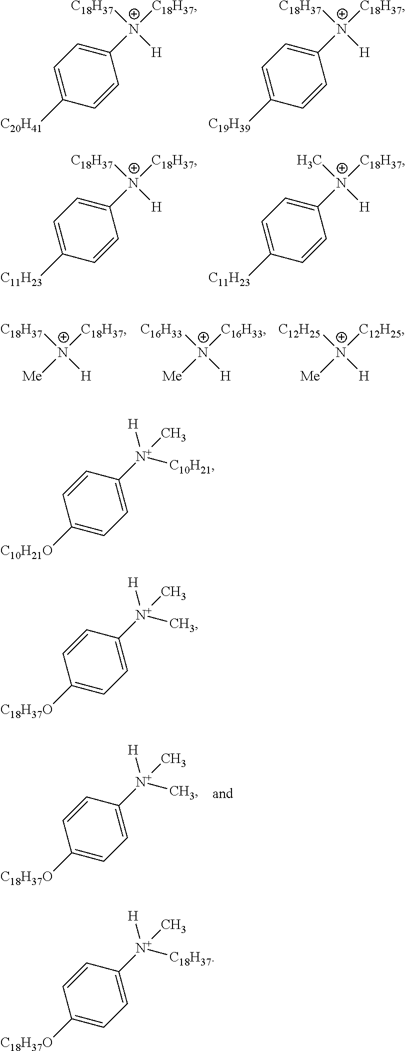

Element 10: wherein the non-coordinating anion activator comprises an anion portion selected from the group consisting of tetrakis(perfluorophenyl)borate, tetrakis(perfluoronaphthyl)borate, and tetrakis(perfluorobiphenyl)borate.

Element 11: wherein the non-coordinating anion activator has a solubility of at least about 5 mM at 25° C. in methylcyclohexane.

Element 12: wherein the non-coordinating anion activator has a solubility of at least about 5 mM at 25° C. in isohexane.

Element 13: wherein the catalyst system is substantially free of aromatic solvent.

Element 14: wherein the transition metal complex comprises a metallocene catalyst effective to promote olefin polymerization.

Element 15: wherein the transition metal complex comprises a non-metallocene catalyst effective to promote olefin polymerization.

Element 16: wherein the transition metal complex is also deposited upon the support material.

Element 17: wherein the transition metal complex has a solubility of at least about 5 mM at 25° C. in at least one aliphatic hydrocarbon solvent.

Element 18: wherein contacting takes place in a substantial absence of aromatic solvent.

Element 19: wherein the olefinic feed comprises one or more alpha olefins.

Element 20: wherein contacting is performed under gas phase polymerization reaction conditions or slurry phase polymerization reaction conditions.

Element 21: wherein the method further comprises passivating the at least one support material by contacting at least one unpassivated support material with a hydrocarbyl aluminum compound.

Element 22: wherein the method further comprises contacting the at least one support material with a transition metal complex dissolved in at least one aliphatic hydrocarbon solvent; and removing the at least one aliphatic hydrocarbon solvent to deposit the transition metal complex upon the at least one support material.

Element 23: wherein the transition metal complex and the non-coordinating anion activator are present in a single aliphatic hydrocarbon solution when contacting the at least one support material.

Element 24: wherein the transition metal complex and the non-coordinating anion activator are present in separate aliphatic hydrocarbon solutions when contacting the at least one support material.

Illustrative combinations applicable to A-D include, but are not limited to: 1 and 2; 1-3; 1 and 6; 1 and 9; 1 and 10; 1, 9 and 10; 1 and 11; 1 and 12; 1, 11 and 12; 2-4; 2, 4 and 5; 2 and 6; 2, 3 and 6; 2 and 9; 2 and 10; 2, 9 and 10; 2 and 11; 2 and 12; 6 and 7; 6 and 8; 6 and 10; 6 and 11; 6 and 12; and 11 and 12. In B, any of the foregoing may be in further combination with one or more of 13-17, and in C-D any of the foregoing may be in further combination with one or more of 13-24.

The present disclosure relates to:

1. A supported activator, comprising:

a support material; and

a non-coordinating anion activator deposited on the support material, the non-coordinating anion activator having a solubility of at least about 5 mM at 25° C. in at least one aliphatic hydrocarbon solvent.

2. The supported activator of paragraph 1, wherein the supported activator is substantially free of aromatic solvent.
3. The supported activator of paragraph 1 or paragraph 2, wherein the support material is passivated and comprises a reaction product of an unpassivated support material and a hydrocarbyl aluminum compound.
4. The supported activator of paragraph 3, wherein the hydrocarbyl aluminum compound comprises a trialkylaluminum compound.
5. The supported activator of paragraph 3 or paragraph 4, wherein the unpassivated support material comprises an inorganic oxide selected from the group consisting of Al₂O₃, ZrO₂, SiO₂, SiO₂/Al₂O₃, SiO₂/TiO₂, silica/clay, silicon oxide/clay, and mixtures thereof.
6. The supported activator of paragraph 3 or paragraph 4, wherein the unpassivated support material comprises silica.
7. The supported activator of any one of paragraphs 1-6, wherein the non-coordinating anion activator comprises an ammonium or phosphonium borate represented by Formula 3

[R¹¹R¹²R¹³EH]⁺[BR¹⁴R¹⁵R¹⁶R¹⁷]⁻ Formula 3

wherein

E is nitrogen or phosphorus;

R¹¹, R¹², and R¹³ are independently a C₁-C₃₀, optionally substituted, alkyl group, an aryl group, an aryl group substituted with a C₁-C₃₀, optionally substituted, alkyl group, or an aryl group substituted with a C₁-C₃₀, optionally substituted, alkoxy group, provided that among R¹¹, R¹², and R¹³ at least one C₁₀₊ alkyl group or C₁₀₊ alkoxy group is present; and

R¹⁴, R¹⁵, R¹⁶, and R¹⁷ are each an independently selected halosubstituted aryl group.

8. The supported activator of paragraph 7, wherein E is N.
9. The supported activator of paragraph 7 or paragraph 8, wherein R¹⁴, R¹⁵, R¹⁶, and R¹⁷ are each an independently selected perfluorinated aryl group.
10. The supported activator of any one of paragraphs 1-9, wherein the non-coordinating anion activator comprises a cation portion having a structure represented by a formula selected from the group consisting of

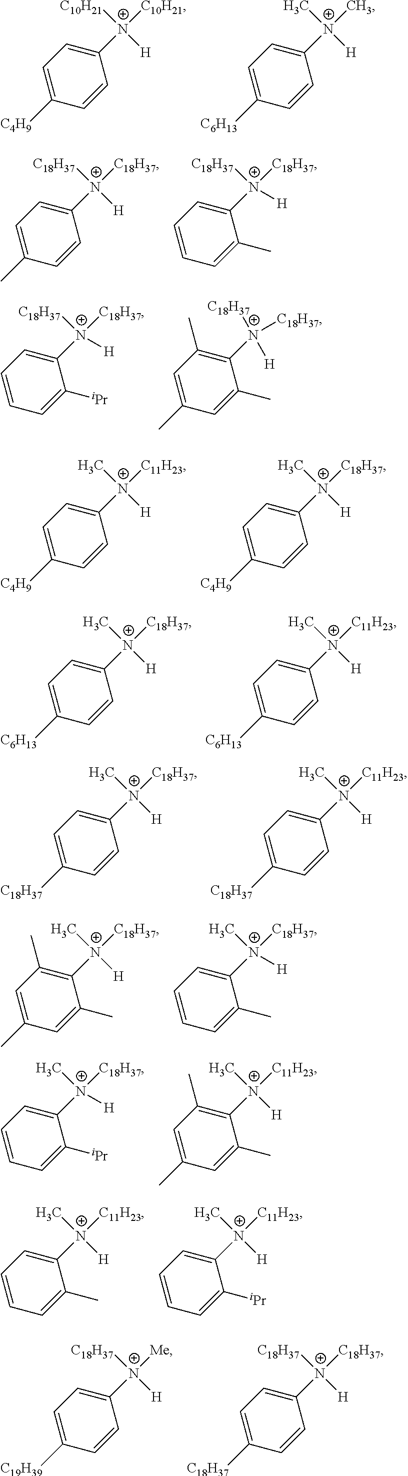

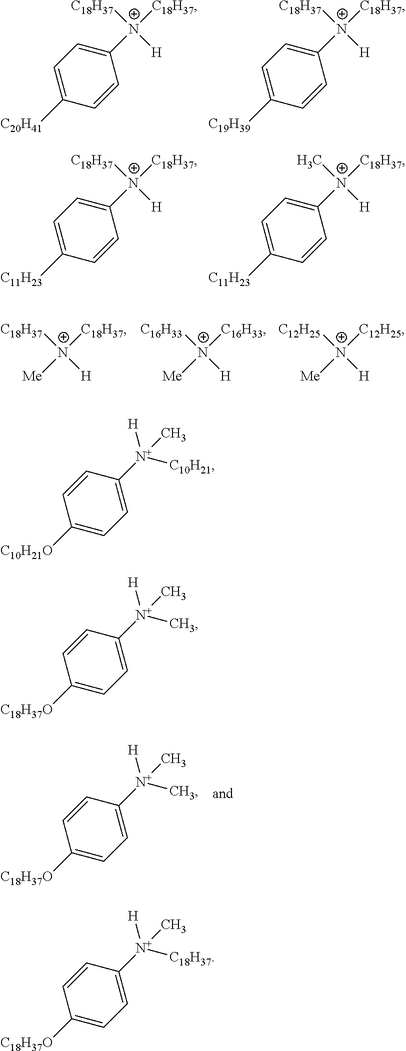

11. The supported activator of any one of paragraphs 1-10, wherein the non-coordinating anion activator comprises an anion portion selected from the group consisting of tetrakis(perfluorophenyl)borate, tetrakis(perfluoronaphthyl)borate, and tetrakis(perfluorobiphenyl)borate.
12. The supported activator of any one of paragraphs 1-11, wherein the non-coordinating anion activator has a solubility of at least about 5 mM at 25° C. in methylcyclohexane.
13. The supported activator of any one of paragraphs 1-12, wherein the non-coordinating anion activator has a solubility of at least about 5 mM at 25° C. in isohexane.
14. A catalyst system comprising:

a supported activator comprising a support material and a non-coordinating anion activator deposited on the support material, the non-coordinating anion activator having a solubility of at least about 5 mM at 25° C. in at least one aliphatic hydrocarbon solvent; and

a transition metal complex activatable by the supported activator.

15. The catalyst system of paragraph 14, wherein the catalyst system is substantially free of aromatic solvent.
16. The catalyst system of paragraph 14 or paragraph 15, wherein the support material is passivated and comprises a reaction product of an unpassivated support material and a hydrocarbyl aluminum compound.
17. The catalyst system of paragraph 16, wherein the hydrocarbyl aluminum compound comprises a trialkylaluminum compound.
18. The catalyst system of paragraph 16 or paragraph 17, wherein the unpassivated support material comprises an inorganic oxide selected from the group consisting of Al₂O₃, ZrO₂, SiO₂, SiO₂/Al₂O₃, SiO₂/TiO₂, silica/clay, silicon oxide/clay, and mixtures thereof.
19. The catalyst system of paragraph 16 or paragraph 17, wherein the unpassivated support material comprises silica.
20. The catalyst system of any one of paragraphs 14-19, wherein the non-coordinating anion activator comprises an ammonium or phosphonium borate represented by Formula 3

[R¹¹R¹²R¹³EH]⁺[BR¹⁴R¹⁵R¹⁶R¹⁷]⁻ Formula 3

wherein

E is nitrogen or phosphorus;

R¹¹, R¹², and R¹³ are independently a C₁-C₃₀, optionally substituted, alkyl group, an aryl group, an aryl group substituted with a C₁-C₃₀, optionally substituted, alkyl group, or an aryl group substituted with a C₁-C₃₀, optionally substituted, alkoxy group, provided that among R¹¹, R¹², and R¹³ at least one C₁₀₊ alkyl group or C₁₀₊ alkoxy group is present; and

R¹⁴, R¹⁵, R¹⁶, and R¹⁷ are each an independently selected halosubstituted aryl group.

21. The catalyst system of paragraph 20, wherein E is N.
22. The catalyst system of paragraph 20 or paragraph 21, wherein R¹⁴, R¹⁵, R¹⁶, and R¹⁷ are each an independently selected perfluorinated aryl group.
23. The catalyst system of any one of paragraphs 16-22, wherein the non-coordinating anion activator comprises a cation portion having a structure represented by a formula selected from the group consisting of

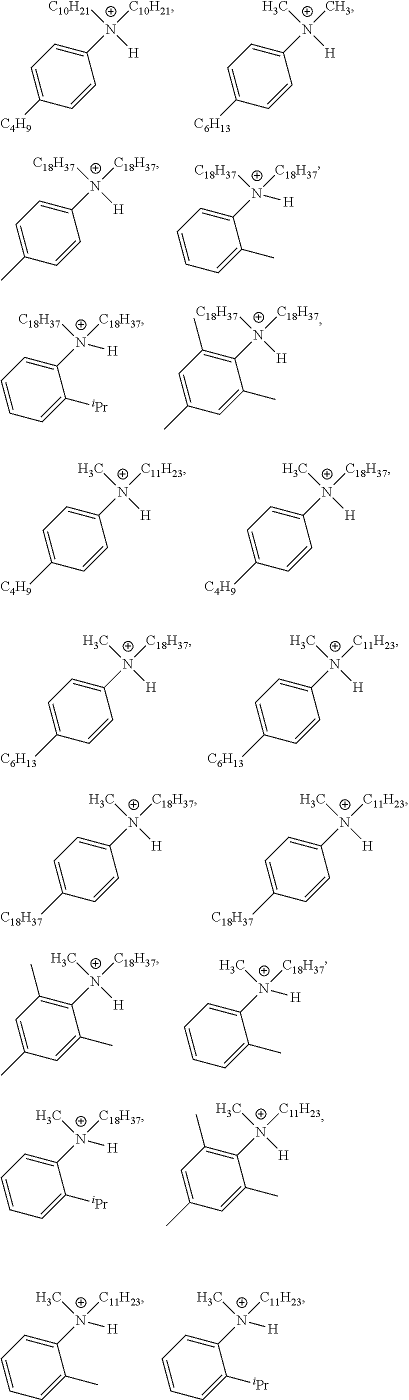

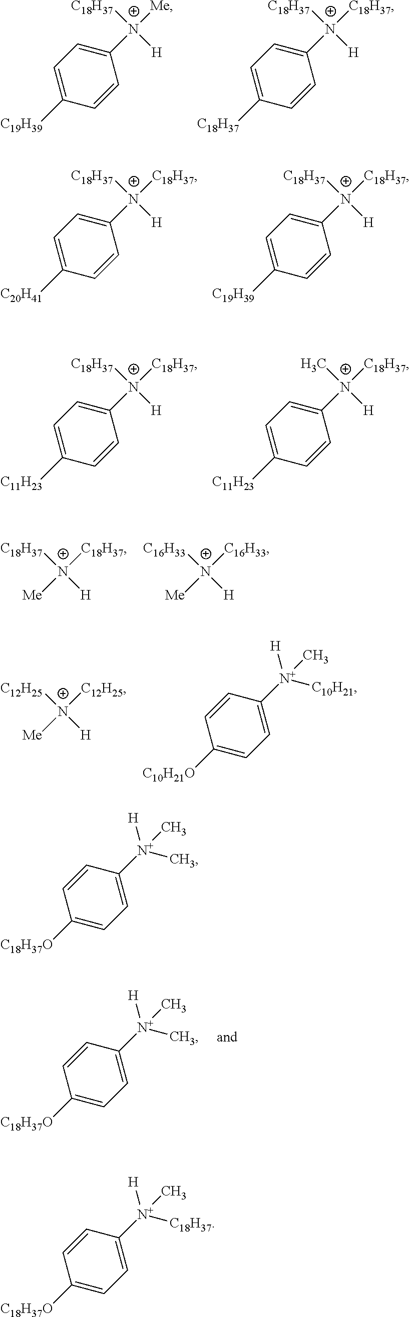

24. The catalyst system of any one of paragraphs 14-23, wherein the non-coordinating anion activator comprises an anion portion selected from the group consisting of tetrakis(perfluorophenyl)borate, tetrakis(perfluoronaphthyl)borate, and tetrakis(perfluorobiphenyl)borate.
25. The catalyst system of any one of paragraphs 14-24, wherein the non-coordinating anion activator has a solubility of at least about 5 mM at 25° C. in methylcyclohexane.
26. The catalyst system of any one of paragraphs 14-25, wherein the non-coordinating anion activator has a solubility of at least about 5 mM at 25° C. in isohexane.
27. The catalyst system of any one of paragraphs 14-26, wherein the transition metal complex comprises a metallocene catalyst effective to promote olefin polymerization.
28. The catalyst system of any one of paragraphs 14-26, wherein the transition metal complex comprises a non-metallocene catalyst effective to promote olefin polymerization.
29. The catalyst system of any one of paragraphs 14-28, wherein the transition metal complex is also deposited upon the passivated support material.
30. The catalyst system of any one of paragraphs 14-29, wherein the transition metal complex has a solubility of at least about 5 mM at 25° C. in at least one aliphatic hydrocarbon solvent.
31. A method comprising:

contacting the catalyst system of any one of paragraphs 14-30 with an olefinic feed comprising one or more olefins under polymerization reaction conditions to form a polyolefin.

32. The method of paragraph 31, wherein contacting takes place in a substantial absence of aromatic solvent.
33. The method of paragraph 31 or paragraph 32, wherein the support material is passivated and comprises a reaction product of an unpassivated support material and a hydrocarbyl aluminum compound.
34. The method of paragraph 33, wherein the hydrocarbyl aluminum compound comprises a trialkylaluminum compound.
35. The method of paragraph 33 or paragraph 34, wherein the unpassivated support material comprises an inorganic oxide selected from the group consisting of Al₂O₃, ZrO₂, SiO₂, SiO₂/Al₂O₃, SiO₂/TiO₂, silica/clay, silicon oxide/clay, and mixtures thereof.
36. The method of paragraph 33 or paragraph 34, wherein the unpassivated support material comprises silica.
37. The method of any one of paragraphs 30-36, wherein the non-coordinating anion activator comprises an ammonium or phosphonium borate represented by Formula 3

[R¹¹R¹²R¹³EH]⁺[BR¹⁴R¹⁵R¹⁶R¹⁷]⁻ Formula 3

wherein

E is nitrogen or phosphorus;

R¹¹, R¹², and R¹³ are independently a C₁-C₃₀, optionally substituted, alkyl group, an aryl group, an aryl group substituted with a C₁-C₃₀, optionally substituted, alkyl group, or an aryl group substituted with a C₁-C₃₀, optionally substituted, alkoxy group, provided that among R¹¹, R¹², and R¹³ at least one C₁₀₊ alkyl group or C₁₀₊ alkoxy group is present; and

R¹⁴, R¹⁵, R¹⁶, and R¹⁷ are each an independently selected halosubstituted aryl group.

38. The method of paragraph 37, wherein E is N.
39. The method of paragraph 37 or paragraph 38, wherein R¹⁴, R¹⁵, R¹⁶, and R¹⁷ are each an independently selected perfluorinated aryl group.
40. The method of any one of paragraphs 31-39, wherein the non-coordinating anion activator comprises a cation portion having a structure represented by a formula selected from the group consisting of

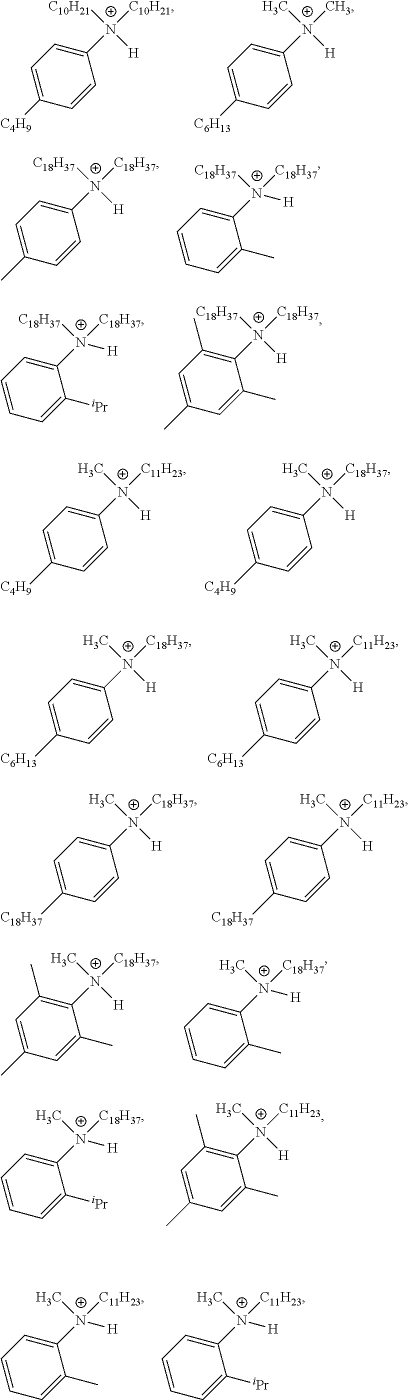

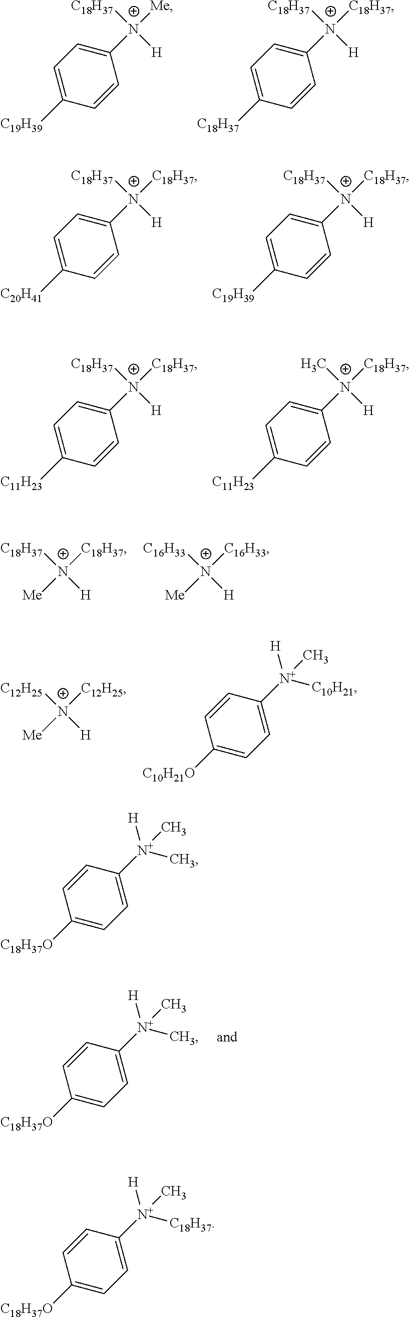

41. The method of any one of paragraphs 31-40, wherein the non-coordinating anion activator comprises an anion portion selected from the group consisting of tetrakis(perfluorophenyl)borate, tetrakis(perfluoronaphthyl)borate, and tetrakis(perfluorobiphenyl)borate.
42. The method of any one of paragraphs 31-41, wherein the non-coordinating anion activator has a solubility of at least about 5 mM at 25° C. in methylcyclohexane.
43. The method of any one of paragraphs 31-42, wherein the non-coordinating anion activator has a solubility of at least about 5 mM at 25° C. in isohexane.
44. The method of any one of paragraphs 31-43, wherein the transition metal complex comprises a metallocene effective to promote olefin polymerization.
45. The method of any one of paragraphs 31-43, wherein the transition metal complex comprises a non-metallocene catalyst effective to promote olefin polymerization.
46. The method of any one of paragraphs 31-45, wherein the transition metal complex is also deposited upon the support material.
47. The method of any one of paragraphs 31-46, wherein the transition metal complex has a solubility of at least about 5 mM at 25° C. in at least one aliphatic hydrocarbon solvent.
48. The method of any one of paragraphs 31-47, wherein the olefinic feed comprises one or more alpha olefins.
49. The method of any one of paragraphs 31-48, wherein contacting is performed under gas phase polymerization reaction conditions or slurry phase polymerization reaction conditions.
50. A method comprising:

contacting at least one support material with a non-coordinating anion activator dissolved in at least one aliphatic hydrocarbon solvent; and

removing the at least one aliphatic hydrocarbon solvent to deposit the non-coordinating anion activator upon the at least one support material, thereby forming a supported activator.

51. The method of paragraph 50, wherein contacting takes place in a substantial absence of aromatic solvent.
52. The method paragraph 50 or paragraph 51, further comprising:

passivating the at least one support material by contacting at least one unpassivated support material with a hydrocarbyl aluminum compound.

53. The method of paragraph 52, wherein the hydrocarbyl aluminum compound comprises a trialkylaluminum compound.
54. The method of paragraph 52 or paragraph 53, wherein the unpassivated support material comprises an inorganic oxide selected from the group consisting of Al₂O₃, ZrO₂, SiO₂, SiO₂/Al₂O₃, SiO₂/TiO₂, silica/clay, silicon oxide/clay, and mixtures thereof.
55. The method of paragraph 52 or paragraph 53, wherein the unpassivated support material comprises silica.
56. The method of any one of paragraphs 50-55, wherein the non-coordinating anion activator comprises an ammonium or phosphonium borate represented by Formula 3

[R¹¹R¹²R¹³EH]⁺[BR¹⁴R¹⁵R¹⁶R¹⁷]⁻ Formula 3

wherein

E is nitrogen or phosphorus;

R¹¹, R¹², and R¹³ are independently a C₁-C₃₀, optionally substituted, alkyl group, an aryl group, an aryl group substituted with a C₁-C₃₀, optionally substituted, alkyl group, or an aryl group substituted with a C₁-C₃₀, optionally substituted, alkoxy group, provided that among R¹¹, R¹², and R¹³ at least one C₁₀₊ alkyl group or C₁₀₊ alkoxy group is present; and

R¹⁴, R¹⁵, R¹⁶, and R¹⁷ are each an independently selected halosubstituted aryl group.

57. The method of paragraph 56, wherein E is N.
58. The method of paragraph 56 or paragraph 57, wherein R¹⁴, R¹⁵, R¹⁶, and R¹⁷ are each an independently selected perfluorinated aryl group.
59. The method of any one of paragraphs 50-58, wherein the non-coordinating anion activator comprises a cation portion having a structure represented by a formula selected from the group consisting of

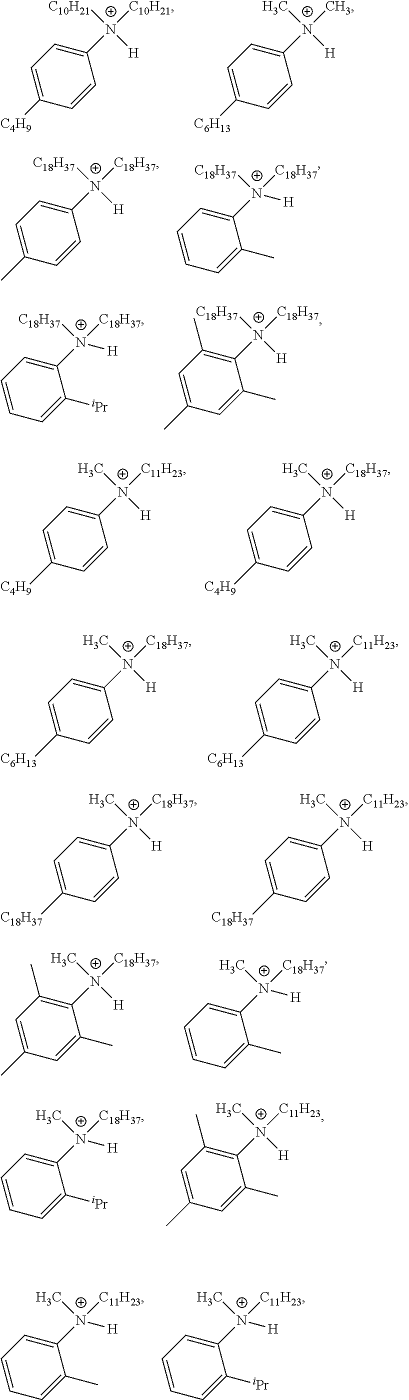

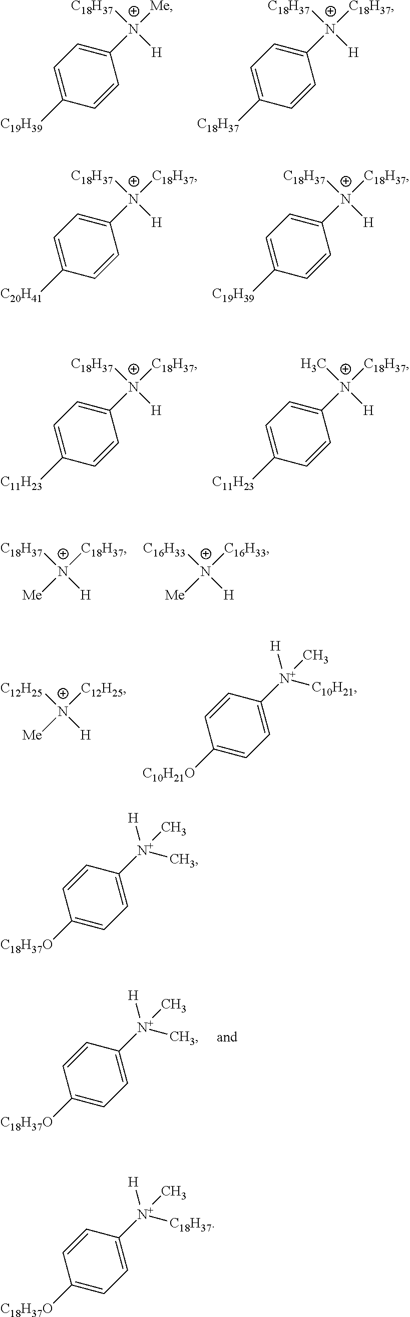

60. The method of any one of paragraphs 50-59, wherein the non-coordinating anion activator comprises an anion portion selected from the group consisting of tetrakis(perfluorophenyl)borate, tetrakis(perfluoronaphthyl)borate, and tetrakis(perfluorobiphenyl)borate.
61. The method of any one of paragraphs 50-60, wherein the non-coordinating anion activator has a solubility of at least about 5 mM at 25° C. in methylcyclohexane.
62. The method of any one of paragraphs 50-61, wherein the non-coordinating anion activator has a solubility of at least about 5 mM at 25° C. in isohexane.
63. The method of any one of paragraphs 50-62, further comprising:

contacting the at least one support material with a transition metal complex dissolved in at least one aliphatic hydrocarbon solvent; and removing the at least one aliphatic hydrocarbon solvent to deposit the transition metal complex upon the at least one support material.

64. The method of paragraph 63, wherein the transition metal complex comprises a metallocene effective to promote olefin polymerization.
65. The method of paragraph 63, wherein the transition metal complex comprises a non-metallocene catalyst effective to promote olefin polymerization.
66. The method of any one of paragraphs 63-65, wherein the transition metal complex and the non-coordinating anion activator are present in a single aliphatic hydrocarbon solution when contacting the at least one support material.
67. The method of any one of paragraphs 63-65, wherein the transition metal complex and the non-coordinating anion activator are present in separate aliphatic hydrocarbon solutions when contacting the at least one support material.

The present disclosure also relates to:

1A. A supported activator, comprising:

a support material; and

a non-coordinating anion activator deposited on the support material, the non-coordinating anion activator having a solubility of at least about 5 mM at 25° C. in at least one aliphatic hydrocarbon solvent.

2A. The supported activator of paragraph 1A, wherein the supported activator is substantially free of aromatic solvent.
3A. The supported activator of paragraph 1A or paragraph 2A, wherein the support material is passivated and comprises a reaction product of an unpassivated support material and a hydrocarbyl aluminum compound.
4A. The supported activator of paragraph 3A, wherein the hydrocarbyl aluminum compound comprises a trialkylaluminum compound.
5A. The supported activator of paragraph 3A, wherein the unpassivated support material comprises an inorganic oxide selected from the group consisting of Al₂O₃, ZrO₂, SiO₂, SiO₂/Al₂O₃, SiO₂/TiO₂, silica/clay, silicon oxide/clay, and mixtures thereof.
6A. The supported activator of paragraph 3A, wherein the unpassivated support material comprises silica.
7A. The supported activator of paragraph 1A or paragraph 2A, wherein the non-coordinating anion activator comprises an ammonium or phosphonium borate represented by Formula 3

[R¹¹R¹²R¹³EH]⁺[BR¹⁴R¹⁵R¹⁶R¹⁷]⁻ Formula 3

wherein

E is nitrogen or phosphorus;

R¹¹, R¹², and R¹³ are independently a C₁-C₃₀, optionally substituted, alkyl group, an aryl group, an aryl group substituted with a C₁-C₃₀, optionally substituted, alkyl group, or an aryl group substituted with a C₁-C₃₀, optionally substituted, alkoxy group, provided that among R¹¹, R¹², and R¹³ at least one C₁₀₊ alkyl group or C₁₀₊ alkoxy group is present; and

R¹⁴, R¹⁵, R¹⁶, and R¹⁷ are each an independently selected halosubstituted aryl group.

8A. The supported activator of paragraph 7A, wherein E is N.
9A. The supported activator of paragraph 7A, wherein R¹⁴, R¹⁵, R¹⁶, and R¹⁷ are each an independently selected perfluorinated aryl group.
10A. The supported activator of paragraph 1A or paragraph 2A, wherein the non-coordinating anion activator comprises a cation portion having a structure represented by a formula selected from the group consisting of

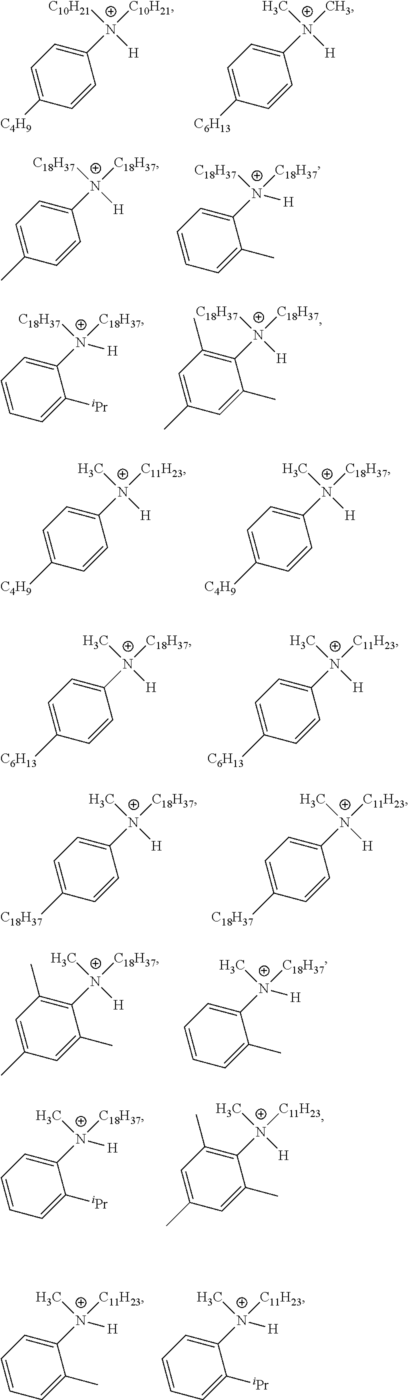

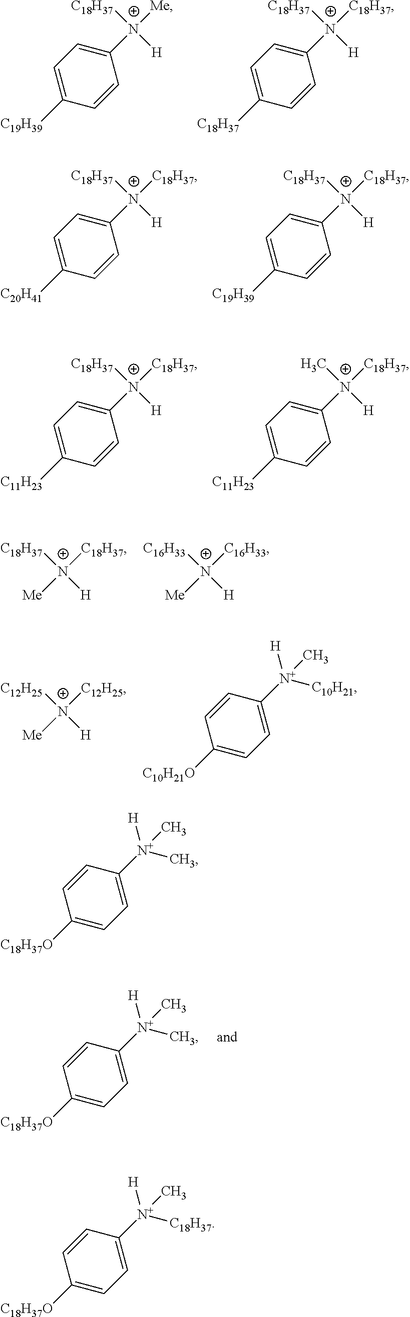

11A. The supported activator of paragraph 1A or paragraph 2A, wherein the non-coordinating anion activator comprises an anion portion selected from the group consisting of tetrakis(perfluorophenyl)borate, tetrakis(perfluoronaphthyl)borate, and tetrakis(perfluorobiphenyl)borate.
12A. The supported activator of paragraph 1A or paragraph 2A, wherein the non-coordinating anion activator has a solubility of at least about 5 mM at 25° C. in methylcyclohexane.
13A. The supported activator of paragraph 1A or paragraph 2A, wherein the non-coordinating anion activator has a solubility of at least about 5 mM at 25° C. in isohexane.
14A. A catalyst system comprising:

a supported activator comprising a support material and a non-coordinating anion activator deposited on the support material, the non-coordinating anion activator having a solubility of at least about 5 mM at 25° C. in at least one aliphatic hydrocarbon solvent; and

a transition metal complex activatable by the supported activator.

15A. The catalyst system of paragraph 14A, wherein the catalyst system is substantially free of aromatic solvent.
16A. The catalyst system of paragraph 14A or paragraph 15A, wherein the support material is passivated and comprises a reaction product of an unpassivated support material and a hydrocarbyl aluminum compound.
17A. The catalyst system of paragraph 16A, wherein the hydrocarbyl aluminum compound comprises a trialkylaluminum compound.
18A. The catalyst system of paragraph 16A, wherein the unpassivated support material comprises an inorganic oxide selected from the group consisting of Al₂O₃, ZrO₂, SiO₂, SiO₂/Al₂O₃, SiO₂/TiO₂, silica/clay, silicon oxide/clay, and mixtures thereof.
19A. The catalyst system of paragraph 16A or paragraph 17A, wherein the unpassivated support material comprises silica.
20A. The catalyst system of paragraph 14A or paragraph 15A, wherein the non-coordinating anion activator comprises an ammonium or phosphonium borate represented by Formula 3

[R¹¹R¹²R¹³EH]⁺[BR¹⁴R¹⁵R¹⁶R¹⁷]⁻ Formula 3

wherein

E is nitrogen or phosphorus;

R¹¹, R¹², and R¹³ are independently a C₁-C₃₀, optionally substituted, alkyl group, an aryl group, an aryl group substituted with a C₁-C₃₀, optionally substituted, alkyl group, or an aryl group substituted with a C₁-C₃₀, optionally substituted, alkoxy group, provided that among R¹¹, R¹², and R¹³ at least one C₁₀₊ alkyl group or C₁₀₊ alkoxy group is present; and

R¹⁴, R¹⁵, R¹⁶, and R¹⁷ are each an independently selected halosubstituted aryl group.

21A. The catalyst system of paragraph 20A, wherein E is N.
22A. The catalyst system of paragraph 20A, wherein R¹⁴, R¹⁵, R¹⁶, and R¹⁷ are each an independently selected perfluorinated aryl group.
23A. The catalyst system of paragraph 14A or paragraph 15A, wherein the non-coordinating anion activator comprises a cation portion having a structure represented by a formula selected from the group consisting of

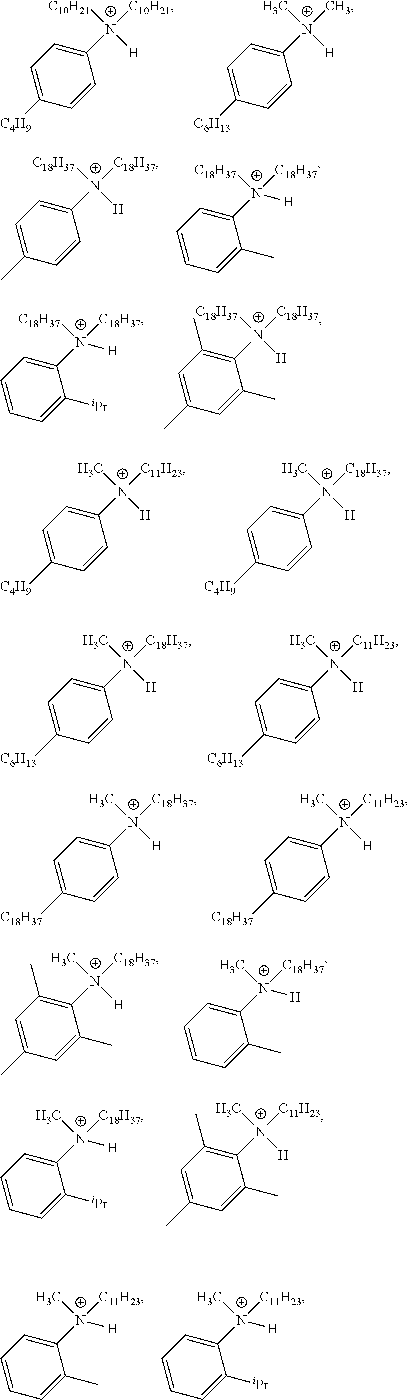

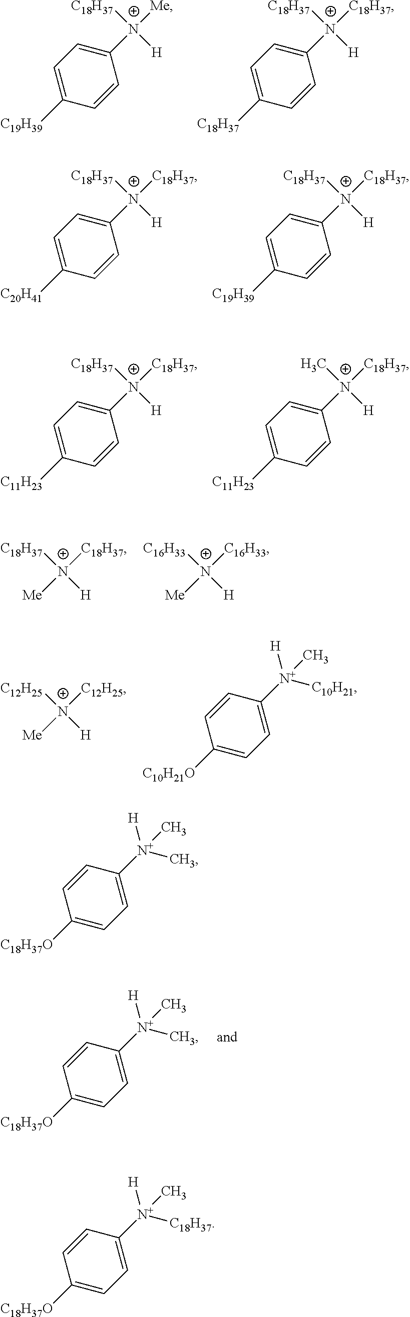

24A. The catalyst system of paragraph 14A or paragraph 15A, wherein the non-coordinating anion activator comprises an anion portion selected from the group consisting of tetrakis(perfluorophenyl)borate, tetrakis(perfluoronaphthyl)borate, and tetrakis(perfluorobiphenyl)borate.
25A. The catalyst system of paragraph 14A or paragraph 15A, wherein the non-coordinating anion activator has a solubility of at least about 5 mM at 25° C. in methylcyclohexane.
26A. The catalyst system of paragraph 14A or paragraph 15A, wherein the non-coordinating anion activator has a solubility of at least about 5 mM at 25° C. in isohexane.
27A. The catalyst system of paragraph 14A or paragraph 15A, wherein the transition metal complex comprises a metallocene catalyst effective to promote olefin polymerization.
28A. The catalyst system of paragraph 14A or paragraph 15A, wherein the transition metal complex comprises a non-metallocene catalyst effective to promote olefin polymerization.
29A. The catalyst system of paragraph 14A or paragraph 15A, wherein the transition metal complex is also deposited upon the support material.
30A. The catalyst system of paragraph 14A or paragraph 15A, wherein the transition metal complex has a solubility of at least about 5 mM at 25° C. in at least one aliphatic hydrocarbon solvent.
31A. A method comprising:

contacting the catalyst system of any one of paragraphs 14A-30A with an olefinic feed comprising one or more olefins under polymerization reaction conditions to form a polyolefin.

32A. The method of paragraph 31A, wherein contacting takes place in a substantial absence of aromatic solvent.
33A. The method of paragraph 31A or paragraph 32A, wherein the support material is passivated and comprises a reaction product of an unpassivated support material and a hydrocarbyl aluminum compound.
34A. The method of paragraph 33A, wherein the hydrocarbyl aluminum compound comprises a trialkylaluminum compound.
35A. The method of paragraph 33A, wherein the unpassivated support material comprises an inorganic oxide selected from the group consisting of Al₂O₃, ZrO₂, SiO₂, SiO₂/Al₂O₃, SiO₂/TiO₂, silica/clay, silicon oxide/clay, and mixtures thereof.
36A. The method of paragraph 33A, wherein the unpassivated support material comprises silica.
37A. The method of any paragraph 30A or paragraph 31A, wherein the non-coordinating anion activator comprises an ammonium or phosphonium borate represented by Formula 3

[R¹¹R¹²R¹³EH]⁺[BR¹⁴R¹⁵R¹⁶R¹⁷]⁻ Formula 3

wherein

E is nitrogen or phosphorus;

R¹¹, R¹², and R¹³ are independently a C₁-C₃₀, optionally substituted, alkyl group, an aryl group, an aryl group substituted with a C₁-C₃₀, optionally substituted, alkyl group, or an aryl group substituted with a C₁-C₃₀, optionally substituted, alkoxy group, provided that among R¹¹, R¹², and R¹³ at least one C₁₀₊ alkyl group or C₁₀₊ alkoxy group is present; and

R¹⁴, R¹⁵, R¹⁶, and R¹⁷ are each an independently selected halosubstituted aryl group.

38A. The method of paragraph 37A, wherein E is N.
39A. The method of paragraph 37A, wherein R¹⁴, R¹⁵, R¹⁶, and R¹⁷ are each an independently selected perfluorinated aryl group.
40A. The method of paragraph 31A or paragraph 32A, wherein the non-coordinating anion activator comprises a cation portion having a structure represented by a formula selected from the group consisting of

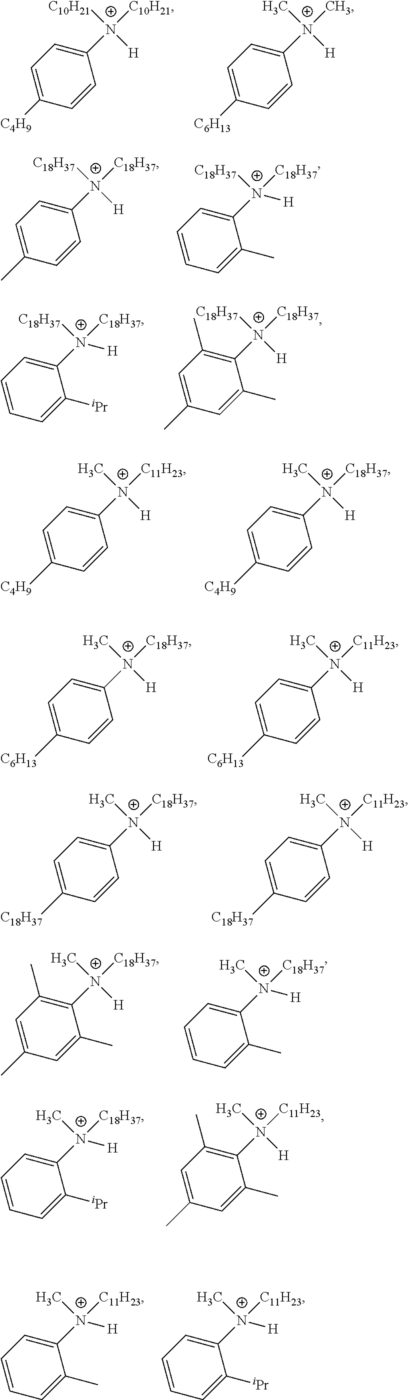

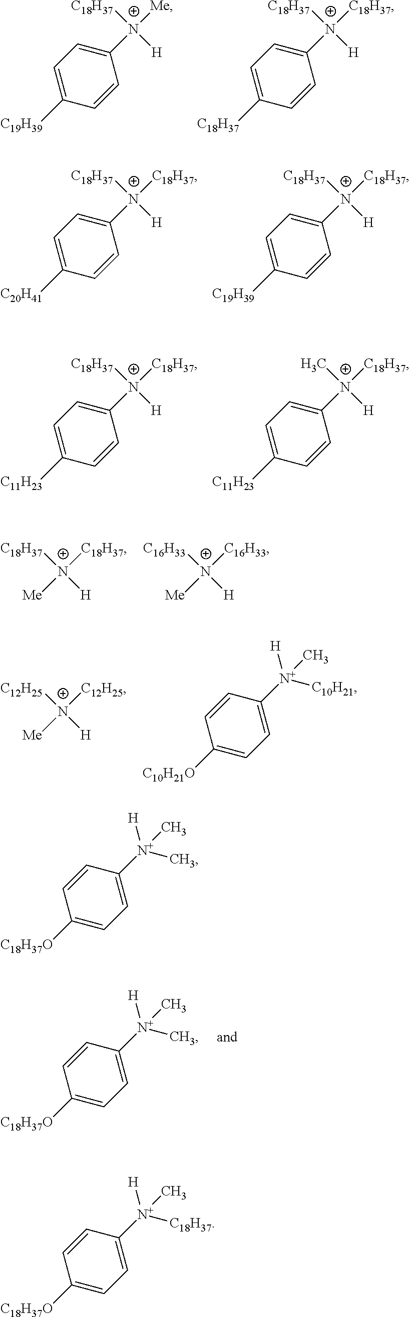

41A. The method of paragraph 31A or paragraph 32A, wherein the non-coordinating anion activator comprises an anion portion selected from the group consisting of tetrakis(perfluorophenyl)borate, tetrakis(perfluoronaphthyl)borate, and tetrakis(perfluorobiphenyl)borate.
42A. The method of paragraph 31A or paragraph 32A, wherein the non-coordinating anion activator has a solubility of at least about 5 mM at 25° C. in methylcyclohexane.
43A. The method of paragraph 31A or paragraph 32A, wherein the non-coordinating anion activator has a solubility of at least about 5 mM at 25° C. in isohexane.
44A. The method of paragraph 31A or paragraph 32A, wherein the transition metal complex comprises a metallocene effective to promote olefin polymerization.
45A. The method of paragraph 31A or paragraph 32A, wherein the transition metal complex comprises a non-metallocene catalyst effective to promote olefin polymerization.
46A. The method of paragraph 31A or paragraph 32A, wherein the transition metal complex is also deposited upon the passivated support material.
47A. The method of paragraph 31A or paragraph 32A, wherein the transition metal complex has a solubility of at least about 5 mM at 25° C. in at least one aliphatic hydrocarbon solvent.
48A. The method of any paragraph 31A or paragraph 32A, wherein the olefinic feed comprises one or more alpha olefins.
49A. The method of paragraph 31A or paragraph 32A, wherein contacting is performed under gas phase polymerization reaction conditions or slurry phase polymerization reaction conditions.
50A. A method comprising:

contacting at least one support material with a non-coordinating anion activator dissolved in at least one aliphatic hydrocarbon solvent; and

removing the at least one aliphatic hydrocarbon solvent to deposit the non-coordinating anion activator upon the at least one support material, thereby forming a supported activator.

51A. The method of paragraph 50A, wherein contacting takes place in a substantial absence of aromatic solvent.
52A. The method paragraph 50A or paragraph 51A, further comprising:

passivating the at least one support material by contacting at least one unpassivated support material with a hydrocarbyl aluminum compound.

53A. The method of paragraph 52A, wherein the hydrocarbyl aluminum compound comprises a trialkylaluminum compound.
54A. The method of paragraph 52A, wherein the unpassivated support material comprises an inorganic oxide selected from the group consisting of Al₂O₃, ZrO₂, SiO₂, SiO₂/Al₂O₃, SiO₂/TiO₂, silica/clay, silicon oxide/clay, and mixtures thereof.
55A. The method of paragraph 52A, wherein the unpassivated support material comprises silica.
56A. The method of paragraph 50A or paragraph 51A, wherein the non-coordinating anion activator comprises an ammonium or phosphonium borate represented by Formula 3

[R¹¹R¹²R¹³EH]⁺[BR¹⁴R¹⁵R¹⁶R¹⁷]⁻ Formula 3

wherein

E is nitrogen or phosphorus;

R¹¹, R¹², and R¹³ are independently a C₁-C₃₀, optionally substituted, alkyl group, an aryl group, an aryl group substituted with a C₁-C₃₀, optionally substituted, alkyl group, or an aryl group substituted with a C₁-C₃₀, optionally substituted, alkoxy group, provided that among R¹¹, R¹², and R¹³ at least one C₁₀₊ alkyl group or C₁₀₊ alkoxy group is present; and

R¹⁴, R¹⁵, R¹⁶, and R¹⁷ are each an independently selected halosubstituted aryl group.

57A. The method of paragraph 56A, wherein E is N.
58A. The method of paragraph 56A, wherein R¹⁴, R¹⁵, R¹⁶, and R¹⁷ are each an independently selected perfluorinated aryl group.
59A. The method of paragraph 50A or paragraph 51A, wherein the non-coordinating anion activator comprises a cation portion having a structure represented by a formula selected from the group consisting of

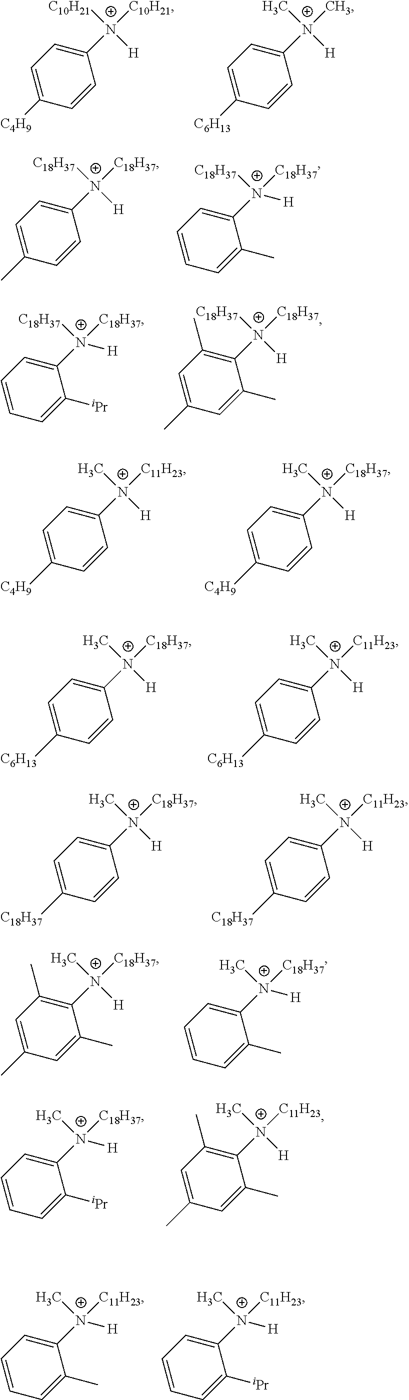

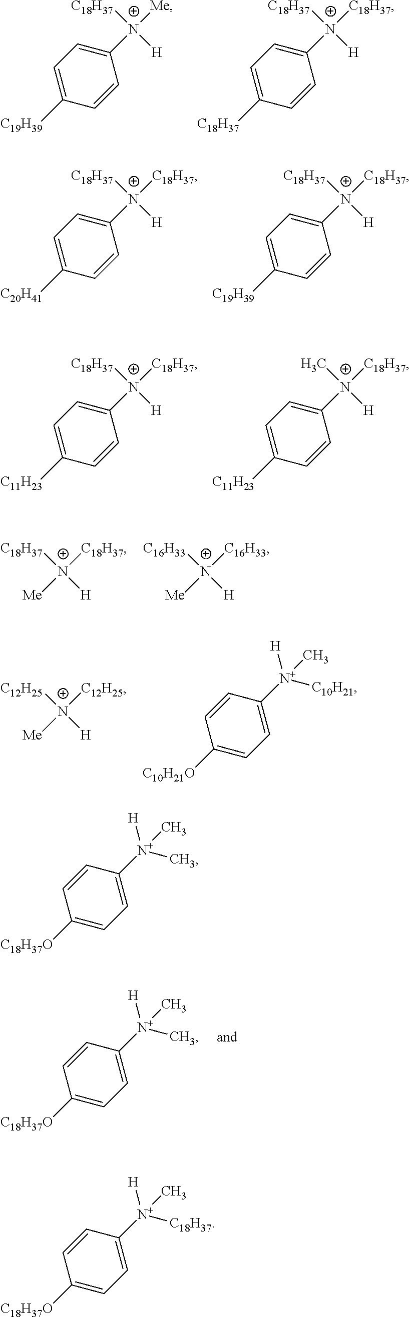

60A. The method of paragraph 50A or paragraph 51A, wherein the non-coordinating anion activator comprises an anion portion selected from the group consisting of tetrakis(perfluorophenyl)borate, tetrakis(perfluoronaphthyl)borate, and tetrakis(perfluorobiphenyl)borate.
61A. The method of paragraph 50A or paragraph 51A, wherein the non-coordinating anion activator has a solubility of at least about 5 mM at 25° C. in methylcyclohexane.
62A. The method of paragraph 50A or paragraph 51A, wherein the non-coordinating anion activator has a solubility of at least about 5 mM at 25° C. in isohexane.
63A. The method of paragraph 50A or paragraph 51A, further comprising:

contacting the at least one support material with a transition metal complex dissolved in at least one aliphatic hydrocarbon solvent; and

removing the at least one aliphatic hydrocarbon solvent to deposit the transition metal complex upon the at least one support material.

64A. The method of paragraph 63A, wherein the transition metal complex comprises a metallocene effective to promote olefin polymerization.
65A. The method of paragraph 63A, wherein the transition metal complex comprises a non-metallocene catalyst effective to promote olefin polymerization.
66A. The method of paragraph 63A, wherein the transition metal complex and the non-coordinating anion activator are present in a single aliphatic hydrocarbon solution when contacting the at least one support material.
67A. The method of paragraph 63A, wherein the transition metal complex and the non-coordinating anion activator are present in separate aliphatic hydrocarbon solutions when contacting the at least one support material.

The present disclosure further relates to:

1B. A supported activator, comprising:

a support material; and

a non-coordinating anion activator deposited on the support material, the non-coordinating anion activator having a solubility of at least about 5 mM at 25° C. in at least one aliphatic hydrocarbon solvent.

2B. The supported activator of paragraph 1B, wherein the supported activator is substantially free of aromatic solvent.
3B. The supported activator of paragraph 1B, wherein the support material is passivated and comprises a reaction product of an unpassivated support material and a hydrocarbyl aluminum compound.
4B. The supported activator of paragraph 3B, wherein the hydrocarbyl aluminum compound comprises a trialkylaluminum compound.
5B. The supported activator of paragraph 3B, wherein the unpassivated support material comprises an inorganic oxide selected from the group consisting of Al₂O₃, ZrO₂, SiO₂, SiO₂/Al₂O₃, SiO₂/TiO₂, silica/clay, silicon oxide/clay, and mixtures thereof.
6B. The supported activator of paragraph 3B, wherein the unpassivated support material comprises silica.
7B. The supported activator of paragraph 1B, wherein the non-coordinating anion activator comprises an ammonium or phosphonium borate represented by Formula 3

[R¹¹R¹²R¹³EH]⁺[BR¹⁴R¹⁵R¹⁶R¹⁷]⁻ Formula 3

wherein

E is nitrogen or phosphorus;

R¹¹, R¹², and R¹³ are independently a C₁-C₃₀, optionally substituted, alkyl group, an aryl group, an aryl group substituted with a C₁-C₃₀, optionally substituted, alkyl group, or an aryl group substituted with a C₁-C₃₀, optionally substituted, alkoxy group, provided that among R¹¹, R¹², and R¹³ at least one C₁₀₊ alkyl group or C₁₀₊ alkoxy group is present; and

R¹⁴, R¹⁵, R¹⁶, and R¹⁷ are each an independently selected halosubstituted aryl group.

8B. The supported activator of paragraph 7B, wherein E is N.
9B. The supported activator of paragraph 7B, wherein R¹⁴, R¹⁵, R¹⁶, and R¹⁷ are each an independently selected perfluorinated aryl group.
10B. The supported activator of paragraph 1B, wherein the non-coordinating anion activator comprises a cation portion having a structure represented by a formula selected from the group consisting of

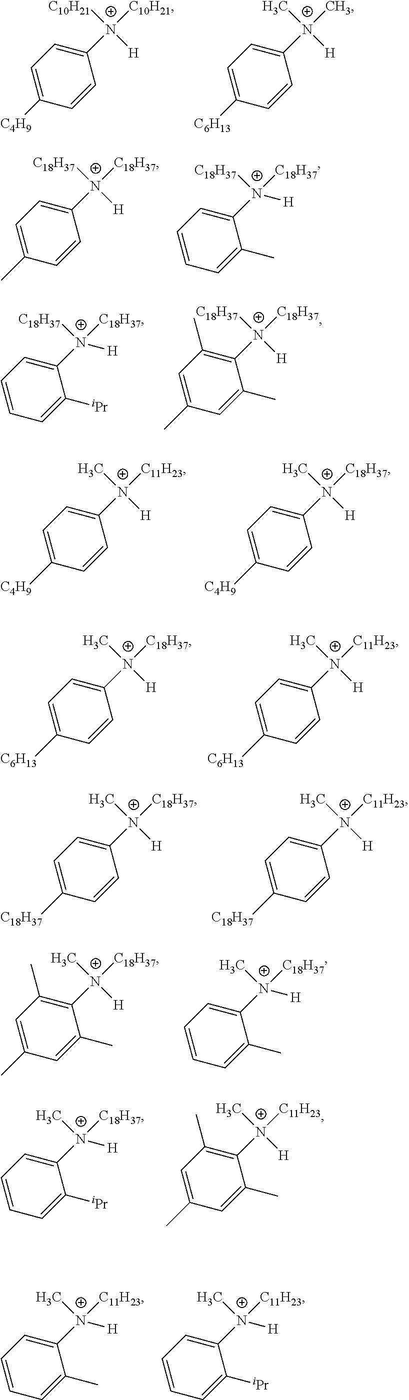

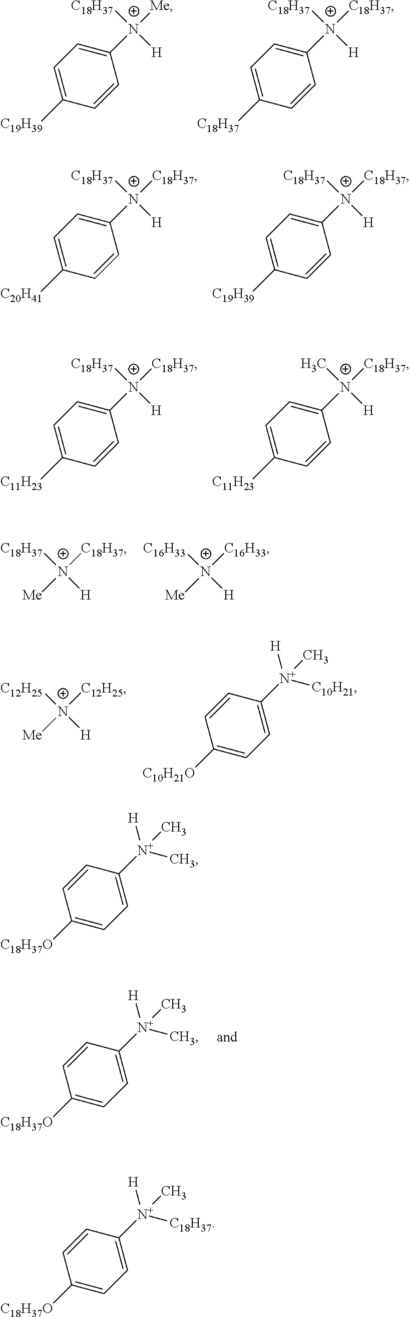

11B. The supported activator of paragraph 1B, wherein the non-coordinating anion activator comprises an anion portion selected from the group consisting of tetrakis(perfluorophenyl)borate, tetrakis(perfluoronaphthyl)borate, and tetrakis(perfluorobiphenyl)borate.
12B. The supported activator of paragraph 1B, wherein the non-coordinating anion activator has a solubility of at least about 5 mM at 25° C. in methylcyclohexane.
13B. The supported activator of paragraph 1B, wherein the non-coordinating anion activator has a solubility of at least about 5 mM at 25° C. in isohexane.
14B. A catalyst system comprising:

a supported activator comprising a support material and a non-coordinating anion activator deposited on the support material, the non-coordinating anion activator having a solubility of at least about 5 mM at 25° C. in at least one aliphatic hydrocarbon solvent; and

a transition metal complex activatable by the supported activator.

15B. The catalyst system of paragraph 14B, wherein the catalyst system is substantially free of aromatic solvent.
16B. The catalyst system of paragraph 14B, wherein the support material is passivated and comprises a reaction product of an unpassivated support material and a hydrocarbyl aluminum compound.
17B. The catalyst system of paragraph 16B, wherein the hydrocarbyl aluminum compound comprises a trialkylaluminum compound.
18B. The catalyst system of paragraph 16B, wherein the unpassivated support material comprises an inorganic oxide selected from the group consisting of Al₂O₃, ZrO₂, SiO₂, SiO₂/Al₂O₃, SiO₂/TiO₂, silica/clay, silicon oxide/clay, and mixtures thereof.
19B. The catalyst system of paragraph 16B, wherein the unpassivated support material comprises silica.
20B. The catalyst system of paragraph 14B, wherein the non-coordinating anion activator comprises an ammonium or phosphonium borate represented by Formula 3

[R¹¹R¹²R¹³EH]⁺[BR¹⁴R¹⁵R¹⁶R¹⁷]⁻ Formula 3

wherein

E is nitrogen or phosphorus;

R¹¹, R¹², and R¹³ are independently a C₁-C₃₀, optionally substituted, alkyl group, an aryl group, an aryl group substituted with a C₁-C₃₀, optionally substituted, alkyl group, or an aryl group substituted with a C₁-C₃₀, optionally substituted, alkoxy group, provided that among R¹¹, R¹², and R¹³ at least one C₁₀₊ alkyl group or C₁₀₊ alkoxy group is present; and

R¹⁴, R¹⁵, R¹⁶, and R¹⁷ are each an independently selected halosubstituted aryl group.

21B. The catalyst system of paragraph 20B, wherein E is N.
22B. The catalyst system of paragraph 20B, wherein R¹⁴, R¹⁵, R¹⁶, and R¹⁷ are each an independently selected perfluorinated aryl group.
23B. The catalyst system of paragraph 14B, wherein the non-coordinating anion activator comprises a cation portion having a structure represented by a formula selected from the group consisting of

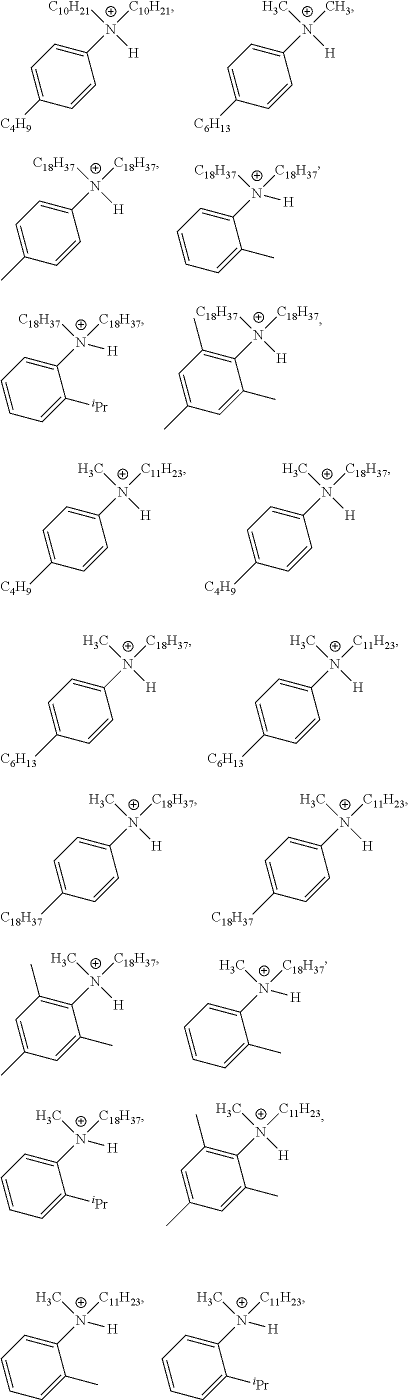

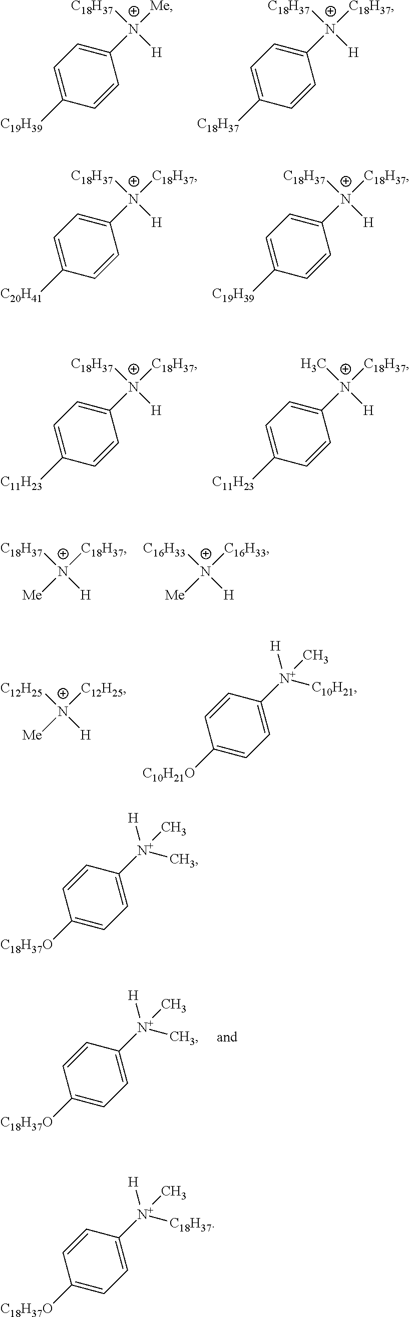

24B. The catalyst system of paragraph 14B, wherein the non-coordinating anion activator comprises an anion portion selected from the group consisting of tetrakis(perfluorophenyl)borate, tetrakis(perfluoronaphthyl)borate, and tetrakis(perfluorobiphenyl)borate.
25B. The catalyst system of paragraph 14B, wherein the non-coordinating anion activator has a solubility of at least about 5 mM at 25° C. in methylcyclohexane.
26B. The catalyst system of paragraph 14B, wherein the non-coordinating anion activator has a solubility of at least about 5 mM at 25° C. in isohexane.
27B. The catalyst system of paragraph 14B, wherein the transition metal complex comprises a metallocene catalyst effective to promote olefin polymerization.
28B. The catalyst system of paragraph 14B, wherein the transition metal complex comprises a non-metallocene catalyst effective to promote olefin polymerization.
29B. The catalyst system of paragraph 14B, wherein the transition metal complex is also deposited upon the support material.
30B. The catalyst system of paragraph 14B, wherein the transition metal complex has a solubility of at least about 5 mM at 25° C. in at least one aliphatic hydrocarbon solvent.
31B. A method comprising:

contacting the catalyst system of any one of paragraphs 14B-30B with an olefinic feed comprising one or more olefins under polymerization reaction conditions to form a polyolefin.

32B. The method of paragraph 31B, wherein contacting takes place in a substantial absence of aromatic solvent.
33B. The method of paragraph 31B, wherein the support material is passivated and comprises a reaction product of an unpassivated support material and a hydrocarbyl aluminum compound.
34B. The method of paragraph 33B, wherein the hydrocarbyl aluminum compound comprises a trialkylaluminum compound.
35B. The method of paragraph 33B, wherein the unpassivated support material comprises an inorganic oxide selected from the group consisting of Al₂O₃, ZrO₂, SiO₂, SiO₂/Al₂O₃, SiO₂/TiO₂, silica/clay, silicon oxide/clay, and mixtures thereof.
36B. The method of paragraph 33B, wherein the unpassivated support material comprises silica.
37B. The method of any paragraph 30B, wherein the non-coordinating anion activator comprises an ammonium or phosphonium borate represented by Formula 3

[R¹¹R¹²R¹³EH]⁺[BR¹⁴R¹⁵R¹⁶R¹⁷]⁻ Formula 3

wherein

E is nitrogen or phosphorus;

R¹¹, R¹², and R¹³ are independently a C₁-C₃₀, optionally substituted, alkyl group, an aryl group, an aryl group substituted with a C₁-C₃₀, optionally substituted, alkyl group, or an aryl group substituted with a C₁-C₃₀, optionally substituted, alkoxy group, provided that among R¹¹, R¹², and R¹³ at least one C₁₀₊ alkyl group or C₁₀₊ alkoxy group is present; and

R¹⁴, R¹⁵, R¹⁶, and R¹⁷ are each an independently selected halosubstituted aryl group.

38B. The method of paragraph 37B, wherein E is N.
39B. The method of paragraph 37B, wherein R¹⁴, R¹⁵, R¹⁶, and R¹⁷ are each an independently selected perfluorinated aryl group.
40B. The method of paragraph 31B, wherein the non-coordinating anion activator comprises a cation portion having a structure represented by a formula selected from the group consisting of

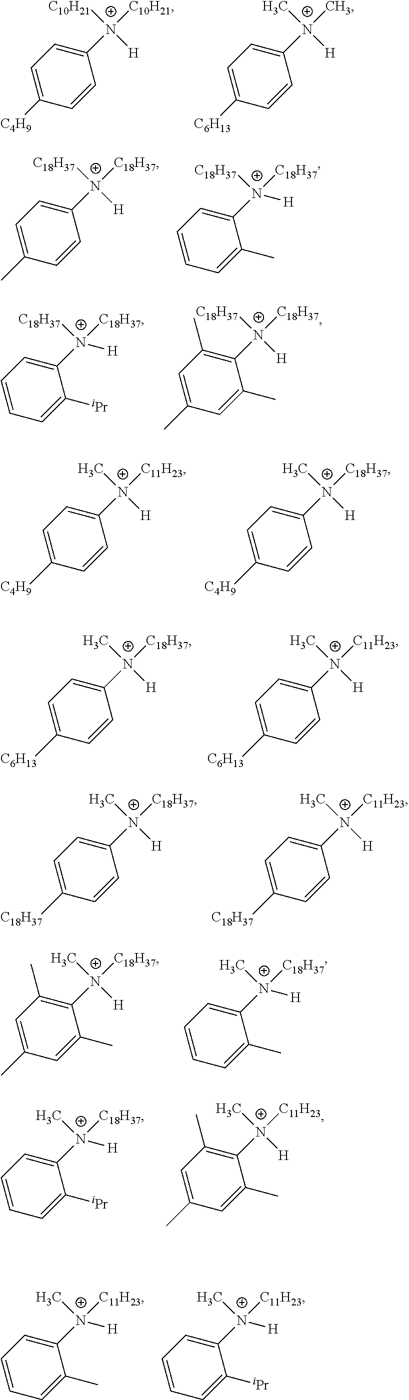

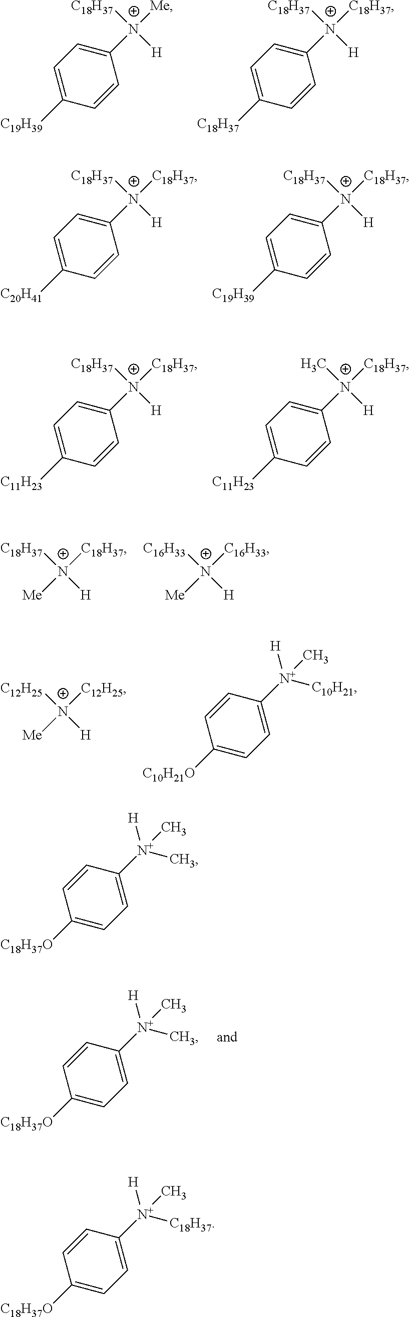

41B. The method of paragraph 31B, wherein the non-coordinating anion activator comprises an anion portion selected from the group consisting of tetrakis(perfluorophenyl)borate, tetrakis(perfluoronaphthyl)borate, and tetrakis(perfluorobiphenyl)borate.
42B. The method of paragraph 31B, wherein the non-coordinating anion activator has a solubility of at least about 5 mM at 25° C. in methylcyclohexane.
43B. The method of paragraph 31B, wherein the non-coordinating anion activator has a solubility of at least about 5 mM at 25° C. in isohexane.
44B. The method of paragraph 31B, wherein the transition metal complex comprises a metallocene effective to promote olefin polymerization.
45B. The method of paragraph 31B, wherein the transition metal complex comprises a non-metallocene catalyst effective to promote olefin polymerization.
46B. The method of paragraph 31B, wherein the transition metal complex is also deposited upon the support material.
47B. The method of paragraph 31B, wherein the transition metal complex has a solubility of at least about 5 mM at 25° C. in at least one aliphatic hydrocarbon solvent.
48B. The method of any paragraph 31B, wherein the olefinic feed comprises one or more alpha olefins.
49B. The method of paragraph 31B, wherein contacting is performed under gas phase polymerization reaction conditions or slurry phase polymerization reaction conditions.
50B. A method comprising:

contacting at least one support material with a non-coordinating anion activator dissolved in at least one aliphatic hydrocarbon solvent; and

removing the at least one aliphatic hydrocarbon solvent to deposit the non-coordinating anion activator upon the at least one support material, thereby forming a supported activator.

51B. The method of paragraph 50B, wherein contacting takes place in a substantial absence of aromatic solvent.
52B. The method paragraph 50B, further comprising:

passivating the at least one support material by contacting at least one unpassivated support material with a hydrocarbyl aluminum compound.

53B. The method of paragraph 52B, wherein the hydrocarbyl aluminum compound comprises a trialkylaluminum compound.
54B. The method of paragraph 52B, wherein the unpassivated support material comprises an inorganic oxide selected from the group consisting of Al₂O₃, ZrO₂, SiO₂, SiO₂/Al₂O₃, SiO₂/TiO₂, silica/clay, silicon oxide/clay, and mixtures thereof.
55B. The method of paragraph 52B, wherein the unpassivated support material comprises silica.
56B. The method of paragraph 50B, wherein the non-coordinating anion activator comprises an ammonium or phosphonium borate represented by Formula 3

[R¹¹R¹²R¹³EH]⁺[BR¹⁴R¹⁵R¹⁶R¹⁷]⁻ Formula 3

wherein

E is nitrogen or phosphorus;

R¹¹, R¹², and R¹³ are independently a C₁-C₃₀, optionally substituted, alkyl group, an aryl group, an aryl group substituted with a C₁-C₃₀, optionally substituted, alkyl group, or an aryl group substituted with a C₁-C₃₀, optionally substituted, alkoxy group, provided that among R¹¹, R¹², and R¹³ at least one C₁₀₊ alkyl group or C₁₀₊ alkoxy group is present; and

R¹⁴, R¹⁵, R¹⁶, and R¹⁷ are each an independently selected halosubstituted aryl group.

57B. The method of paragraph 56B, wherein E is N.
58B. The method of paragraph 56B, wherein R¹⁴, R¹⁵, R¹⁶, and R¹⁷ are each an independently selected perfluorinated aryl group.
59B. The method of paragraph 50B, wherein the non-coordinating anion activator comprises a cation portion having a structure represented by a formula selected from the group consisting of

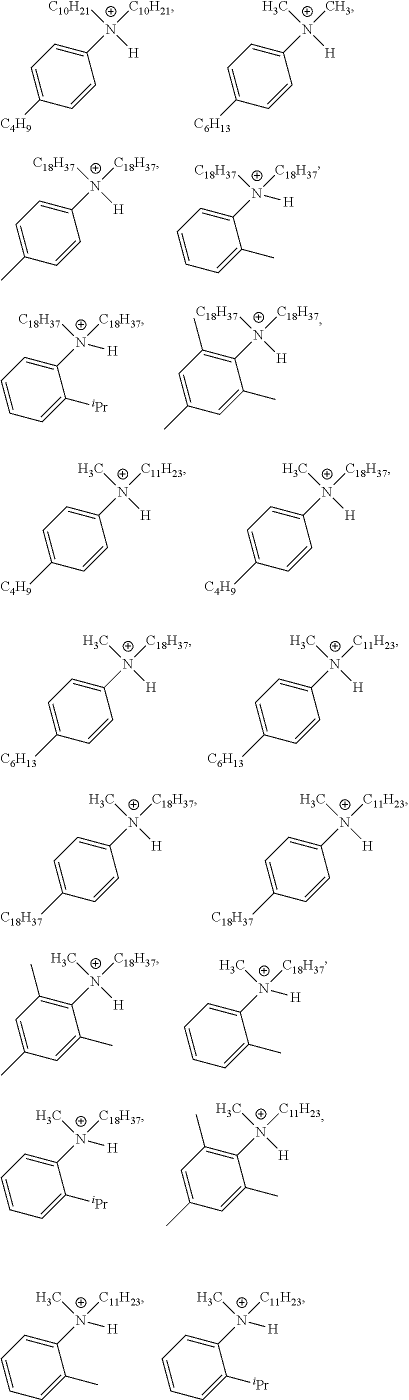

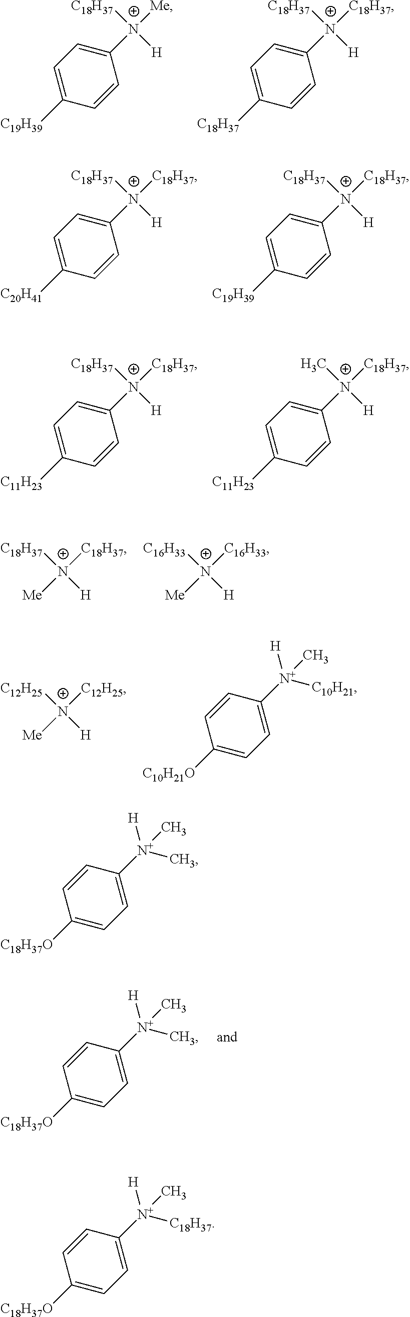

60B. The method of paragraph 50B, wherein the non-coordinating anion activator comprises an anion portion selected from the group consisting of tetrakis(perfluorophenyl)borate, tetrakis(perfluoronaphthyl)borate, and tetrakis(perfluorobiphenyl)borate.
61B. The method of paragraph 50B, wherein the non-coordinating anion activator has a solubility of at least about 5 mM at 25° C. in methylcyclohexane.
62B. The method of paragraph 50B, wherein the non-coordinating anion activator has a solubility of at least about 5 mM at 25° C. in isohexane.
63B. The method of paragraph 50B, further comprising:

contacting the at least one support material with a transition metal complex dissolved in at least one aliphatic hydrocarbon solvent; and

removing the at least one aliphatic hydrocarbon solvent to deposit the transition metal complex upon the at least one support material.

64B. The method of paragraph 63B, wherein the transition metal complex comprises a metallocene effective to promote olefin polymerization.
65B. The method of paragraph 63B, wherein the transition metal complex comprises a non-metallocene catalyst effective to promote olefin polymerization.
66B. The method of paragraph 63B, wherein the transition metal complex and the non-coordinating anion activator are present in a single aliphatic hydrocarbon solution when contacting the at least one support material.
67B. The method of paragraph 63B, wherein the transition metal complex and the non-coordinating anion activator are present in separate aliphatic hydrocarbon solutions when contacting the at least one support material.

To facilitate a better understanding of the embodiments of the present invention, the following example of preferred or representative embodiments are given. In no way should the following example be read to limit, or to define, the scope of the invention.

### Examples

### Metallocenes and Reagents.

Bis(n-propylcyclopentadienyl)hafnium dimethyl (Metallocene 1), bis(1-butyl, 3-methylcyclopentadienyl) zirconium dimethyl (Metallocene 2), rac-dimethylsilyl-bis(indenyl) zirconium dimethyl (Metallocene 3), bis(1-methylindenyl)zirconium dimethyl (mixture of rac and meso isomers) (Metallocene 4), and dimethylsilyl-bis(trimethylsilylmethylenecyclopentadienyl)hafnium dimethyl (mixture of rac and meso isomers) (Metallocene 5) were prepared by standard methods. N,N-Dimethylanilinium tetrakis(pentafluorophenyl)borate (DMAH-BF20) was purchased from Albemarle. Lithium tetrakis(pentafluorophenyl)borate etherate (Li—BF20) was purchased from Boulder Scientific. All other reagents and solvents were purchased from Sigma-Aldrich. NMR spectra were recorded on a Bruker 500 or 400 MHz NMR with chemical shifts referenced to residual solvent peaks (CDCl₃: 7.27 ppm for ¹H, 77.23 ppm for ¹³C).

### Activator Preparation.

### Activator 1 (NOMAH-BF20).

N-methyl-N-octadecylaniline: N-methylaniline (10.2 g, 96 mmol), bromoctadecane (38.4 g, 115 mmol), and triethylamine (19.9 mL, 144 mmol) were dissolved in 400 mL of DMSO and heated overnight at 100° C. The solution was diluted with water and extracted three times with ethyl acetate. The organic fractions were combined, rinsed with brine, dried with MgSO₄ and concentrated to yield a yellow oily solid. The product was purified by silica gel chromatography (2% ethyl acetate/isohexane) and isolated as a white solid. ¹H NMR (400 MHz, CDCl₃, δ): 0.88 (t, J=8.0 Hz, 3H), 1.25 (m, 32H), 1.56 (m, 2H), 2.92 (s, 3H), 3.29 (m, 2H), 6.68 (m, 3H), 7.22 (m, 2H).

4-(methyl(octadecyl)amino)benzaldehyde: To DMF (0.34 mL, 4.4 mmol) cooled to 0° C., was added phosphoryl chloride (0.49 mL, 5.3 mmol) dropwise. The reaction was warmed to room temperature over 30 minutes, turning bright red. The reaction mixture was cooled to 0° C. and a solution of the above alkylated aniline (1.6 g, 4.4 mmol) in 20 mL of THF was added. After stirring for 20 minutes, the reaction was heated at 80° C. for 2 hours. The cooled solution was quenched by dropwise addition of 20 mL of 1M KOH. The mixture was extracted with three portions of 15 mL EtOAc. The organic fractions were combined, rinsed with brine, dried with MgSO₄, and concentrated. The orange residue was purified by silica gel chromatography (2% ethyl acetate/isohexane) and isolated as a pale pink crystalline solid in 70% yield. ¹H NMR (400 MHz, CDCl₃, δ): 0.88 (t, J=7.0 Hz, 3H), 1.25 (m, 30H), 1.61 (m, 2H), 3.04 (s, 3H), 3.39 (t, J=8.0 Hz, 2H), 6.69 (d, J=7.0 Hz, 2H), 7.72 (d, J=7.0 Hz, 2H), 9.72 (s, 1H).

1-(4-(methyl(octadecyl)amino)phenyl)nonadecan-1-ol: Bromoocta-decylmagnesium chloride was prepared from bromooctadecane (1.03 g, 2.5 mmol) and magnesium turnings (88 mg, 3.5 mmol) in THF. The reaction mixture was filtered into a solution of the above aminobenzaldehyde (1.0 g, 2.5 mmol) in THF and stirred at ambient temperature overnight. The reaction was quenched with water and extracted with ethyl acetate. Organic fractions were combined, rinsed with brine, dried with MgSO₄, filtered and concentrated. The product was used without further purification. ¹H NMR (400 MHz, CDCl₃, δ): 0.88 (m, 6H), 1.24-1.80 (m, 67H), 2.92 (s, 3H), 3.28 (t, J=8.0 Hz, 2H), 4.55 (br s, 1H), 6.66 (d, J=8.0 Hz, 2H), 7.20 (d, J=8.0 Hz, 2H).

N-methyl-4-nonadecyl-N-octadecylaniline (NOMA): To the above alcohol (1.6 g, 2.5 mmol) dissolved in 50 mL of THF was added 27 mg of 10% Pd/C and 0.5 mL conc. HCl. The reaction was stirred under an atmosphere of hydrogen for over 48 hours. The reaction mixture was then filtered through Celite, concentrated, and purified by silica gel chromatography (2% ethyl acetate/isohexane). ¹H NMR (400 MHz, CDCl₃, δ): 0.89 (m, 6H), 1.27 (m, 62H), 1.56 (m, 4H), 2.50 (m, 2H), 2.90 (s, 3H), 3.26 (m, 2H), 6.65 (m, 2H), 7.04 (m, 2H).

N-methyl-4-nonadecyl-N-octadecylanilinium tetrakis(perfluorophenylborate) (NOMAH-BF20): N-methyl-4-nonadecyl-N-octadecylaniline (15.0 g, 24.0 mmol) was dissolved in 1 L of hexane. A 2 M ethereal solution of HCl (12.0 mL, 24.0 mmol) was added slowly, causing a white precipitate to form. After stirring for 16 hours, the white solid was collected, washed with fresh hexane, and dried under vacuum to give the anilinium salt in 85% yield. The N-methyl-4-nonadecyl-N-octadecylaniline HCl salt (1.50 g, 2.26 mmol) was suspended in 100 mL of isohexane and combined with Li—BF20 (1.72 g, 2.26 mmol). The mixture was heated at reflux for 1.5 hours, then cooled to ambient temperature and filtered. The filtrate was concentrated to give the product as a colorless oil in 61% yield. ¹H NMR (400 MHz, CDCl₃, δ): 0.86 (m, 6H), 1.25 (m, 62H), 1.61 (m, 4H), 2.66 (m, 2H), 3.19 (s, 3H), 3.42 (t, J=8.0 Hz, 2H), 7.27 (d, J=8.6 Hz, 2H), 7.35 (d, J=8.7 Hz, 2H).

### Activator 2 (19DMAH-BF20).

N,N-dimethyl-4-(nonadec-1-en-1-yl)aniline: Octadecyltriphenylphosphonium bromide (19.96 g, 340 mmol) was dissolved in 200 mL of THF. n-Butyllithium (26.8 mL, 2.5 M in hexanes, 67.0 mmol) was added slowly and the reaction stirred for 1 hour. 4-Dimethylaminobenzaldehyde (5.0 g, 33.5 mmol) was then added and allowed to stir at ambient overnight. The reaction was quenched with ice and extracted with 3 portions of diethyl ether. The combined organic fractions were washed with brine, dried (MgSO₄), filtered, and concentrated under reduced pressure. The product was purified by column chromatography (10% acetone/isohexane) to give a white solid in 70% yield. ¹H NMR (500 MHz, CDCl₃, δ): 0.89 (m, 3H), 1.27 (m, 28H), 1.46 (m, 2H), 2.35 (m, 2H), 2.95 (s, 6H), 6.03 (m, 1H), 6.28 (m, 1H), 6.69 (m, 2H), 7.27 (m, 2H).

N,N-dimethyl-4-nonadecylaniline: To the above compound (3.0 g, 7.77 mmol) dissolved in 150 mL of THF, was added 10% Pd/C suspended in ethanol. The flask was put under an atmosphere of hydrogen and stirred overnight. The mixture was filtered through Celite and concentrated under reduced pressure. The product was purified by column chromatography (10% acetone/isohexane) to give the aniline as a pale yellow solid in 40% yield. ¹H NMR (500 MHz, CDCl₃, δ): 0.88 (m, 3H), 1.26 (m, 32H), 1.55 (m, 2H), 2.50 (m, 2H), 3.48 (s, 6H), 6.70 (d, J=8.5 Hz, 2H), 7.06 (d, J=8.5 Hz, 2H).

N,N-dimethyl-4-nonadecylanilinium chloride (19DMA): The above aniline (1.2 g, 3.1 mmol) was dissolved in 100 mL of isohexane and ethereal HCl (4.3 mL, 8.62 mmol) was added, forming a white precipitate. The reaction was stirred for half an hour before collecting the solid with filtration, which was then washed with fresh isohexane and dried under vacuum to give a white powder in 38% yield.

N,N-dimethyl-4-nonadecylanilinium tetrakis(perfluorophenylborate) (19DMAH-BF20): The above HCl salt (250 mg, 0.592 mmol) and Li—BF20 (450 mg, 0.592 mmol) were slurried in methylcyclohexane and heated for 1.5 hours at 80° C. Once cooled to ambient temperature, the solution was filtered and the filtrate concentrated to a white solid. The product was obtained in 90% yield. ¹H NMR (400 MHz, CDCl₃, δ): 0.87 (m, 3H), 1.25 (m, 32H), 1.61 (m, 2H), 2.68 (m, 2H), 3.30 (s, 6H), 7.22 (m, 2H), 7.38 (m, 2H), 8.46 (s, 1H).

### Support Passivation.

Passivated Support 1. ES70 silica (PQ Corp) was dried for 3 hours at 100° C. in a tube furnace under a slight flow of dry N₂. To a conical reaction vessel was added 2.5 L of dry, deoxygenated n-hexane and 272 grams of triisobutylaluminum (Albemarle). The stirring rate was set to 120 rpm and 742 g of the silica was added. The slurry was stirred for 3 hours and then dried under vacuum at 25° C. over the course of 16 hours. The dry solid was washed with 2 liters of dry, deoxygenated pentane (Sigma Aldrich) and then returned to the reaction vessel and dried under vacuum for 2 hours at 25° C.

Passivated Support 2. ES70 silica (PQ Corp) dried for 3 hours at 875° C. in a tube furnace under a slight flow of dry N2 was added to iso-hexane (˜60 mL), and with rapid stirring was added 0.48 g of trimethylaluminum (Sigma Aldrich). After stirring about 45 minutes, the solid was isolated by filtration, washed with about 50 mL isohexane and dried under vacuum to give a free flowing powder.

### Supported Catalysts.

Example 1. An isohexane solution containing 40 μmol of Metallocene 1 (0.80 mL) was added to an isohexane solution containing 40 μmol NOMAH-BF20 (0.80 mL). After a few minutes, the isohexane was evaporated off and the solid was redissolved in 1.60 mL toluene. Passivated Support 1 (1.0 g) was added and then stirred well with a spatula. The slurry was dried under vacuum to give a free flowing powder.

Example 2. An isohexane solution containing 80 μmol NOMAH-BF20 (1.6 mL) was added to Passivated Support 1 (1.0 g), stirred well with a spatula and dried down. To this solid was added an isohexane solution of Metallocene 1 (1.6 mL, 80 μmol). The slurry was stirred well with a spatula and was dried under vacuum to give a free flowing powder.

Example 3. Example 2 was repeated except that 1.6 mL of isohexane solutions containing 40 μmol of NOMAH-BF20 and Metallocene 1 were used.

Example 4. Passivated Support 1 (5.0 g) was slurried in isohexane (20 mL), and a solution containing 200 μmol of NOMAH-BF20 in isohexane (4.0 mL) was added over about a minute with rapid stirring. The slurry was dried under vacuum to give a free flowing powder. To 1.0 g of this powder was added 1.6 mL of an isohexane solution of Metallocene 1 (40 μmol). The resulting mixture was stirred well with a spatula and was dried under vacuum to give a free flowing powder.

Example 5. Example 3 was repeated except that Passivated Support 2 was used.

Example 6. A solution of 19DMAH-BF20 in methylcyclohexane was prepared at a concentration of 31.2 μmol/mL. This solution was heated to 60° C. to fully solubilize the activator. To 1.28 mL of this solution was added an additional 0.32 mL of methylcyclohexane. Passivated Support 1 (1.0 g) was added to the solution at 60° C. The mixture was stirred well with a spatula and was dried under vacuum to give a free flowing powder. To 1.0 g of this powder was added 1.6 mL of an isohexane solution of Metallocene (40 μmol). The mixture was stirred well with a spatula and was dried under vacuum to give a free flowing powder.

Example 7. An isohexane solution containing 40 μmol NOMAH-BF20 (1.6 mL) was added to Passivated Support 1 (1.0 g), stirred well with a spatula and dried down. No metallocene was added.

Example 8. Example 4 was repeated except a solution of Metallocene 2 was used.

Example 9. 1.6 mL of a Metallocene 2 solution in isohexane (40 μmol) was added to 0.8 mL NOMAH-BF20 solution in isohexane (40 μmol) and an orange oil formed. Most of the isohexane was evaporated off and the resulting oil was dissolved in 1.60 mL toluene to form an orange solution. To this solution was added 1.0 g Passivated Support 1. The mixture was thoroughly mixed with a spatula and dried under vacuum.

Example 10. An isohexane solution containing 40 μmol NOMAH-BF20 (1.7 mL) was added to Passivated Support 2 (1.0 g), stirred well with a spatula and dried down. To the solid was added 1.6 mL of an isohexane solution of Metallocene 2 (40 μmol). The solid was stirred well with a spatula and was dried under vacuum to give a free flowing powder.

Example 11. A solution of 19DMAH-BF20 in methylcyclohexane was prepared at a concentration of 31.2 μmol/mL. This solution was heated to 60° C. to fully solubilize the activator. To 1.28 mL of this solution was added Passivated Support 1 (1.0 g) at 60° C. The mixture was stirred well with a spatula and was dried under vacuum to give a free flowing powder. To 1.0 g of the powder was added 1.6 mL of an isohexane solution of Metallocene 2 (40 μmol). This mixture was stirred well with a spatula and was dried under vacuum to give a free flowing powder.

Example 12. Example 8 was repeated except a solution of Metallocene 3 was used.

Example 13. Example 11 was repeated except Metallocene 3 was used.

Example 14. Example 11 was repeated except Metallocene 4 was used.

Example 15. Example 11 was repeated except Metallocene 5 was used.

Example 16. Example 11 was repeated except a solution containing 20 mol each of Metallocene 4 and Metallocene 5 was used.

The supported catalyst compositions used are further summarized in Table 3 below.

Polymerization Reactions. A 2 L autoclave was heated at 110° C. for 1 hour and then charged, under N₂, with solid NaCl (350 g), 6 grams of Passivated Support 1 (scavenger) and heated for 30 minutes at 120° C. The reactor was then cooled to ˜81° C. 1-Hexene and 10% H₂ in N₂ were added, and stirring was then commenced (450 RPM). Supported catalysts (10-20 mg, Examples 1-16) were injected into the reactor with ethylene flow (200 psi). After the injection, the reactor temperature was controlled at 85° C. and ethylene allowed to flow into the reactor to maintain pressure. Both 10% H₂ in N₂ and 1-hexene were fed in ratio to the ethylene flow. The polymerization was halted after 60 minutes by venting the reactor. The polymer was washed twice with water to remove salt and then dried in air for at least two days. Polymerization yield and catalyst productivity data is summarized in Table 3 below.

TABLE 3

| | | | | Catalyst | Polymer | Catalyst |
|---|---|---|---|---|---|---|
| | | | Passivated | Mass | Yield | Productivity |
| Entry | Metallocene | Activator | Support | (mg) | (g) | (g_{poly}/g_{cat}) |
| 1 | Metallocene | NOMAH | Support 1 | 14.6 | 85.5 | 5856 |
| | 1 | D4 | | | | |
| 2 | Metallocene | NOMAH | Support 1 | 14.0 | 97 | 6929 |
| | 1 | D4 | | | | |
| 3 | Metallocene | NOMAH | Support 1 | 15.0 | 80.6 | 5373 |
| | 1 | D4 | | | | |
| 4 | Metallocene | NOMAH | Support 1 | 12.9 | 68.6 | 5318 |
| | 1 | D4 | | | | |
| 5 | Metallocene | NOMAH | Support 2 | 14.9 | 72.2 | 4866 |
| | 1 | D4 | | | | |
| 6 | Metallocene | 19DMAH | Support 1 | 11.1 | 54.9 | 4946 |
| | 1 | D4 | | | | |
| 7 | N/A | NOMAH | Support 1 | 14.9 | 4.4 | 295 |
| | | D4 | | | | |
| 8 | Metallocene | NOMAH | Support 1 | 14.9 | 14.7 | 987 |
| | 2 | D4 | | | | |
| 9 | Metallocene | NOMAH | Support 1 | 13.9 | 18.7 | 1345 |
| | 2 | D4 | | | | |
| 10 | Metallocene | NOMAH | Support 2 | 14.8 | 15.9 | 1074 |
| | 2 | D4 | | | | |
| 11 | Metallocene | 19DMAH | Support 1 | 12.9 | 39.6 | 3070 |
| | 2 | D4 | | | | |
| 12 | Metallocene | NOMAH | Support 1 | 12.7 | 6.9 | 543 |
| | 3 | D4 | | | | |
| 13 | Metallocene | 19DMAH | Support 1 | 13.1 | 42.6 | 3252 |
| | 3 | D4 | | | | |
| 14 | Metallocene | 19DMAH | Support 1 | 14.9 | 26.4 | 1772 |
| | 4 | D4 | | | | |
| 15 | Metallocene | 19DMAH | Support 1 | 11.8 | 75.5 | 6398 |
| | 5 | D4 | | | | |
| 16 | Metallocene | 19DMAH | Support 1 | 12.1 | 25.6 | 2116 |
| | 4/5 | D4 | | | | |

All documents described herein are incorporated by reference herein, including any priority documents and/or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

One or more illustrative embodiments incorporating the invention embodiments disclosed herein are presented herein. Not all features of a physical implementation are described or shown in this application for the sake of clarity. It is understood that in the development of a physical embodiment incorporating the embodiments of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

1. A supported activator, comprising:
a support material; and
a non-coordinating anion activator deposited on the support material, the non-coordinating anion activator having a solubility of at least about 5 mM at 25° C. in at least one aliphatic hydrocarbon solvent.

2. The supported activator of claim 1, wherein the supported activator is substantially free of aromatic solvent.

3. The supported activator of claim 1, wherein the support material is passivated and comprises a reaction product of an unpassivated support material and a hydrocarbyl aluminum compound, and wherein the hydrocarbyl aluminum compound comprises a trialkylaluminum compound.

4. (canceled)

5. The supported activator of claim 3, wherein the unpassivated support material comprises silica or an inorganic oxide selected from the group consisting of Al₂O₃, ZrO₂, SiO₂, SiO₂/Al₂O₃, SiO₂/TiO₂, silica/clay, silicon oxide/clay, and mixtures thereof.

6. (canceled)

7. The supported activator of claim 1, wherein the non-coordinating anion activator comprises an ammonium or phosphonium borate represented by Formula 3
[R¹¹R¹²R¹³EH]⁺[BR¹⁴R¹⁵R¹⁶R¹⁷]⁻ Formula 3
wherein
E is nitrogen or phosphorus;
R¹¹, R¹², and R¹³ are independently a C₁-C₃₀, optionally substituted, alkyl group, an aryl group, an aryl group substituted with a C₁-C₃₀, optionally substituted, alkyl group, or an aryl group substituted with a C₁-C₃₀, optionally substituted, alkoxy group, provided that among R¹¹, R¹², and R¹³ at least one C₁₀₊ alkyl group or C₁₀₊ alkoxy group is present; and
R¹⁴, R¹⁵, R¹⁶, and R¹⁷ are each an independently selected halosubstituted aryl group.

8. The supported activator of claim 7, wherein E is N and R¹⁴, R¹⁵, R¹⁶, and R¹⁷ are each an independently selected perfluorinated aryl group.

9. (canceled)

10. The supported activator of claim 1, wherein the non-coordinating anion activator comprises a cation portion having a structure represented by a formula selected from the group consisting of

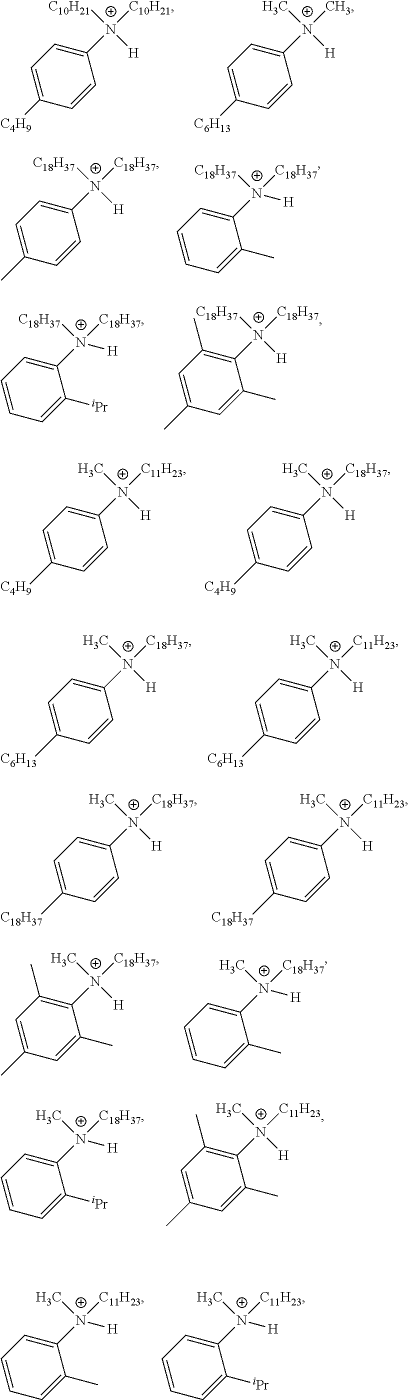

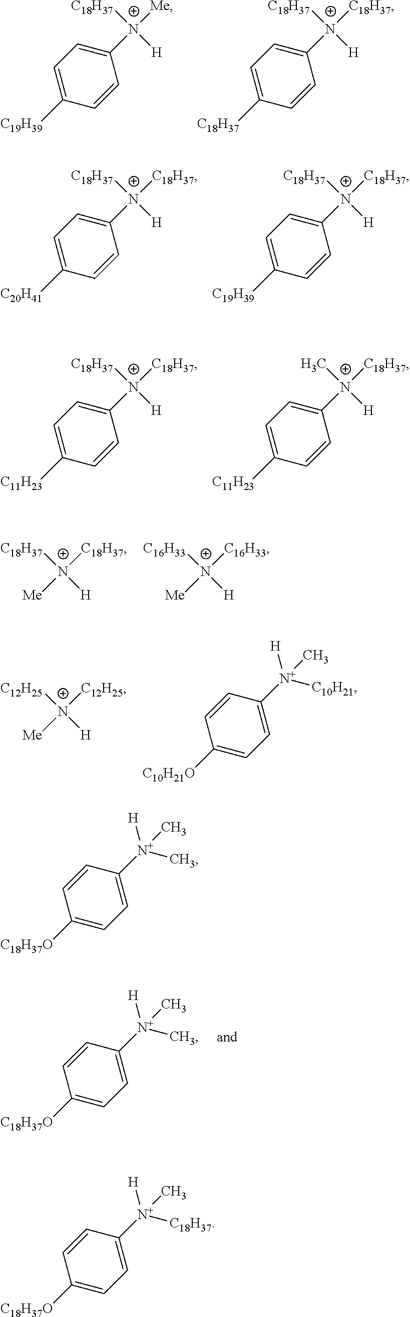

11. The supported activator of claim 1, wherein the non-coordinating anion activator comprises an anion portion selected from the group consisting of tetrakis(perfluorophenyl)borate, tetrakis(perfluoronaphthyl)borate, and tetrakis(perfluorobiphenyl)borate.

12. The supported activator of claim 1, wherein the non-coordinating anion activator has a solubility of at least about 5 mM at 25° C. in methylcyclohexane or the non-coordinating anion activator has a solubility of at least about 5 mM at 25° C. in isohexane.

13-26. (canceled)

27. A catalyst system comprising:
the supported activator of claim 1; and
a transition metal complex activatable by the supported activator,
wherein the transition metal complex comprises a metallocene or non-metallocene catalyst effective to promote olefin polymerization.

28. (canceled)

29. The catalyst system of claim 27, wherein the transition metal complex is also deposited upon the support material.

30. The catalyst system of claim 27, wherein the transition metal complex has a solubility of at least about 5 mM at 25° C. in at least one aliphatic hydrocarbon solvent.

31. A method comprising:
contacting the catalyst system of claim 27 with an olefinic feed comprising one or more olefins under polymerization reaction conditions to form a polyolefin.

32. The method of claim 31, wherein the contacting takes place in a substantial absence of aromatic solvent.

33-47. (canceled)

48. The method of claim 31, wherein the olefinic feed comprises one or more alpha olefins, and the contacting is performed under gas phase polymerization reaction conditions or slurry phase polymerization reaction conditions.

49-67. (canceled)
